(19) United States
(12) Patent Application Publication
(10) Pub. No.: US 2020/0123039 A1
(43) Pub. Date: Apr. 23, 2020

(54) PREPARATION OF A QUARTZ GLASS BODY

(71) Applicant: Heraeus Quarzglas GmbH & Co. KG, Hanau (DE)

(72) Inventors: Boris Gromann, Aschaffenburg (DE); Marcus Constantin Goebel, Giessen (DE); Nils Christian Nielsen, Goellheim (DE); Michael Huenermann, Alzenau (DE); Kathrin Wissel-Stoll, Moembris (DE)

(73) Assignee: Heraeus Quarzglas GmbH & Co. KG, Hanau (DE)

(21) Appl. No.: 16/622,206

(22) PCT Filed: Jun. 13, 2018
(86) PCT No.: PCT/EP2018/065706

§ 371 Date: Dec. 12, 2019

(30) Foreign Application Priority Data
Jun. 14, 2017 (EP) 17176042.4

(51) Int. Cl. C03B 19/10; C03B 17/04; C03C 1/02; C03C 3/06; C01B 33/18; H01J 5/04

(52) U.S. Cl. CPC C03B 19/1005; C03B 17/04; C03C 1/026; C03C 3/06; H01J 9/395; H01J 5/04; C03B 2201/04; C03C 2201/02; C03C 2203/10; C01B 33/183

(57) ABSTRACT

One aspect relates to a process for the preparation of a quartz glass body including: i.) providing a silicon dioxide granulate, ii.) making a first glass melt out of the silicon dioxide granulate, iii.) making a glass product out of at least one part of the glass melt, iv.) reducing the size of the glass product to obtain a quartz glass grain, v.) making a further glass melt from the quartz glass grain and vi.) making a quartz glass body out of at least one part of the further glass melt. Furthermore, one aspect relates to a quartz glass body obtainable by this process. Furthermore, one aspect relates to a reactor, which is obtainable by further processing of the quartz glass body.

The invention relates to a process for the preparation of a quartz glass body comprising the process steps i.) Providing a silicon dioxide granulate, ii.) Making a first glass melt out of the silicon dioxide granulate, iii) Making a glass product out of at least one part of the glass melt, iv.) Reducing the size of the glass product to obtain a quartz glass grain, v.) Making a further glass melt from the quartz glass grain and vi) Making a quartz glass body out of at least one part of the further glass melt. Furthermore, the invention relates to a quartz glass body obtainable by this process. Furthermore, the invention relates to a reactor, which is obtainable by further processing of the quartz glass body.

### BACKGROUND OF THE INVENTION

Quartz glass, quartz glass products and products which contain quartz glass are known. Likewise, various processes for the preparation of quartz glass, quartz glass bodies and grains of quartz glass are already known. Nonetheless, considerable efforts are still being made to identify preparation processes by which quartz glass of even higher purity, i.e. absence of impurities, can be prepared. In many areas of application of quartz glass and its processed products, high demands are made, for example in terms of purity. This is the case, inter alia, for quartz glass which is provided for an application in production steps in the fabrication of semiconductors. Here, every impurity of a glass body can potentially lead to defects in the semiconductor and thus to rejects in the fabrication. The varieties of high purity quartz glass which are employed in these processes are therefore laborious to prepare. These are valuable.

Furthermore, there is a market requirement for the above mentioned high purity quartz glass and products derived therefrom at low price. Therefore, it is an aspiration to be able to offer high purity quartz glass at a lower price than before. In this connection, both more cost-efficient preparation processes as well as cheaper sources of raw materials are sought.

Known processes for the preparation of quartz glass grains comprise melting silicon dioxide, making glass products out of the melt and reducing the size of the glass products to a grain. Impurities of the glass products made at the outset can lead to a failure of a quartz glass body made from the grain under load, in particular at high temperatures, or can preclude its use for a particular purpose. Impurities in the raw materials in the quartz glass body can also be released and transferred to the treated semiconductor components. This is the case, for example, in etching processes and leads to rejects in the semiconductor billets. A common problem associated with known preparation processes is therefore an inadequate quality of the purity of quartz glass bodies.

A further aspect relates to raw materials efficiency. It appears advantageous to input quartz glass and raw materials, which accumulate elsewhere as side products, into a preferably industrial process for quartz glass products, rather than employ these side products as filler, e.g. in construction or to dispose of them as rubbish at a cost. These side products are often separated off as fine dust in filters. The fine dust brings further problems, in particular in relation to health, work safety and handling.

### OBJECTS

An object of the present invention is to at least partially overcome one or more of the disadvantages present in the state of the art.

It is a further object of the invention to provide components made of glass with a long lifetime. The term components in particular is to be understood to include devices which can be employed in reactors for chemical and/or physical treatment steps.

It is a further object of the invention to provide components made of glass which are suitable in particular for specific treatment steps in the fabrication of semiconductors, in particular in the preparation of wafers. Examples of such a specific treatment step is plasma etching, chemical etching and plasma doping.

It is a further object of the invention to provide components made of glass which have a high transparency.

It is a further object of the invention to provide components made of glass which are free of bubbles or have a low content of bubbles.

It is a further object of the invention to provide components made of glass which have a high contour accuracy. In particular, it is an object of the invention to provide components made of glass which do not deform at high temperatures. In particular, it is an object of the invention to provide components made of glass which are form stable, even when formed with large size.

It is a further object of the invention to provide components made of glass which are tear-proof and break-proof.

It is a further object of the invention to provide components made of glass which are efficient to prepare.

It is a further object of the invention to provide components made of glass which are cost-efficient to prepare.

It is a further object of the invention to provide components made of glass, the preparation of which does not require long further processing steps, for example tempering.

It is a further object of the invention to provide components made of glass which have a high thermal shock resistance. It is in particular an object of the invention to provide components made of glass which with large thermal fluctuations exhibit only little thermal expansion.

It is a further object of the invention to provide components made of glass with a high hardness.

It is a further object of the invention to provide components made of glass which have a high purity and low contamination with foreign atoms. The term foreign atoms is employed to mean constituents at a concentration of less than 10 ppm which are not purposefully introduced.

It is a further object of the invention to provide components made of glass which contain a low content of dopant materials.

It is a further object of the invention to provide components made of glass which have a high material homogeneity. The material homogeneity is a measure of the uniformity of the distribution of the elements and compounds, in particularly of OH, chlorine, metals, in particular aluminium, alkali earth metals, refractory metals and dopant materials, contained in the component.

It is a further object of the invention to provide components made of glass which display low stresses under thermal load.

It is a further object of the invention to provide thin components made of quartz glass. It is a further object of the invention to provide components made of glass, which components have a long working life.

It is a further object of the invention to provide large components made of quartz glass.

It is a further object of the invention to provide components made of quartz glass which have a low marbling. It is a further object of the invention to provide components made of quartz glass which do not have any transmission speckles.

It is as further object of the invention to provide components made of quartz glass which have a high transparency.

It is a further object of the invention to provide components made of quartz glass which have a low content of bubbles or even free of bubbles.

It is a further object of the invention to provide components made of quartz glass which can be etched easily.

It is a further object of the invention to provide components made of quartz glass which are uniformly densely sintered.

It is a further object of the invention to provide cost-efficient melting crucibles made of synthetic quartz glass.

It is a further object of the invention to provide a quartz glass body which is suitable for use in quartz glass components and solves at least partly at least one, preferably several, of the above mentioned objects.

It is as further object of the invention to provide a quartz glass body which has a high transparency.

It is a further object of the invention to provide a quartz glass body which has as few bubbles as possible, i.e. a low content of bubbles or even free of bubbles.

It is a further object of the invention to provide a quartz glass body which has a high homogeneity over the entire length of the quartz glass body.

In particular, it is a further object of the invention to provide a quartz glass body which has a high material homogeneity over the entire length of the quartz glass body.

In particular, it is a further object of the invention to provide a quartz glass body which has a high optical homogeneity over the entire length of the quartz glass body.

It is a further object of the invention to provide a quartz glass body, which comprises quartz glass of a defined composition.

It is a further object of the invention to provide a quartz glass body with high purity.

It is a further object to provide a quartz glass body efficiently and cost-efficiently.

It is a further object of the invention to provide a process by which quartz glass bodies can be prepared by which at least part of the above described objects is at least partly solved.

It is a further object of the invention to provide a process by which a glass, in particular a quartz glass and components thereof can be provided, wherein the glass has a high purity and as few bubbles as possible.

It is a further object of the invention to provide a process by which quartz glass bodies can be prepared simply and with little effort.

It is a further object of the invention to provide a process by which quartz glass bodies can be formed with a high speed.

It is a further object of the invention to provide a process by which quartz glass bodies can be prepared with a low reject rate.

### PREFERRED EMBODIMENTS OF THE INVENTION

A contribution to at least partially fulfilling at least one of the aforementioned objects is made by the independent claims. The dependent claims provide preferred embodiments which contribute to at least partially fulfilling at least one of the objects.
   |1| A process for the preparation of a quartz glass body comprising the process steps:
   i.) Providing a silicon dioxide granulate comprising the process steps:
      I. Providing a pyrogenically produced silicon dioxide powder;
      II. Processing the silicon dioxide powder to a silicon dioxide granulate, wherein the silicon dioxide granulate has a greater particle diameter than the silicon dioxide powder;
   ii.) Making a first glass melt out of the silicon dioxide granulate;
   iii.) Making a glass product out of at least one part of the first glass melt;
   iv.) Reducing the size of the glass product to obtain a quartz glass grain;
   v.) Making a further glass melt from the quartz glass grain;
   vi.) Making the quartz glass body out of at least one part of the further glass melt.
   |2| The process according to embodiment |1|, wherein the glass product has at least one of the following features:
   A] a transmission of more than 0.3, particularly preferably of more than 0.5;
   B] a blistering in a range from 5 to 5000 based on 1 kg of the glass product;
   C] an average bubble size in a range from 0.5 to 10 mm;
   D] a BET surface area of less than 1 m²/g;
   E] a density in a range from 2.1 to 2.3;
   F] a carbon content of less than 5 ppm;
   G] a total metal content of metals different to aluminium of less than 2000 ppb; and
   H] a cylindrical form;
   wherein the ppb and ppm are each based on the total weight of the glass product.
   |3| The process according to one of the preceding embodiments, wherein in step i.) a quantity of 1 to 10 ppm carbon is added.
   |4| The process according to one of the preceding embodiments, wherein step II. comprises the following steps:
   II.1. Providing a liquid phase
   II.2. Mixing the silicon dioxide powder with the liquid phase to obtain a slurry;
   II.3. Granulating the slurry to obtain the silicon dioxide granulate.
   |5| The process according to one of the preceding embodiments, wherein at least one of steps ii.) and v.) is carried out in a melting crucible which has at least one inlet and an outlet, wherein the inlet is arranged above the outlet.
   |6| The process according to one of the preceding embodiments, wherein the melt energy in at least one of steps ii.) and v.) is transferred to the melt material via a solid surface.
   |7| The process according to one of the preceding embodiments, wherein the glass product in step iii.), the quartz glass body in step vi.) or both are produced in a crucible drawing process.
   |8| The process according to one of the preceding embodiments, wherein the reduction in size in step iv.) takes place by high voltage discharge pulses.
   |9| The process according to one of the preceding embodiments, wherein the silicon dioxide powder can be prepared from a compound selected from the group consisting of siloxanes, silicon alkoxides and silicon halides.
   |10| The process according to one of the preceding embodiments, wherein the silicon dioxide granulate
   A) has a carbon content of in the range from 1 to 10 ppm;
   |11| The process according to one of the preceding embodiments, wherein the silicon dioxide granulate has at least one of the following features:
   B) a BET surface area in a range from 20 to 50 m²/g;
   C) a mean particle size in a range from 50 to 500 μm;
   D) a bulk density in a range from 0.5 to 1.2 g/cm³.
   E) an aluminium content of less than 200 ppb;
   F) a tamped density in a range from 0.7 to 1.0 g/cm³;
   G) a pore volume in a range from 0.1 to 2.5 mL/g;
   H) an angle of repose in a range from 23 to 26°,
   I) a particle size distribution D₁₀ in a range from 50 to 150 μm;
   J) a particle size distribution D₅₀ in a range from 150 to 300 μm;
   K) a particle size distribution D₉₀ in a range from 250 to 620 μm, wherein the ppm and ppb are each based on the total weight of the silicon dioxide granulate.
   |12| The process according to one of the preceding embodiments, wherein the quartz glass grain has at least one of the following features:
   I/ an OH content of less than 500 ppm;
   II/ a chlorine content of less than 60 ppm;
   III/ an aluminium content of less than 200 ppb;
   IV/ a BET surface area of less than 1 m²/g;
   V/ a bulk density in a range from 1.1 to 1.4 g/cm³.
   VI/ a particle size D₅₀ for the melt insert in a range from 50 to 5000 μm;
   VII/ a particle size D₅₀ for the slurry insert in a range from 0.5 to 5 mm;
   VIII/ a metal content of metals different to aluminium of less than 2 ppm;
   IX/ viscosity (p=1013 hPa) in a range from log 10 (η (1250° C.)/dPas)=11.4 to log 10 (η (1250° C.)/dPas)=12.9 or log 10 (η (1300° C.)/dPas)=11.1 to log 10 (η (1300° C.)/dPas)=12.2 or log 10 (η (1350° C.)/dPas)=10.5 to log 10 (η (1350° C.)/dPas)=11.5;
   wherein the ppm and ppb are each based on the total weight of the quartz glass grain.
   |13| The process according to one of the preceding embodiments, wherein the quartz glass body is characterised by the following features:
   [A] a transmission of more than 0.5, for example more than 0.6 or more than 0.7, particularly preferably more than 0.9; and
   [B] a blistering in a range from 0.5 to 500 based on 1 kg of the quartz glass product.
   |14| The process according to one of the preceding embodiments, wherein the quartz glass body has at least one of the following features:
   [C] a mean particle size in a range from 0.05 to 1 mm;
   [D] a BET surface area of less than 1 m²/g;
   [E] a density in a range from 2.1 to 2.3 g/cm³.
   [F] a carbon content of less than 5 ppm;
   [G] a metal content of metals different to aluminium of less than 2 ppm;
   [H] a cylindrical form;
   [I] a sheet;
   [J] an OH content of less than 500 ppm;
   [K] a chlorine content of less than 60 ppm;
   [L] an aluminium content of less than 200 ppb;
   [M] an ODC content of less than 5*10¹⁸/cm³;
   wherein the ppm and ppb are each based on the total weight of the quartz glass body.
   |15| A quartz glass grain obtainable by a process according to one of the preceding embodiments.
   |16| A process for the preparation of a light duct comprising the following steps:
   A/ Providing a quartz glass body according to embodiment |15| or obtainable according to a process according to one of embodiments |1| to |14|, wherein the quartz glass body is first processed to obtain a hollow body with at least one opening;
   B/ Introducing one or more core rods into the hollow body from step A/ through the at least one opening to obtain a precursor;
   C/ Drawing the precursor in the heat to obtain a light duct with one or several cores and a jacket M1.
   |17| A process for the preparation of an illuminant comprising the following steps:
   (i) Providing a quartz glass body according to embodiment |15| or obtainable according to a process according to one of embodiments |1| to |14|, wherein the quartz glass body is first processed to obtain a hollow body
   (ii) Optionally fitting the hollow body with electrodes;
   (iii) Filling the hollow body with a gas.
   |18| A process for the preparation of a formed body comprising the following steps:
   (1) Providing a quartz glass body according to embodiment |15| or obtainable according to a process according to one of embodiments |1| to |14|;
   (2) Forming the quartz glass body to obtain the formed body.

### General

In the present description disclosed ranges also include the boundary values. A disclosure of the form “in the range from X to Y” in relation to a parameter A therefore means that A can take the values X, Y and values in between X and Y. Ranges bounded on one side of the form “up to Y” for a parameter A mean correspondingly the value Y and those less than Y.

### DETAILED DESCRIPTION OF THE INVENTION

A first aspect of the present invention is a process for the preparation of a quartz glass body comprising the process steps:
i.) Providing a silicon dioxide granulate comprising the process steps:
ii.) Making a first glass melt out of the silicon dioxide granulate;
iii.) Making a glass product out of at least one part of the first glass melt;
iv.) Reducing the size of the glass product to obtain a quartz glass grain;
v.) Making a further glass melt from the quartz glass grain;
vi.) Making the quartz glass body out of at least one part of the further glass melt.

### Step i.)

According to the invention, the provision of the silicon dioxide granulate comprises the following process steps:
I. Providing a pyrogenically produced silicon dioxide powder; and
II. Processing the silicon dioxide powder to obtain a silicon dioxide granulate, wherein the silicon dioxide granulate has a greater particle diameter than the silicon dioxide powder.

A powder means particles of a dry solid material with a primary particle size in the range from 1 to less than 100 nm.

The silicon dioxide granulate can be obtained by granulating silicon dioxide powder. A silicon dioxide granulate commonly has a BET surface area of 3 m²/g or more and a density of less than 1.5 g/cm³. Granulating means transforming powder particles into granules. During granulation, clusters of multiple silicon dioxide powder particles, i.e. larger agglomerates, form which are referred to as “silicon dioxide granules”. These are often also called “silicon dioxide granulate particles” or “granulate particles”. Collectively, the granules form a granulate, e.g. the silicon dioxide granules form a “silicon dioxide granulate”. The silicon dioxide granulate has a larger particle diameter than the silicon dioxide powder. The granulation procedure, for transforming a powder into a granulate, will be described in more detail later.

Silicon dioxide grain in the present context means silicon dioxide particles which are obtainable by reduction in size of a silicon dioxide body, in particular of a quartz glass body. A silicon dioxide grain commonly has a density of more than 1.2 g/cm³, for example in a range from 1.2 to 2.2 g/cm³, and particularly preferably of about 2.2 g/cm³.

Furthermore, the BET surface area of a silicon dioxide grain is preferably generally less than 1 m²/g, determined according to DIN ISO 9277:2014-01.

In principle, all silicon dioxide particles which are considered to be suitable by the skilled man can be selected. Preferred are silicon dioxide granulate and silicon dioxide grain.

Particle diameter or particle size mean the diameter of a particle, given as the “area equivalent circular diameter x_{Ai}” according to the formula

$${x}_{Ai} = \sqrt{\frac{4 {A}_{i}}{π}} ,$$

wherein Ai stands for the surface area of the observed particle by means of image analysis. Suitable methods for the measurement are for example ISO 13322-1:2014 or ISO 13322-2:2009. Comparative disclosures such as “greater particle diameter” always means that the values being compared are measured with the same method.

### Silicon Dioxide Powder

In the context of the present invention, synthetic silicon dioxide powder, namely pyrogenically produced silicon dioxide powder, is used.

The silicon dioxide powder can be any silicon dioxide powder which has at least two particles. As preparation process, any process which the skilled man considers to be prevalent in the art and suitable can be used.

According to a preferred embodiment of the present invention, the silicon dioxide powder is produced as side product in the preparation of quartz glass, in particular in the preparation of so called “soot bodies”. Silicon dioxide from such a source is often also called “soot dust”.

A preferred source for the silicon dioxide powder are silicon dioxide particles which are obtained from the synthetic preparation of soot bodies by application of flame hydrolysis burners. In the preparation of a soot body, a rotating carrier tube with a cylinder jacket surface is moved back and forth along a row of burners. Flame hydrolysis burners can be fed with oxygen and hydrogen as burner gases as well as the raw materials for making silicon dioxide primary particles. The silicon dioxide primary particles preferably have a primary particle size of up to 100 nm. The silicon dioxide primary particles produced by flame hydrolysis aggregate or agglomerate to form silicon dioxide particles with particle sizes of about 9 μm (DIN ISO 13320:2009-1). In the silicon dioxide particles, the silicon dioxide primary particles are identifiable by their form by scanning electron microscopy and the primary particle size can be measured. A portion of the silicon dioxide particles are deposited on the cylinder jacket surface of the carrier tube which is rotating about its longitudinal axis. In this way, the soot body is built up layer by layer. Another portion of the silicon dioxide particles are not deposited on the cylinder jacket surface of the carrier tube, rather they accumulate as dust, e.g. in a filter system. This other portion of silicon dioxide particles make up the silicon dioxide powder, often also called “soot dust”. In general, the portion of the silicon dioxide particles which are deposited on the carrier tube is greater than the portion of silicon dioxide particles which accumulate as soot dust in the context of soot body preparation, based on the total weight of the silicon dioxide particles.

These days, soot dust is generally disposed of as waste in an onerous and costly manner, or used as filler material without adding value, e.g. in road construction, as additive in the dyes industry, as a raw material for the tiling industry and for the preparation of hexafluorosilicic acid, which is employed for restoration of construction foundations. In the case of the present invention, it is a suitable raw material and can be processed to obtain a high-quality product.

Silicon dioxide prepared by flame hydrolysis is normally called pyrogenic silicon dioxide. Pyrogenic silicon dioxide is normally available in the form of amorphous silicon dioxide primary particles or silicon dioxide particles.

According to a preferred embodiment, the silicon dioxide powder can be prepared by flame hydrolysis out of a gas mixture. In this case, silicon dioxide particles are also created in the flame hydrolysis and are taken away before agglomerates or aggregates form. Here, the silicon dioxide powder, previously referred to as soot dust, is the main product.

Suitable raw materials for creating the silicon dioxide powder are preferably siloxanes, silicon alkoxides and inorganic silicon compounds. Siloxanes means linear and cyclic polyalkylsiloxanes. Preferably, polyalkylsiloxanes have the general formula

SiₚOₚR₂ₚ,
wherein p is an integer of at least 2, preferably from 2 to 10, particularly preferably from 3 to 5, and R is an alkyl group with 1 to 8 C-atoms, preferably with 1 to 4 C-atoms, particularly preferably a methyl group.

Particularly preferred are siloxanes selected from the group consisting of hexamethyldisiloxane, hexamethylcyclotrisiloxane (D3), octamethylcyclotetrasiloxane (D4) and decamethylcyclopentasiloxane (D5) or a combination of two or more thereof. If the siloxane comprises D3, D4 and D5, then D4 is preferably the main component. The main component is preferably present in an amount of at least 70 wt.-%, preferably of at least 80 wt.-%, for example of at least 90 wt.-% or of at least 94 wt.-%, particularly preferably of at least 98 wt.-%, in each case based on the total amount of the silicon dioxide powder. Preferred silicon alkoxides are tetramethoxysilane and methyltrimethoxysilane. Preferred inorganic silicon compounds as raw material for silicon dioxide powder are silicon halides, silicates, silicon carbide and silicon nitride. Particularly preferred inorganic silicon compounds as raw material for silicon dioxide powder are silicon tetrachloride and trichlorosilane.

According to a preferred embodiment, the silicon dioxide powder can be prepared from a compound selected from the group consisting of siloxanes, silicon alkoxides and silicon halides.

Preferably, the silicon dioxide powder can be prepared from a compound selected from the group consisting of hexamethyldisiloxane, hexamethylcyclotrisiloxane, octamethylcyclotetrasiloxane and decamethylcyclopentasiloxane, tetramethoxysilane and methyltrimethoxysilane, silicon tetrachloride and trichlorosilane or a combination of two or more thereof, for example out of silicon tetrachloride and octamethylcyclotetrasiloxane, particularly preferably out of octamethylcyclotetrasiloxane.

For making silicon dioxide out of silicon tetrachloride by flame hydrolysis, various parameters are significant. A preferred composition of a suitable gas mixture comprises an oxygen content in the flame hydrolysis in a range from 25 to 40 vol.-%. The content of hydrogen can be in a range from 45 to 60 vol.-%. The content of silicon tetrachloride is preferably 5 to 30 vol.-%, all of the afore mentioned vol.-% being based on the total volume of the gas flow. Further preferred is a combination of the above mentioned volume proportions for oxygen, hydrogen and SiCl₄. The flame in the flame hydrolysis preferably has a temperature in a range from 1500 to 2500° C., for example in a range from 1600 to 2400° C., particularly preferably in a range from 1700 to 2300° C. Preferably, the silicon dioxide primary particles created in the flame hydrolysis are taken away as silicon dioxide powder before agglomerates or aggregates form.

According to a preferred embodiment of the first aspect of the invention, the silicon dioxide powder has at least one, for example at least two or at least three or at least four, particularly preferably at least five of the following features:
a. a BET surface area in a range from 20 to 60 m²/g, for example from 25 to 55 m²/g, or from 30 to 50 m²/g, particularly preferably from 20 to 40 m²/g,
b. a bulk density 0.01 to 0.3 g/cm³, for example in the range from 0.02 to 0.2 g/cm³, preferably in the range from 0.03 to 0.15 g/cm³, further preferably in the range from 0.1 to 0.2 g/cm³ or in the range from 0.05 to 0.1 g/cm³.
c. a carbon content of less than 50 ppm, for example of less than 40 ppm or of less than 30 ppm, particularly preferably in a range from 1 ppb to 20 ppm;
d. a chlorine content of less than 200 ppm, for example of less than 150 ppm or of less than 100 ppm, particularly preferably in a range from 1 ppb to 80 ppm;
e. an aluminium content of less than 200 ppb, for example in the range from 1 to 100 ppb, particularly preferably in the range from 1 to 80 ppb;
f. a total content of metals different to aluminium of less than 5 ppm, for example of less than 2 ppm, particularly preferably in a range from 1 ppb to 1 ppm;
g. at least 70 wt.-% of the powder particles have a primary particle size in a range from 10 to less than 100 nm, for example in the range from 15 to less than 100 nm, particularly preferably in the range from 20 to less than 100 nm;
h. a tamped density in a range from 0.001 to 0.3 g/cm³, for example in the range from 0.002 to 0.2 g/cm³ or from 0.005 to 0.1 g/cm³, preferably in the range from 0.01 to 0.06 g/cm³, and preferably in the range from 0.1 to 0.2 g/cm³, or in the range of from 0.15 to 0.2 g/cm³;
i. a residual moisture content of less than 5 wt.-%, for example in the range from 0.25 to 3 wt.-%, particularly preferably in the range from 0.5 to 2 wt.-%;
j. a particle size distribution D₁₀ in the range from 1 to 7 μm, for example in the range from 2 to 6 μm or in the range from 3 to 5 μm, particularly preferably in the range from 3.5 to 4.5 μm;
k. a particle size distribution D₅₀ in the range from 6 to 15 μm, for example in the range from 7 to 13 μm or in the range from 8 to 11 μm, particularly preferably in the range from 8.5 to 10.5 μm;
l. a particle size distribution D₉₀ in the range from 10 to 40 μm, for example in the range from 15 to 35 μm, particularly preferably in the range from 20 to 30 μm;
wherein the wt.-%, ppm and ppb are each based on the total weight of the silicon dioxide powder.

The silicon dioxide powder contains silicon dioxide. Preferably, the silicon dioxide powder contains a proportion of silicon dioxide of more than 95 wt.-%, for example more than 98 wt.-% or more than 99 wt.-%. or more than 99.9 wt.-%, in each case based on the total weight of the silicon dioxide powder. Particularly preferably, the silicon dioxide powder contains a proportion of silicon dioxide of more than 99.99 wt.-%, based on the total weight of the silicon dioxide powder.

Preferably, the silicon dioxide powder has a metal content of metals different from aluminium of less than 5 ppm, for example of less than 2 ppm, particularly preferably of less than 1 ppm, in each case based on the total weight of the silicon dioxide powder. Often however, the silicon dioxide powder has a content of metals different to aluminium of at least 1 ppb. Such metals are for example sodium, lithium, potassium, magnesium, calcium, strontium, germanium, copper, molybdenum, tungsten, titanium, iron and chromium. These can be present for example in elemental form, as an ion, or as part of a molecule or of an ion or of a complex.

Preferably, the silicon dioxide powder has a total content of further constituents of less than 30 ppm, for example of less than 20 ppm, particularly preferably of less than 15 ppm, the ppm in each case being based on the total weight of the silicon dioxide powder. Often however, the silicon dioxide powder has a content of further constituents of at least 1 ppb. Further constituents means all constituents of the silicon dioxide powder which do not belong to the following group: silicon dioxide, chlorine, aluminium, OH-groups.

In the present context, reference to a constituent, when the constituent is a chemical element, means that it can be present as element or as an ion or in a compound or a salt. For example the term “aluminium” includes in addition to metallic aluminium, also aluminium salts, aluminium oxides and aluminium metal complexes. For example, the term “chlorine” includes, in addition to elemental chlorine, chlorides such as sodium chloride and hydrogen chloride. Often, the further constituents are present in the same aggregate state as the material in which they are contained.

In the present context, in the case where a constituent is a chemical compound or a functional group, reference to the constituent means that the constituent can be present in the form disclosed, as a charged chemical compound or as derivative of the chemical compound. For example, reference to the chemical material ethanol includes, in addition to ethanol, also ethanolate, for example sodium ethanolate. Reference to “OH-group” also includes silanol, water and metal hydroxides. For example, reference to derivate in the context of acetic acid also includes acetic acid ester and acetic acid anhydride.

Preferably, at least 70% of the powder particles of the silicon dioxide powder, based on the number of powder particles, have a primary particle size of less than 100 nm, for example in the range from 10 to 100 nm or from 15 to 100 nm, and particularly preferably in the range from 20 to 100 nm. The primary particle size is measured by dynamic light scattering according to ISO 13320:2009-10.

Preferably at least 75% of the powder particles of the silicon dioxide powder, based on the number of powder particles, have a primary particle size of less than 100 nm, for example in the range from 10 to 100 nm or from 15 to 100 nm, and particularly preferably in the range from 20 to 100 nm.

Preferably, at least 80% of the powder particles of the silicon dioxide powder, based on the number of powder particles, have a primary particle size of less than 100 nm, for example in the range from 10 to 100 nm or from 15 to 100 nm, and particularly preferably in the range from 20 to 100 nm.

Preferably, at least 85% of the powder particles of the silicon dioxide powder, based on the number of powder particles, have a primary particle size of less than 100 nm, for example in the range from 10 to 100 nm or from 15 to 100 nm, and particularly preferably in the range from 20 to 100 nm.

Preferably, at least 90% of the powder particles of the silicon dioxide powder, based on the number of powder particles, have a primary particle size of less than 100 nm, for example in the range from 10 to 100 nm or from 15 to 100 nm, and particularly preferably in the range from 20 to 100 nm.

Preferably, at least 95% of the powder particles of the silicon dioxide powder, based on the number of powder particles, have a primary particle size of less than 100 nm, for example in the range from 10 to 100 nm or from 15 to 100 nm, and particularly preferably in the range from 20 to 100 nm.

Preferably, the silicon dioxide powder has a particle size D₁₀ in the range from 1 to 7 μm, for example in the range from 2 to 6 μm or in the range from 3 to 5 μm, particularly preferably in the range from 3.5 to 4.5 μm. Preferably, the silicon dioxide powder has a particle size D₅₀ in the range from 6 to 15 μm, for example in the range from 7 to 13 μm or in the range from 8 to 11 μm, particularly preferably in the range from 8.5 to 10.5 μm. Preferably, the silicon dioxide powder has a particle size D₉₀ in the range from 10 to 40 μm, for example in the range from 15 to 35 μm, particularly preferably in the range from 20 to 30 μm.

Preferably, the silicon dioxide powder has a specific surface area (BET-surface area) in a range from 20 to 60 m²/g, for example from 25 to 55 m²/g, or from 30 to 50 m²/g, particularly preferably from 20 to 40 m²/g. The BET surface area is determined according to the method of Brunauer, Emmet and Teller (BET) by means of DIN 66132 which is based on gas absorption at the surface to be measured.

Preferably, the silicon dioxide powder has a pH value of less than 7, for example in the range from 3 to 6.5 or from 3.5 to 6 or from 4 to 5.5, particularly preferably in the range from 4.5 to 5. The pH value can be determined by means of a single rod measuring electrode (4% silicon dioxide powder in water).

The silicon dioxide powder preferably has the feature combination a./b./c. or a./b./f. or a./b./g., further preferred the feature combination a./b./c./f. or a./b./c./g. or a./b./f./g., further preferably the feature combination a./b./c./f./g.

The silicon dioxide powder preferably has the feature combination a./b./c., wherein the BET surface area is in a range from 20 to 40 m²/g, the bulk density is in a range from 0.05 to 0.3 g/mL and the carbon content is less than 40 ppm.

The silicon dioxide powder preferably has the feature combination a./b./f., wherein the BET surface area is in a range from 20 to 40 m²/g, the bulk density is in a range from 0.05 to 0.3 g/mL and the total content of metals which are different to aluminium is in a range from 1 ppb to 1 ppm.

The silicon dioxide powder preferably has the feature combination a./b./g., wherein the BET surface area is in a range from 20 to 40 m²/g, the bulk density is in a range from 0.05 to 0.3 g/mL and at least 70 wt. % of the powder particles have a primary particle size in a range from 20 to less than 100 nm.

The silicon dioxide powder further preferably has the feature combination a./b./c./f., wherein the BET surface area is in a range from 20 to 40 m²/g, the bulk density is in a range from 0.05 to 0.3 g/mL, the carbon content is less than 40 ppm and the total content of metals which are different to aluminium is in a range from 1 ppb to 1 ppm.

The silicon dioxide powder further preferably has the feature combination a./b./c./g., wherein the BET surface area is in a range from 20 to 40 m²/g, the bulk density is in a range from 0.05 to 0.3 g/mL, the carbon content is less than 40 ppm and at least 70 wt. % of the powder particles have a primary particle size in a range from 20 to less than 100 nm.

The silicon dioxide powder further preferably has the feature combination a./b./f./g., wherein the BET surface area is in a range from 20 to 40 m²/g, the bulk density is in a range from 0.05 to 0.3 g/mL, the total content of metals which are different to aluminium is in a range from 1 ppb to 1 ppm and at least 70 wt. % of the powder particles have a primary particle size in a range from 20 to less than 100 nm.

The silicon dioxide powder has particularly preferably the feature combination a./b./c./f./g., wherein the BET surface area is in a range from 20 to 40 m²/g, the bulk density is in a range from 0.05 to 0.3 g/mL, the carbon content is less than 40 ppm, the total content of metals which are different to aluminium is in a range from 1 ppb to 1 ppm and at least 70 wt. % of the powder particles have a primary particle size in a range from 20 to less than 100 nm.

### Step II.

According to the invention, silicon dioxide powder is processed in step II to obtain a silicon dioxide granulate, wherein the silicon dioxide granulate has a greater particle diameter than the silicon dioxide powder. For this purpose, any processes known to the skilled man that lead to an increase in the particle diameter are suitable.

The silicon dioxide granulate has a particle diameter which is greater than the particle diameter of the silicon dioxide powder. Preferably, the particle diameter of the silicon dioxide granulate is in a range from 500 to 50,000 times as great as the particle diameter of the silicon dioxide powder, for example 1,000 to 10,000 times as great, particularly preferably 2,000 to 8,000 times as great.

Preferably, at least 90% of the silicon dioxide granulate provided in step i.) is made up of pyrogenically produced silicon dioxide powder, for example at least 95 wt.-% or at least 98 wt.-%, particularly preferably at least 99 wt.-% or more, in each case based on the total weight of the silicon dioxide granulate.

Preferably, the silicon dioxide granulate has
A) a carbon content in a range from 1 to 10 ppm.

According to a preferred embodiment of the first aspect of the invention, the silicon dioxide granulate employed has at least one, preferably at least two or at least three or at least four, particularly preferably all of the following features:
B) a BET surface area in the range from 20 m²/g to 50 m²/g;
C) a mean particle size in a range from 50 to 500 μm.
D) a bulk density in a range from 0.5 to 1.2 g/cm³, for example in a range from 0.6 to 1.1 g/cm³, particularly preferably in a range from 0.7 to 1.0 g/cm³;
E) an aluminium content of less than 200 ppb;
F) a tamped density in a range from 0.7 to 1.2 g/cm³;
G) a pore volume in a range from 0.1 to 2.5 mL/g, for example in a range from 0.15 to 1.5 mL/g; particularly preferably in a range from 0.2 to 0.8 mL/g;
H) an angle of repose in a range from 23 to 26°;
I) a particle size distribution D₁₀ in a range from 50 to 150 μm;
J) a particle size distribution D₅₀ in a range from 150 to 300 μm;
K) a particle size distribution D₉₀ in a range from 250 to 620 μm, wherein the ppm and ppb are each based on the total weight of the silicon dioxide granulate.

Preferably, the granules of the silicon dioxide granulate have a spherical morphology. Spherical morphology means a round or oval form of the particle. The granules of the silicon dioxide granulate preferably have a mean sphericity in a range from 0.7 to 1.3 SPHT3, for example a mean sphericity in a range from 0.8 to 1.2 SPHT3, particularly preferably a mean sphericity in a range from 0.85 to 1.1 SPHT3. The feature SPHT3 is described in the test methods.

Furthermore, the granules of the silicon dioxide granulate preferably have a mean symmetry in a range from 0.7 to 1.3 Symm3, for example a mean symmetry in a range from 0.8 to 1.2 Symm3, particularly preferably a mean symmetry in a range from 0.85 to 1.1 Symm3. The feature of the mean symmetry Symm3 is described in the test methods.

Preferably, the silicon dioxide granulate has a metal content of metals different to aluminium of less than 1000 ppb, for example of less than 500 ppb, particularly preferably of less than 100 ppb, in each case based on the total weight of the silicon dioxide granulate. Often however, the silicon dioxide granulate has a content of metals different to aluminium of at least 1 ppb. Often, the silicon dioxide granulate has a metal content of metals different to aluminium of less than 1 ppm, preferably in a range from 40 to 900 ppb, for example in a range from 50 to 700 ppb, particularly preferably in a range from 60 to 500 ppb, in each case based on the total weight of the silicon dioxide granulate. Such metals are for example sodium, lithium, potassium, magnesium, calcium, strontium, germanium, copper, molybdenum, titanium, iron and chromium. These can for example be present as an element, as an ion, or as part of a molecule or of an ion or of a complex.

The silicon dioxide granulate can comprise further constituents, for example in the form of molecules, ions or elements. Preferably, the silicon dioxide granulate comprises less than 500 ppm of further constituents, for example less than 300 ppm, particularly preferably less than 100 ppm, in each case based on the total weight of the silicon dioxide granulate. Often, at least 1 ppb of further constituents are comprised. The further constituents can in particular be selected from the group consisting of carbon, fluoride, iodide, bromide, phosphorus or a mixture of at least two thereof.

Preferably, the silicon dioxide granulate comprises less than 10 ppm carbon, for example less than 8 ppm or less than 5 ppm, particularly preferably less than 4 ppm, in each case based on the total weight of the silicon dioxide granulate. Often, at least 1 ppb of carbon is comprised in the silicon dioxide granulate.

Preferably, the silicon dioxide granulate comprises less than 100 ppm of further constituents, for example less than 80 ppm, particularly preferably less than 70 ppm, in each case based on the total weight of the silicon dioxide granulate. Often however, at least 1 ppb of the further constituents are comprised in the silicon dioxide granulate.

Preferably, step II. comprises the following steps:
II.1. Providing a liquid;
II.2. Mixing the silicon dioxide powder with the liquid to obtain a slurry;
II.3. Granulating, preferably spray drying the slurry wherein the silicon dioxide granulate is obtained.

In the context of the present invention, a liquid means a material or a mixture of materials which is liquid at a pressure of 1013 hPa and a temperature of 20° C.

A “slurry” in the context of the present invention means a mixture of at least two materials, wherein the mixture, considered under the prevailing conditions, comprises at least one liquid and at least one solid.

Suitable liquids are all materials and mixtures of materials known to the skilled man and which appear suitable for the present application. Preferably, the liquid is selected from the group consisting of organic liquids and water. Preferably, the solubility of the silicon dioxide powder in the liquid is less than 0.5 g/L, preferably less than 0.25 g/L, particularly preferably less than 0.1 g/L, the g/L each given as g silicon dioxide powder per litre liquid.

Preferred suitable liquids are polar solvents. These can be organic liquids or water. Preferably, the liquid is selected from the group consisting of water, methanol, ethanol, n-propanol, iso-propanol, n-butanol, tert-butanol and mixtures of more than one thereof. Particularly preferably, the liquid is water. Particularly preferably, the liquid comprises distilled or de-ionised water.

Preferably, the silicon dioxide powder is processed to obtain a slurry comprising silicon dioxide powder. The silicon dioxide powder is virtually insoluble in the liquid at room temperature, but can be introduced into the liquid in high weight proportions to obtain the slurry comprising silicon dioxide powder.

The silicon dioxide powder and the liquid can be mixed in any manner. For example, the silicon dioxide powder can be added to the liquid, or the liquid can be added to the silicon dioxide powder. The mixture can be agitated during the addition or following the addition. Particularly preferably, the mixture is agitated during and following the addition. Examples for the agitation are shaking and stirring, or a combination of both. Preferably, the silicon dioxide powder can be added to the liquid under stirring. Furthermore, preferably, a portion of the silicon dioxide powder can be added to the liquid, wherein the mixture thus obtained is agitated, and the mixture is subsequently mixed with the remaining portion of the silicon dioxide powder. Likewise, a portion of the liquid can be added to the silicon dioxide powder, wherein the mixture thus obtained is agitated, and the mixture subsequently mixed with the remaining portion of the liquid.

By mixing the silicon dioxide powder and the liquid, a slurry comprising silicon dioxide powder is obtained. Preferably, the slurry comprising silicon dioxide powder is a suspension in which the silicon dioxide powder is distributed uniformly in the liquid. “Uniform” means that the density and the composition of the slurry comprising silicon dioxide powder at each position does not deviate from the average density and from the average composition by more than 10%, in each case based on the total amount of slurry comprising silicon dioxide powder. A uniform distribution of the silicon dioxide powder in the liquid can prepared, or obtained, or both, by an agitation as mentioned above.

Preferably, the slurry comprising silicon dioxide powder has a weight per litre in the range from 1000 to 2000 g/L, for example in the range from 1200 to 1900 g/L or from 1300 to 1800 g/L, particularly preferably in the range from 1400 to 1700 g/L. The weight per litre is measured by weighing a volume calibrated container.

According to a preferred embodiment, at least one, for example at least two or at least three or at least four, particularly preferably at least five of the following features applies to the slurry comprising silicon dioxide powder:
{a} the slurry comprising silicon dioxide powder is transported in contact with a plastic surface;
{b} the slurry comprising silicon dioxide powder is sheared;
{c} the slurry comprising silicon dioxide powder has a temperature of more than 0° C., preferably in a range from 5 to 35° C.;
{d} the slurry comprising silicon dioxide powder has a zeta potential at a pH value of 7 in a range from 0 to −100 mA, for example from −20 to −60 mA, particularly preferably from −30 to −45 mA;
{e} the slurry comprising silicon dioxide powder has a pH value in a range of 7 or more, for example of more than 7 or a pH value in the range from 7.5 to 13 or from 8 to 11, particularly preferably from 8.5 to 10;
{f} the slurry comprising silicon dioxide powder has an isoelectric point of less than 7, for example in a range from 1 to 5 or in a range from 2 to 4, particularly preferably in a range from 3 to 3.5;
{g} the slurry comprising silicon dioxide powder has a solids content of at least 40 wt.-%, for example in a range from 50 to 80 wt.-%, or in a range from 55 to 75 wt.-%, particularly preferably in a range from 60 to 70 wt.-%, in each case based on the total weight of the slurry;
{h} the slurry comprising silicon dioxide powder has a viscosity according to DIN 53019-1 (5 rpm, 30 wt. %) in a range from 500 to 1000 mPas, for example in the range from 600 to 900 mPas or from 650 to 850 mPas, particularly preferably in the range from 700 to 800 mPas;
{i} the slurry comprising silicon dioxide powder has a thixotropy according to DIN SPEC 91143-2 (30 wt. % in water, 23° C., 5 rpm/50 rpm) in the range from 3 to 6, for example in the range from 3.5 to 5, particularly preferably in the range from 4.0 to 4.5;
{j} the silicon dioxide particles in the slurry comprising silicon dioxide powder have in a 4 wt.-% slurry comprising silicon dioxide powder a mean particle size in suspension according to DIN ISO 13320-1 in the range from 100 to 500 nm, for example in a range from 200 to 300 nm.

Preferably, the silicon dioxide particles in a 4 wt.-% aqueous slurry comprising silicon dioxide powder have a particle size D₁₀ in a range from 50 to 250 nm, particularly preferably in the range from 100 to 150 mm Preferably, the silicon dioxide particles in a 4 wt.-% aqueous slurry comprising silicon dioxide powder have a particle size D₅₀ in a range from 100 to 400 nm, particularly preferably in the range from 200 to 250 mm Preferably, the silicon dioxide particles in a 4 wt.-% aqueous slurry comprising silicon dioxide powder have a particle size D₉₀ in a range from 200 to 600 nm, particularly preferably in a range from 350 to 400 mm. The particle size is measured according to DIN ISO 13320-1.

“Isoelectric point” means the pH value at which the zeta potential takes the value 0. The zeta potential is measured according to ISO 13099-2:2012.

Preferably, the pH value of the slurry comprising silicon dioxide powder is set to a value in the range given above. Preferably, the pH value can be set by adding to the slurry comprising silicon dioxide powder materials such as NaOH or NH₃, for example as aqueous solution. During this process, the slurry comprising silicon dioxide powder is often agitated.

### Granulation

The silicon dioxide granulate is obtained from the silicon dioxide powder by granulation. Granulation means the transformation of powder particles into granules. During granulation, larger agglomerates which are referred to as “silicon dioxide granules” are formed by agglomeration of multiple silicon dioxide powder particles. These are often also called “silicon dioxide particles”, “silicon dioxide granulate particles” or “granulate particles”. Collectively, granules make up a granulate, e.g. the silicon dioxide granules make up a “silicon dioxide granulate”.

In the present case, any granulation process which is known to the skilled man and appears to him to be suitable for the granulation of silicon dioxide powder can in principle be selected. Granulation processes can be categorised as agglomeration granulation processes or press granulation processes, and further categorised as wet and dry granulation processes. Known methods are roll granulation in a granulation plate, spray granulation, centrifugal pulverisation, fluidised bed granulation, granulation processes employing a granulation mill, compactification, roll pressing, briquetting, scabbing or extruding.

### Spray Drying

According to a preferred embodiment of the first aspect of the invention, a silicon dioxide granulate is obtained by spray granulation of the slurry comprising silicon dioxide powder. Spray granulation is also known as spray drying.

Spray drying is preferably effected in a spray tower. For spray drying, the slurry comprising silicon dioxide powder is preferably put under pressure at a raised temperature. The pressurised slurry comprising silicon dioxide powder is then depressurised via a nozzle and thus sprayed into the spray tower. Subsequently, droplets form which instantly dry and first form dry minute particles (“nuclei”). The minute particles form, together with a gas flow applied to the particles, a fluidised bed. In this way, they are maintained in a floating state and can thus form a surface for drying further droplets.

The nozzle, through which the slurry comprising silicon dioxide powder is sprayed into the spray tower, preferably forms an inlet into the interior of the spray tower.

The nozzle preferably has a contact surface with the slurry comprising silicon dioxide powder during spraying. “Contact surface” means the region of the nozzle which comes into contact with the slurry comprising silicon dioxide powder during spraying. Often, at least part of the nozzle is formed as a tube through which the slurry comprising silicon dioxide powder is guided during spraying, so that the inner side of the hollow tube comes into contact with the slurry comprising silicon dioxide powder.

The contact surface preferably comprises a glass, a plastic or a combination thereof. Preferably, the contact surface comprises a glass, particularly preferably quartz glass. Preferably, the contact surface comprises a plastic. In principle, all plastics known to the skilled man, which are stable at the process temperatures and do not pass any foreign atoms to the slurry comprising silicon dioxide powder, are suitable. Preferred plastics are polyolefins, for example homo- or co-polymers comprising at least one olefin, particularly preferably homo- or co-polymers comprising polypropylene, polyethylene, polybutadiene or combinations of two or more thereof. Preferably, the contact surface is made of a glass, a plastic or a combination thereof, for example selected from the group consisting of quartz glass and polyolefins, particularly preferably selected from the group consisting of quartz glass and homo- or co-polymers comprising polypropylene, polyethylene, polybutadiene or combinations of two or more thereof. Preferably, the contact surface comprises no metals, in particular no tungsten, titanium, tantalum, chromium, cobalt, nickel, iron, vanadium, zirconium and manganese.

It is in principle possible for the contact surface and the further parts of the nozzle to be made of the same or from different materials. Preferably, the further parts of the nozzle comprise the same material as the contact surface. It is likewise possible for the further parts of the nozzle to comprise a material different to the contact surface. For example, the contact surface can be coated with a suitable material, for example with a glass or with a plastic.

Preferably, the nozzle is more than 70 wt.-%, based on the total weight of the nozzle, made out of an item selected from the group consisting of glass, plastic or a combination of glass and plastic, for example more than 75 wt.-% or more than 80 wt.-% or more than 85 wt.-% or more than 90 wt.-% or more than 95 wt.-%, particularly preferably more than 99 wt.-%.

Preferably, the nozzle comprises a nozzle plate. The nozzle plate is preferably made of glass, plastic or a combination of glass and plastic. Preferably, the nozzle plate is made of glass, particularly preferably quartz glass. Preferably, the nozzle plate is made of plastic. Preferred plastics are polyolefins, for example homo- or co-polymers comprising at least one olefin, particularly preferably homo- or co-polymers comprising polypropylene, polyethylene, polybutadiene or combinations of two or more thereof. Preferably, the nozzle plate comprises no metals, in particular no tungsten, titanium, tantalum, chromium, cobalt, nickel, iron, vanadium, zirconium and manganese.

Preferably, the nozzle comprises a screw twister. The screw twister is preferably made of glass, plastic or a combination of glass and plastic. Preferably, the screw twister is made of glass, particularly preferably quartz glass. Preferably, the screw twister is made of plastic. Preferred plastics are polyolefins, for example homo- or co-polymers comprising at least one olefin, particularly preferably homo- or co-polymers comprising polypropylene, polyethylene, polybutadiene or combinations of two or more thereof. Preferably, the screw twister comprises no metals, in particular no tungsten, titanium, tantalum, chromium, cobalt, nickel, iron, vanadium, zirconium and manganese.

Furthermore, the nozzle can comprise further constituents. Preferred further constituents are a nozzle body, particularly preferable is a nozzle body which surrounds the screw twister and the nozzle plate, a cross piece and a baffle. Preferably, the nozzle comprises one or more, particularly preferably all, of the further constituents. The further constituents can independently from each other be made of in principle any material which is known to the skilled man and which is suitable for this purpose, for example of a metal comprising material, of glass or of a plastic.

Preferably, the nozzle body is made of glass, particularly preferably quartz glass. Preferably, the further constituents are made of plastic. Preferred plastics are polyolefins, for example homo- or co-polymers comprising at least one olefin, particularly preferably homo- or co-polymers comprising polypropylene, polyethylene, polybutadiene or combinations of two or more thereof. Preferably, the further constituents comprise no metals, in particular no tungsten, titanium, tantalum, chromium, cobalt, nickel, iron, vanadium, zirconium and manganese.

Preferably, the spray tower comprises a gas inlet and a gas outlet. Through the gas inlet, a gas can be introduced into the interior of the spray tower, and through the gas outlet it can be let out. It is also possible to introduce gas into the spray tower via the nozzle. Likewise, gas can be let out via the outlet of the spray tower. Furthermore, gas can preferably be introduced via the nozzle and a gas inlet of the spray tower, and let out via the outlet of the spray tower and a gas outlet of the spray tower.

Preferably, in the interior of the spray tower is present an atmosphere selected from air, an inert gas, at least two inert gases or a combination of air with at least one inert gas, preferably a combination of air with at least one inert gas, and preferably two inert gases. Inert gasses are preferably selected from the list consisting of nitrogen, helium, neon, argon, krypton and xenon. For example, in the interior of the spray tower there is present air, nitrogen or Argon, particularly preferably air.

Further preferably, the atmosphere present in the spray tower is part of a gas flow. The gas flow is preferably introduced into the spray tower via a gas inlet and let out via a gas outlet. It is also possible to introduce parts of the gas flow via the nozzle and to let out parts of the gas flow via a solids outlet. The gas flow can take on further constituents in the spray tower. These can come from the slurry comprising silicon dioxide powder during the spray drying and transfer to the gas flow.

Preferably, a dry gas flow is fed to the spray tower. A dry gas flow means a gas or a gas mixture which has a relative humidity at the temperature set in the spray tower below the condensation point. A relative air humidity of 100% corresponds to a water content of 17.5 g/m³ at 20° C. The gas is preferably pre-warmed to a temperature in a range from 150 to 450° C., for example from 200 to 420° C. or from 300 to 400° C., particularly preferably from 350 to 400° C.

The interior of the spray tower is preferably temperature-controllable. Preferably, the temperature in the interior of the spray tower has a value up to 550° C., for example 300 to 500° C., particularly preferably 350 to 450° C.

The gas flow preferably has a temperature at the gas inlet in a range from 150 to 450° C., for example from 200 to 420° C. or from 300 to 400° C., particularly preferably from 350 to 400° C.

The gas flow which is let out at the solids outlet, at the gas outlet or at both locations, preferably has a temperature of less than 170° C., for example from 50 to 150° C., particularly preferably from 100 to 130° C.

Furthermore, the difference between the temperature of the gas flow on introduction and of the gas flow on expulsion is preferably in a range from 100 to 330° C., for example from 150 to 300° C.

The thus obtained silicon dioxide granules are present as an agglomerate of individual particles of silicon dioxide powder. The individual particles of the silicon dioxide powder continue to be recognizable in the agglomerate. The mean particle size of the particles of the silicon dioxide powder is preferably in the range from 10 to 1000 nm, for example in the range from 20 to 500 nm or from 30 to 250 nm or from 35 to 200 nm or from 40 to 150 nm, or particularly preferably in the range from 50 to 100 nm. The mean particle size of these particles is measured according to DIN ISO 13320-1.

The spray drying can be carried out in the presence of auxiliaries. In principle, all materials can be employed as auxiliaries, which are known to the skilled man and which appear suitable for the present application. As auxiliary material for example, so-called binders can be considered. Examples of suitable binding materials are metal oxides such as calcium oxide, metal carbonates such as calcium carbonate and polysaccharides such as cellulose, cellulose ether, starch and starch derivatives.

Particularly preferably, the spray drying is carried out in the context of the present invention without auxiliaries.

Preferably, before, after or before and after the removal of the silicon dioxide granulate from the spray tower a portion thereof is separated off. For separating off, all processes which are known to the skilled man and which appear suitable can be considered. Preferably, the separating off is effected by a screening or a sieving.

Preferably, before removal from the spray tower of the silicon dioxide granulate which have been formed by spray drying, particles with a particle size of less than 50 μm, for example with a particle size of less than 70 μm particularly preferably with a particle size of less than 90 μm are separated off by screening. The screening is effected preferably using a cyclone arrangement, which is preferably arranged in the lower region of the spray tower, particularly preferably above the outlet of the spray tower.

Preferably, after removal of the silicon dioxide granulate from the spray tower, particles with a particle size of greater than 1000 μm, for example with a particle size of greater than 700 μm, particularly preferably with a particle size of greater than 500 μm are separated off by sieving. The sieving of the particles can in principle by effected in accordance with all processes known to the skilled man and which are suitable for this purpose. Preferably, the sieving is effected using a vibrating chute.

According to a preferred embodiment, the Dray drying of the slurry comprising silicon dioxide powder through a nozzle into a spray tower is characterised by at least one, for example two or three, particularly preferably all of the following features:
a] spray granulation in a spray tower;
b] the presence of a pressure of the slurry comprising silicon dioxide powder at the nozzle of not more than 40 bar, for example in a range from 1.3 to 20 bar, from 1.5 to 18 bar or from 2 to 15 bar or from 4 to 13 bar, or particularly preferably in the range from 5 to 12 bar, wherein the pressure is given in absolute terms (relative to p=0 hPa);
c] a temperature of the droplets upon entering into the spray tower in a range from 10 to 50° C., preferably in a range from 15 to 30° C., particularly preferably in a range from 18 to 25° C.
d] a temperature at the side of the nozzle directed towards the spray tower in a range from 100 to 450° C., for example in a range from 250 to 440° C., particularly preferably from 350 to 430° C.;
e] A throughput of slurry comprising silicon dioxide powder through the nozzle in a range from 0.05 to 1 m³/h, for example in a range from 0.1 to 0.7 m³/h or from 0.2 to 0.5 m³/h, particularly preferably in a range from 0.25 to 0.4 m³/h;
f] A solids content of the slurry comprising silicon dioxide powder of at least 40 wt.-%, for example in a range from 50 to 80 wt.-%, or in a range from 55 to 75 wt.-%, particularly preferably in a range from 60 to 70 wt.-%, in each case based on the total weight of the slurry comprising silicon dioxide powder;
g] A gas inflow into the spray tower in a range from 10 to 100 kg/min, for example in a range from 20 to 80 kg/min or from 30 to 70 kg/min, particularly preferably in a range from 40 to 60 kg/min;
h] A temperature of the gas flow upon entering into the spray tower in a range from 100 to 450° C., for example in a range from 250 to 440° C., particularly preferably from 350 to 430° C.;
i] A temperature of the gas flow at the exit out of the spray tower of less than 170° C.;
j] The gas is selected form the group consisting of air, nitrogen and helium, or a combination of two or more thereof; preferably air;
k] a residual moisture content of the granulate on removal out of the spray tower of less than 5 wt.-%, for example of less than 3 wt.-% or of less than 1 wt.-% or in a range from 0.01 to 0.5 wt.-%, particularly preferably in a range from 0.1 to 0.3 wt.-%, in each case based on the total weight of the silicon dioxide granulate created in the spray drying;
l] at least 50 wt.-% of the spray granulate, based on the total weight of the silicon dioxide granulate created in the spray drying, completes a flight time in a range from 1 to 100 s, for example of a period from 10 to 80 s, particularly preferably over a period from 25 to 70 s;
m] at least 50 wt.-% of the spray granulate, based on the total weight of the silicon dioxide granulate created in the spray drying, covers a flight path of more than 20 m, for example of more than 30 or of more than 50 or of more than 70 or of more than 100 or of more than 150 or of more than 200 or in a range from 20 to 200 m or from 10 to 150 or from 20 to 100, particularly preferably a range from 30 to 80 m.
n] the spray tower has a cylindrical geometry;
o] a height of the spray tower of more than 10 m, for example of more than 15 m or of more than 20 m or of more than 25 m or of more than 30 m or in a range from 10 to 25 m, particularly preferably in a range from 15 to 20 m;
p] screening out of particles with a size of less than 90 μm before the removal of the granulate from the spray tower;
q] sieving out of particles with a size of more than 500 μm after the removal of the granulate from the spray tower, preferably in a vibrating chute;
r] The exit of the droplets of the slurry comprising silicon dioxide powder out of the nozzle occurs at an angle of 30 to 60 degrees from vertical, particularly preferably at an angle of 45 degree from vertical.

Vertical means the direction of the gravitational force vector.

The flight path means the path covered by a droplet of slurry comprising silicon dioxide powder from exiting out of the nozzle in the gas chamber of the spray tower to form a granule up to completion of the action of flying and falling. The action of flying and falling frequently ends by the granule impacting with the floor of the spray tower impacting or the granule impacting with other granules already lying on the floor of the spray tower, whichever occurs first.

The flight time is the period required by a granule to cover the flight path in the spray tower. Preferably, the granules have a helical flight path in the spray tower.

Preferably, at least 60 wt.-% of the spray granulate, based on the total weight of the silicon dioxide granulate created in the spray drying, cover a mean flight path of more than 20 m, for example of more than 30 or of more than 50 or of more than 70 or of more than 100 or of more than 150 or of more than 200 or in a range from 20 to 200 m or from 10 to 150 or from 20 to 100, particularly preferably a range from 30 to 80 m.

Preferably, at least 70 wt.-% of the spray granulate, based on the total weight of the silicon dioxide granulate created in the spray drying, cover a mean flight path of more than 20 m, for example of more than 30 or of more than 50 or of more than 70 or of more than 100 or of more than 150 or of more than 200 or in a range from 20 to 200 m or from 10 to 150 or from 20 to 100, particularly preferably a range from 30 to 80 m.

Preferably, at least 80 wt.-% of the spray granulate, based on the total weight of the silicon dioxide granulate created in the spray drying, cover a mean flight path of more than 20 m, for example of more than 30 or of more than 50 or of more than 70 or of more than 100 or of more than 150 or of more than 200 or in a range from 20 to 200 m or from 10 to 150 or from 20 to 100, particularly preferably a range from 30 to 80 m.

Preferably, at least 90 wt.-% of the spray granulate, based on the total weight of the silicon dioxide granulate created in the spray drying, cover a mean flight path of more than 20 m, for example of more than 30 or of more than 50 or of more than 70 or of more than 100 or of more than 150 or of more than 200 or in a range from 20 to 200 m or from 10 to 150 or from 20 to 100, particularly preferably a range from 30 to 80 m.

Roll Granulation

According to a preferred embodiment of the first aspect of the invention of the invention, a silicon dioxide granulate is obtained by roll granulation of the slurry comprising silicon dioxide powder.

The roll granulation is carried out by stirring the slurry comprising silicon dioxide powder in the presence of a gas at raised temperature. Preferably, the roll granulation is effected in a stirring vessel fitted with a stirring tool. Preferably, the stirring vessel rotates in the opposite sense to the stirring tool. Preferably, the stirring vessel additionally comprises an inlet through which the silicon dioxide powder can be introduced into the stirring vessel, an outlet through which the silicon dioxide granulate can be removed, a gas inlet and a gas outlet.

For stirring the slurry comprising silicon dioxide powder, preferably a pin-type stirring tool is used. A pin-type stirring tool means a stirring tool fitted with multiple elongate pins having their longitudinal axis coaxial with the rotational axis of the stirring tool. The trajectory of the pins preferably traces coaxial circles around the axis of rotation.

Preferably, the slurry comprising silicon dioxide powder is set to a pH value of less than 7, for example to a pH value in the range from 2 to 6.5, particularly preferably to a pH value in a range from 4 to 6. For setting the pH value, an inorganic acid is preferably used, for example an acid selected from the group consisting of hydrochloric acid, sulphuric acid, nitric acid and phosphoric acid, particularly preferably hydrochloric acid.

Preferably, in the stirring vessel is present an atmosphere selected from air, an inert gas, at least two inert gases or a combination of air with at least one inert gas, preferably at least two inert gases. Inert gases are preferably selected from the list consisting of nitrogen, helium, neon, argon, krypton and xenon. For example, air, nitrogen or argon is present in the stirring vessel, particularly preferably air.

Furthermore, preferably, the atmosphere present in the stirring vessel is part of a gas flow. The gas flow is preferably introduced into the stirring vessel via the gas inlet and let out via the gas outlet. The gas flow can take on further constituents in the stirring vessel. These can originate from the slurry comprising silicon dioxide powder in the roll granulation and transfer into the gas flow.

Preferably, a dry gas flow is introduced to the stirring vessel. A dry gas flow means a gas or a gas mixture which has a relative humidity at the temperature set in the stirring vessel under the condensation point. The gas is preferably pre-warmed to a temperature in a range from 50 to 300° C., for example from 80 to 250° C., particularly preferably from 100 to 200° C.

Preferably, per 1 kg of the employed slurry comprising silicon dioxide powder, 10 to 150 m³ gas per hour is introduced into the stirring vessel, for example 20 to 100 m³ gas per hour, particularly preferably 30 to 70 m³ gas per hour.

During the mixing, the slurry comprising silicon dioxide powder is dried by the gas flow to form silicon dioxide granules. The granulate which is formed is removed from the stirring vessel.

Preferably, the removed granulate is dried further. Preferably, the drying is effected continuously, for example in a rotary kiln. Preferred temperatures for the drying are in a range from 80 to 250° C., for example in a range from 100 to 200° C., particularly preferably in a range from 120 to 180° C.

In the context of the present invention, continuous in respect of a process means that it can be operated continuously. That means that the introduction and removal of materials involved in the process can be effected on an ongoing basis whilst the process is being run. It is not necessary to interrupt the process for this.

Continuous as an attribute of an object, e.g. in relation to a “continuous oven”, means that this object is configured in such a way that a process carried out therein, or a process step carried out therein, can be carried out continuously.

The granulate obtained from the roll granulation can be sieved. The sieving occur before or after the drying. Preferably it is sieved before drying. Preferably, granule with a particle size of less than 50 μm, for example with a particle size of less than 80 μm, particularly preferably with a particle size of less than 100 μm, are sieved out. Furthermore, preferably, granules with a particle size of greater than 900 μm, for example with a particle size of greater than 700 μm, particularly preferably with a particle size of greater than 500 μm, sieved out. The sieving out of larger particles can in principle be carried out in accordance with any process known to the skilled man and which is suitable for this purpose. Preferably, the sieving out of larger particles is carried out by means of a vibrating chute.

According to a preferred embodiment, the roll granulation is characterised by at least one, for example two or three, particularly preferably all of the following features:
The granulation is carried out in a rotating stirring vessel;
The granulation is carried out in a gas flow of 10 to 150 kg gas per hour and per 1 kg slurry comprising silicon dioxide powder;
The gas temperature on introduction is 40 to 200° C.;
Granules with a particle size of less than 100 μm and of more than 500 μm are sieved out;
The granules formed have a residual moisture content of 15 to 30 wt.-%;
The granules formed are dried at 80 to 250° C., preferably in a continuous drying tube, particularly preferably to a residual moisture content of less than 1 wt.-%.

Preferably, the silicon dioxide granulate obtained by granulation, preferably by spray- or roll-granulation, particularly preferably by spray granulation, also referred to as silicon dioxide granulate I, is treated before it is processed to obtain glass products. This pre-treatment can fulfil various purposes which either facilitate the processing to obtain glass products or influence the properties of the resulting glass products. For example, the silicon dioxide granulate I can be compacted, purified, surface-modified or dried.

Preferably, the silicon dioxide granulate I has a carbon content w_{C(1)} in a range from 1 to 200 ppm, for example in the range from 5 to 100 ppm or from 10 to 50 ppm, particularly preferably in the range from 15 to 35 ppm, each based on the total weight of the silicon dioxide granulate I. Further preferred ranges for the carbon content w_{C(1)} are from 5 to 200 ppm, 5 to 50 ppm, 5 to 35 ppm or 10 to 35 ppm.

Preferably, the silicon dioxide granulate I has an alkaline earth metals content w_{M(1)}. The alkaline earth metals content w_{M(1)} is preferably in a range from 10 ppb to 1000 ppb, for example in a range from 100 ppb to 900 ppb or from 200 ppb to 800 ppb, particularly preferably in a range from 300 ppb to 700 ppb, each based on the total weight of the silicon dioxide granulate I.

According to a preferred embodiment of the first aspect of the invention, a silicon dioxide I with a carbon content w_{C(1)} can be produced in different ways. In principle, all processes known to a person skilled in the art and suitable for producing a specific carbon content come into consideration. Preferably, carbon is fed to the process for preparing silicon dioxide I. Carbon can be fed at any point, for example when preparing pyrogenic silicon dioxide powder, when preparing silicon dioxide granulate I, in particular before, during or after granulation.

Preferably, a content of 1 to 10 ppm carbon is fed to the process according to the invention in step i.).

Carbon can be fed to the process in different forms known to a person skilled in the art and suitable for this purpose. Preferably, carbon is fed in elementary form or as a compound. Elemental carbon is fed preferably as a powder, for example as an amorphous powder, particularly preferably as carbon black, more preferably as a powder with a particle size of less than 200 μm, further preferably as a powder with a specific surface in a range from 50 to 500 m²/g. Particularly preferably, elemental carbon with a specific surface in a range from 50 to 500 m²/g is fed as carbon black.

In particular, compounds with a decomposition point of less than 600° C., which combust accompanied by soot production, are particularly suitable. Examples of such carbon compounds are hydrocarbon gases, in particular natural gas, methane, ethane, propane, butane, ethene and combinations of two or more thereof, siloxanes, in particular hexamethyldisiloxane, hexamethylcyclotrisiloxane, octamethylcyclotetrasiloxane, decamethylcyclopentasiloxane and combinations of two or more thereof, and silicon alkoxides, in particular tetramethoxysilane and methyltrimethoxysilane.

Preferably, the carbon content w_{C(1)} of the silicon dioxide granulate I can be produced by a shortage of oxygen when preparing the pyrogenic silicon dioxide powder in the flame. A shortage means a substoichiometric use of oxygen in respect of the reaction partners to represent the silicon dioxide, in particular hydrogen and one or more of the above-named carbon compounds. This process is particularly suitable if silicon dioxide powder is prepared from siloxanes or silicon alkoxides.

Preferably, the carbon content w_{C(1)} of the silicon dioxide granulate I can be produced by adding carbon to the slurry. Preferably, amorphous carbon powder is added to the slurry. Preferably, carbon in a content of less than 5000 ppm, for example in a content of 1 ppb to 200 ppm, particularly preferably in a content of 1 ppb to 20 ppm, in each case based on the total weight of the silicon dioxide powder, is added to the slurry.

Preferably, the carbon content w_{C(1)} of the silicon dioxide granulate I can be produced by adding carbon during granulation. It is in principle possible to add the carbon at any point during granulation. Preferably, carbon is added in the form of a carbon compound or a combination of two or more carbon compounds during granulation, for example hydrocarbon gases, particularly preferably natural gas, methane, ethane, propane, butane, ethene and combinations of two or more thereof.

In the case of spray granulation, the carbon can for example be sprayed through the nozzle into the spray tower together with the slurry. Preferably, the content of carbon is in a range from 1 ppb to 200 ppm, based on the total content of silicon dioxide, which is sprayed into the spray tower together with the slurry. According to a further example, the carbon can be present as a gaseous carbon compound in the gas chamber of the spray tower into which the slurry is sprayed. Preferably, the carbon compound is present in a content of 1 ppb to 500 ppm, based on the volume of the gas chamber of the spray tower.

In the case of roll granulation, the carbon can for example be added to the stirring container after insertion of the slurry in solid form, preferably as an amorphous carbon powder, or as a gas, preferably natural gas, methane, ethane, propane, butane, ethene or a combination of two or more thereof. Preferably, the carbon is added to the stirring container in a content of 1 ppb to 500 ppm, particularly preferably 1 ppm to 10 ppm, based on the total weight of the silicon dioxide.

Preferably, the carbon content w_{C(1)} of the silicon dioxide granulate I can be produced by adding carbon after granulation. Preferably, amorphous carbon powder is added to the silicon dioxide granulate I after granulation. Preferably, carbon is added in a content of less than 5000 ppm, for example in a content of 1 ppb to 200 ppm, particularly preferably in a content of 1 ppb to 20 ppm, in each case based on the total weight of the silicon dioxide granulate I. Preferably, carbon is added in an oven, for example in a continuous or a discontinuous oven, particularly preferably in a rotary kiln. Preferably, the oven has a gas atmosphere, in particular containing nitrogen, helium, hydrogen or combinations thereof, particularly preferably combinations of nitrogen and hydrogen or of helium and hydrogen. Preferably, the granulate is then treated in a second oven, preferably at a temperature in a range from 1000 to 1300° C.

Preferably, the silicon dioxide granulate I has at least one, for example at least two or at least three or at least four, particularly preferably at least five of the following features:
[A] a BET surface area in the range from 20 to 60 m²/g, or from 20 to 50 m²/g, for example in a range from 20 to 40 m²/g; particularly preferably in a range from 25 to 35 m²/g; wherein the micropore portion preferably accounts for a BET surface area in a range from 4 to 5 m²/g; for example in a range from 4.1 to 4.9 m²/g; particularly preferably in a range from 4.2 to 4.8 m²/g; and
[B] a mean particle size in a range from 180 to 300 μm;
[C] a bulk density in a range from 0.5 to 1.2 g/cm³, for example in a range from 0.6 to 1.1 g/cm³, particularly preferably in a range from 0.7 to 1.0 g/cm³;
[D] a carbon content of less than 50 ppm, for example less than 40 ppm or less than 30 ppm or less than 20 ppm or less than 10 ppm, particularly preferably in a range from 1 ppb to 5 ppm;
[E] an aluminium content of less than 200 ppb, preferably of less than 100 ppb, for example of less than 50 ppb or from 1 to 200 ppb or from 15 to 100 ppb, particularly preferably in a range from 1 to 50 ppb.
[F] a tamped density in a range from 0.5 to 1.2 g/cm³, for example in a range from 0.6 to 1.1 g/cm³, particularly preferably in a range from 0.75 to 1.0 g/cm³;
[G] a pore volume in a range from 0.1 to 1.5 mL/g, for example in a range from 0.15 to 1.1 mL/g; particularly preferably in a range from 0.2 to 0.8 mL/g,
[H] a chlorine content of less than 200 ppm, preferably of less than 150 ppm, for example less than 100 ppm, or of less than 50 ppm, or of less than 1 ppm, or of less than 500 ppb, or of less than 200 ppb, or in a range from 1 ppb to less than 200 ppm, or from 1 ppb to 100 ppm, or from 1 ppb to 1 ppm, or from 10 ppb to 500 ppb, or from 10 ppb to 200 ppb, particularly preferably from 1 ppb to 80 ppb;
[I] metal content of metals which are different to aluminium of less than 1000 ppb, preferably in a range from 1 to 900 ppb, for example in a range from 1 to 700 ppb, particularly preferably in a range from 1 to 500 ppb;
[J] a residual moisture content of less than 10 wt.-%, preferably in a range from 0.01 wt.-% to 5 wt.-%, for example from 0.02 to 1 wt.-%, particularly preferably from 0.03 to 0.5 wt.-%;
wherein the wt.-%, ppm and ppb are each based on the total weight of the silicon dioxide granulate I.

The OH content, or hydroxyl group content, means the content of OH groups in a material, for example in silicon dioxide powder, in silicon dioxide granulate or in a quartz glass body. The content of OH groups is measured spectroscopically in the infrared by comparing the first and the third OH bands.

The chlorine content means the content of elemental chlorine or chlorine ions in the silicon dioxide granulate, in the silicon dioxide powder or in the quartz glass body.

The aluminium content means the content of elemental aluminium or aluminium ions in the silicon dioxide granulate, in the silicon dioxide powder or in the quartz glass body.

Preferably, the silicon dioxide granulate I has a micropore proportion in a range from 4 to 5 m²/g; for example in a range from 4.1 to 4.9 m²/g; particularly preferably in a range from 4.2 to 4.8 m²/g.

The silicon dioxide granulate I preferably has a density in a range from 2.1 to 2.3 g/cm³, particularly preferably in a range from 2.18 to 2.22 g/cm³.

The silicon dioxide granulate I preferably has a mean particle size in a range from 180 to 300 μm, for example in a range from 220 to 280 μm, particularly preferably in a range from 220 to 270 μm.

The silicon dioxide granulate I preferably has a particle size D₅₀ in a range from 150 to 300 μm, for example in a range from 180 to 280 μm, particularly preferably in a range from 220 to 270 μm. Furthermore, preferably, the silicon dioxide granulate I has a particle size D₁₀ in a range from 50 to 150 μm, for example in a range from 80 to 150 μm, particularly preferably in a range from 100 to 150 μm. Furthermore, preferably, the silicon dioxide granulate I has a particle size D₉₀ in a range from 250 to 620 μm, for example in a range from 280 to 550 μm, particularly preferably in a range from 300 to 450 μm.

Particle size means the size of the particles aggregated from the primary particles, which are present in a silicon dioxide powder, in a slurry or in a silicon dioxide granulate. The mean particle size means the arithmetic mean of all particle sizes of the indicated material. The D₅₀ value indicates that 50% of the particles, based on the total number of particles, are smaller than the indicated value. The D₁₀ value indicates that 10% of the particles, based on the total number of particles, are smaller than the indicated value. The D₉₀ value indicates that 90% of the particles, based on the total number of particles, are smaller than the indicated value. The particle size is measured by the dynamic photo analysis process according to ISO 13322-2:2006-11.

Preferably, the granules of the silicon dioxide granulate have a spherical morphology. Spherical morphology means a round or oval form of the particle. The granules of the silicon dioxide granulate preferably have a mean sphericity in a range from 0.7 to 1.3 SPHT3, for example a mean sphericity in a range from 0.8 to 1.2 SPHT3, particularly preferably a mean sphericity in a range from 0.85 to 1.1 SPHT3. The feature SPHT3 is described in the test methods.

Furthermore, the granules of the silicon dioxide granulate preferably have a mean symmetry in a range from 0.7 to 1.3 Symm3, for example a mean symmetry in a range from 0.8 to 1.2 Symm3, particularly preferably a mean symmetry in a range from 0.85 to 1.1 Symm3. The feature of the mean symmetry Symm3 is described in the test methods.

Preferably, the silicon dioxide granulate has a metal content of metals different to aluminium of less than 1000 ppb, for example of less than 500 ppb, particularly preferably of less than 100 ppb, in each case based on the total weight of the silicon dioxide granulate. Often however, the silicon dioxide granulate has a content of metals different to aluminium of at least 1 ppb. Often, the silicon dioxide granulate has a metal content of metals different to aluminium of less than 1 ppm, preferably in a range from 40 to 900 ppb, for example in a range from 50 to 700 ppb, particularly preferably in a range from 60 to 500 ppb, in each case based on the total weight of the silicon dioxide granulate. Such metals are for example sodium, lithium, potassium, magnesium, calcium, strontium, germanium, copper, molybdenum, titanium, iron and chromium. These can for example be present as an element, as an ion, or as part of a molecule or of an ion or of a complex.

The silicon dioxide granulate I can comprise further constituents, for example in the form of molecules, ions or elements. Preferably, the silicon dioxide granulate I comprises less than 500 ppm of further constituents, for example less than 300 ppm, particularly preferably less than 100 ppm, in each case based on the total weight of the silicon dioxide granulate I. Often, at least 1 ppb of further constituents are comprised. The further constituents can in particular be selected from the group consisting of carbon, fluoride, iodide, bromide, phosphorus or a mixture of at least two thereof.

Preferably, the silicon dioxide granulate I comprises less than 100 ppm of further constituents, for example less than 80 ppm, particularly preferably less than 70 ppm, in each case based on the total weight of the silicon dioxide granulate I. Often however, at least 1 ppb of the further constituents are comprised in the silicon dioxide granulate I.

The silicon dioxide granulate I preferably has the feature combination [A]/[B]/[C] or [A]/[B]/[E] or [A]/[B]/[G], further preferred the feature combination [A]/[B]/[C]/[E] or [A]/[B]/[C]/[G] or [A]/[B]/[E]/[G], further preferably the feature combination [A]/[B]/[C]/[E]/[G].

The silicon dioxide granulate I preferably has the feature combination [A]/[B]/[C], wherein the BET surface area is in a range from 20 to 40 m²/g, the mean particle size is in a range from 180 to 300 μm and the bulk density is in a range from 0.6 to 1.1 g/mL.

The silicon dioxide granulate I preferably has the feature combination [A]/[B]/[E], wherein the BET surface area is in a range from 20 to 40 m²/g, the mean particle size is in a range from 180 to 300 μm and the aluminium content is in a range from 1 to 50 ppb.

The silicon dioxide granulate I preferably has the feature combination[A]/[B]/[G], wherein the BET surface area is in a range from 20 to 40 m²/g, the mean particle size is in a range from 180 to 300 μm and the pore volume is in a range from 0.2 to 0.8 mL/g.

The silicon dioxide granulate I preferably has the feature combination [A]/[B]/[C]/[E], wherein the BET surface area is in a range from 20 to 40 m²/g, the mean particle size is in a range from 180 to 300 μm, the bulk density is in a range from 0.6 to 1.1 g/mL and the aluminium content is in a range from 1 to 50 ppb.

The silicon dioxide granulate I preferably has the feature combination [A]/[B]/[C]/[G], wherein the BET surface area is in a range from 20 to 40 m²/g, the mean particle size is in a range from 180 to 300 μm, the bulk density is in a range from 0.6 to 1.1 g/mL and the pore volume is in a range from 0.2 to 0.8 mL/g.

The silicon dioxide granulate I preferably has the feature combination [A]/[B]/[E]/[G], wherein the BET surface area is in a range from 20 to 40 m²/g, the mean particle size is in a range from 180 to 300 μm, the aluminium content is in a range from 1 to 50 ppb and the pore volume is in a range from 0.2 to 0.8 mL/g.

The silicon dioxide granulate I preferably has the feature combination [A]/[B]/[C]/[E]/[G], wherein the BET surface area is in a range from 20 to 40 m²/g, the mean particle size is in a range from 180 to 300 μm, the bulk density is in a range from 0.6 to 1.1 g/mL, the aluminium content is in a range from 1 to 50 ppb and the pore volume is in a range from 0.2 to 0.8 mL/g.

Preferably, the silicon dioxide granulate I can be subjected to a thermal, mechanical or chemical treatment or a combination of two or more treatments, wherein a silicon dioxide granulate II is obtained.

### Chemical

According to a preferred embodiment of the first aspect of the invention, the silicon dioxide granulate I comprises at least two particles. Preferably, the at least two particles can carry out a motion relative to each other. As means for bringing about the relative motion, in principle all means known to the skilled man and which appear to him to be suitable can be considered. Particular preferred is a mixing. A mixing can in principle be carried out in any manner Preferably, a feed-oven is selected for this. Accordingly, the at least two particles can preferably perform a motion relative to each other by being agitated in a feed oven, for example in a rotary kiln.

Feed ovens mean ovens for which loading and unloading of the oven, so-called charging, is carried out continuously. Examples of feed-ovens are rotary kilns, roll-over type furnaces, belt conveyor ovens, conveyor ovens, continuous pusher-type furnaces. Preferably, for treatment of the silicon dioxide granulate I, rotary kilns are used.

According to a preferred embodiment of the first aspect of the invention, the silicon dioxide granulate I is treated with a reactant to obtain a silicon dioxide granulate II. The treatment is carried out in order to change the concentration of certain materials in the silicon dioxide granulate. The silicon dioxide granulate I can have impurities or certain functionalities, the content of which should be reduced, such as for example: OH groups, carbon containing compounds, transition metals, alkali metals and alkali earth metals. The impurities and functionalities can originate from the starting materials or can be introduced in the course of the process. The treatment of the silicon dioxide granulate I can serve various purposes. For example, employing treated silicon dioxide granulate I, i.e. silicon dioxide granulate II, can simplify the processing of the silicon dioxide granulate to obtain glass products. Furthermore, this selection can be employed to tune the properties of the resulting glass products. For example, the silicon dioxide granulate I can be purified or surface modified. The treatment of the silicon dioxide granulate I can thus be employed for improving the properties of the resulting glass products.

Preferably, a gas or a combination of multiple gases is suitable as reactant. This is also referred to as a gas mixture. In principle, all gases known to the skilled man can be employed, which are known for the specified treatment and which appear to be suitable. Preferably, a gas selected from the group consisting of HCl, Cl₂, F₂, O₂, O₃, H₂, C₂F₄, C₂F₆, HClO₄, air, inert gas, e.g. N₂, He, Ne, Ar, Kr, or combinations of two or more thereof is employed. Preferably, the treatment is carried out in the presence of a gas or a combination of two or more gases. Preferably, the treatment is carried out in a gas counter flow or a gas co-flow.

Preferably, the reactant is selected from the group consisting of HCl, Cl₂, F₂, O₂, O₃ or combinations of two or more thereof. Preferably, mixtures of two or more of the above-mentioned gases are used for the treatment of silicon dioxide granulate I. Through the presence of F, Cl or both, metals which are contained in silicon dioxide granulates I as impurities, such as for example transition metals, alkali metals and alkali earth metals, can be removed. In this connection, the above mentioned metals can be converted along with constituents of the gas mixture under the process conditions to obtain gaseous compounds which are subsequently drawn out and thus are no longer present in the granulate. Furthermore, preferably, the OH content in the silicon dioxide granulate I can be decreased by the treatment of the silicon dioxide granulate I with these gases.

Preferably, a gas mixture of HCl and Cl₂ is employed as reactant. Preferably, the gas mixture has an HCl content in a range from 1 to 30 vol.-%, for example in a range from 2 to 15 vol.-%, particularly preferably in a range from 3 to 10 vol.-%. Likewise, the gas mixture preferably has a Cl₂ content in a range from 20 to 70 vol.-%, for example in a range from 25 to 65 vol.-%, particularly preferably in a range from 30 to 60 vol.-%. The remainder up to 100 vol.-% can be made up of one or more inert gases, e.g. N₂, He, Ne, Ar, Kr, or of air. Preferably, the proportion of inert gas in the reactants is in a range from 0 to less than 50 vol.-%, for example in a range from 1 to 40 vol.-% or from 5 to 30 vol.-%, particularly preferably in a range from 10 to 20 vol.-%, in each case based on the total volume of the reactants. If a chlorine component, e.g. HCl or Cl2, is involved in this gas mixture, this treatment is sometimes also called “hot chlorination”.

O₂, C₂F₂, or mixtures thereof with Cl₂ are preferably used for purifying silicon dioxide granulate I which has been prepared from a siloxane or from a mixture of multiple siloxanes.

The reactant in the form of a gas or of a gas mixture is preferably contacted with the silicon dioxide granulate as a gas flow or as part of a gas flow with a throughput in a range from 50 to 2000 L/h, for example in a range from 100 to 1000 L/h, particularly preferably in a range from 200 to 500 L/h. A preferred embodiment of the contacting is a contact of the gas flow and silicon dioxide granulate in a feed oven, for example in a rotary kiln. Another preferred embodiment of the contacting is a fluidised bed process.

Through treatment of the silicon dioxide granulate I with the reactant, a silicon dioxide granulate II with a carbon content w_{C(2)} is obtained. The carbon content w_{C(2)} of the silicon dioxide granulate II is less than the carbon content w_{C(1)} of the silicon dioxide granulate I, based on the total weight of the respective silicon dioxide granulate. Preferably, w_{C(2)} is 0.5 to 99%, for example 20 to 80% or 50 to 95%, particularly preferably 60 to 99% less than w_{C(1)}.

### Thermal

Preferably, the silicon dioxide granulate I is additionally subjected to a thermal or mechanical treatment or to a combination of these treatments. One or more of these additional treatments can be carried out before or during the treatment with the reactant. Additionally, the additional treatment can also be carried out on the silicon dioxide granulate II. Accordingly, the following description of the preferred conditions under which a thermal treatment can take place also represents the preferred conditions of an optional thermal treatment of the silica granules II.

The thermal treatment of the silicon dioxide granulate I can serve various purposes. For example, this treatment facilitates he processing of the silicon dioxide granulate II to obtain glass products. The treatment can also influence the properties of the resulting glass products. For example, the silicon dioxide granulate II can be compactified, purified, surface modified or dried. In this connection, the specific surface area (BET) can decrease. Likewise, the bulk density and the mean particle size can increase due to agglomerations of silicon dioxide particles. The thermal treatment can be carried out dynamically or statically.

For the dynamic thermal treatment, all ovens in which the silicon dioxide granulate can be thermally treated whilst being agitated are in principle suitable. For the dynamic thermal treatment, preferably feed ovens are used.

A preferred mean holding time of the silicon dioxide granulate in the dynamic thermal treatment is quantity dependent. Preferably, the mean holding time of the silicon dioxide granulate in the dynamic thermal treatment is in the range from 10 to 180 min, for example in the range from 20 to 120 min or from 30 to 90 min. Particularly preferably, the mean holding time of the silicon dioxide granulate in the dynamic thermal treatment is in the range from 30 to 90 min.

In the case of a continuous process, a defined portion of the flow of silicon dioxide granulate is used as a sample load for the measurement of the holding time, e.g. a gram, a kilogram or a tonne. The start and end of the holding time are determined by the introduction into and exiting from the continuous oven operation.

Preferably, the throughput of the silicon dioxide granulate in a continuous process for dynamic thermal treatment is in the range from 1 to 50 kg/h, for example in the range from 5 to 40 kg/h or from 8 to 30 kg/h. Particularly preferably, the throughput here is in the range from 10 to 20 kg/h.

In the case of a discontinuous process for dynamic thermal treatment, the treatment time is given as the period of time between the loading and subsequent unloading of the oven.

In the case of a discontinuous process for dynamic thermal treatment, the throughput is in a range from 1 to 50 kg/h, for example in the range from 5 to 40 kg/h or from 8 to 30 kg/h. Particularly preferably, the throughput is in the range from 10 to 20 kg/h. The throughput can be achieved using a sample load of a determined amount which is treated for an hour. According to another embodiment, the throughput can be achieved through a number of loads per hour, wherein the weight of a single load corresponds to the throughput per hour divided by the number of loads. In this event, time of treatment corresponds to the fraction of an hour which is given by 60 minutes divided by the number of loads per hour.

Preferably, the dynamic thermal treatment of the silicon dioxide granulate is carried out at an oven temperature in a range from 1000 to 1300° C., for example in a range from 1050 to 1250° C., and particularly preferably in the range from 1100 to 1200° C.

Preferably, the temperature at a measuring point in the oven deviates from the set temperature by less than 10% downwards or upwards, based on the entire treatment period and the entire length of the oven as well as at every point in time in the treatment as well as at every position in the oven. It is further preferred that measured temperatures at a measuring point that deviate from the set temperature are within the range indicated above.

Alternatively, in particular the continuous process of a dynamic thermal treatment of the silicon dioxide granulate can by carried out at differing oven temperatures. For example, the oven can have a constant temperature over the treatment period, wherein the temperature varies in section over the length of the oven. Such sections can be of the same length or of different lengths. Preferably, in this case, the temperature increases from the entrance of the oven to the exit of the oven. Preferably, the temperature at the entrance is at least 100° C. lower than at the exit, for example 150° C. lower or 200° C. lower or 300° C. lower or 400° C. lower. Furthermore, preferably, the temperature at the entrance is preferably 1000 to 1300° C., for example 1050 to 1250° C. particularly preferably in the range from 1100 to 1200° C.

Furthermore, preferably, the temperature at the entrance is preferably at least 600° C., for example from 700 to 1200° C. or from 800° C. to 1100° C., particularly preferably from 900 to 1000° C. Furthermore, each of the temperature ranges given at the oven entrance can be combined with each of the temperature ranges given at the oven exit. Preferred combinations of oven entrance temperature ranges and oven exit temperature ranges are:

| Oven entrance temperature range | Oven exit temperature range |
|---|---|
| [° C.] | [° C.] |
| 700-1200 | 1000-1300 |
| 800-1000 | 1050-1250 |
| 900-1000 | 1100-1200 |

For the static thermal treatment of the silicon dioxide granulate crucibles arranged in an oven are preferably used. Suitable crucibles are sinter crucibles or metal sheet crucibles. Preferred are rolled metal sheet crucibles made out of multiple sheets which are riveted together. Examples of crucible materials are refractory metals, in particular tungsten, molybdenum and tantalum. The crucible can furthermore be made of graphite or in the case of the crucible of refractory metals can be lined with graphite foil. Particularly preferably, silicon dioxide crucibles are employed.

The mean holding time of the silicon dioxide granulate in the static thermal treatment is quantity dependent. Preferably, the mean holding time of the silicon dioxide granulate in the static thermal treatment for a 60 kg amount of silicon dioxide granulate I is in the range from 1 to 60 hrs, for example in the range from 5 to 50 hrs, or from 10 to 40 hrs, particularly preferably in the range from 20 to 30 hrs.

According to the invention, the static thermal treatment of the silicon dioxide granulate is carried out at an oven temperature in a range from 1000 to 1300° C., for example in the range from 1050 to 1250° C., particularly preferably in a range from 1100 to 1200° C.

Preferably, the static thermal treatment of the silicon dioxide granulate I is carried out at constant oven temperature. The static thermal treatment can also be carried out at a varying oven temperature. Preferably, in this case, the temperature increases during the treatment, wherein the temperature at the start of the treatment is at least 50° C. lower than at the end, for example 70° C. lower or 80° C. lower or 100° C. lower or 110° C. lower, and wherein the temperature at the end is preferably at least 1000 to 1300° C., for example from 1050 to 1250° C., particularly preferably from 1100 to 1200° C.

### Mechanical

According to a further preferred embodiment, the silicon dioxide granulate I can be additionally mechanically treated. The mechanical treatment can be carried out for increasing the bulk density. The mechanical treatment can be combined with the above mentioned thermal or chemical treatment, or a combination of both. A mechanical treatment can avoid the agglomerates in the silicon dioxide granulate and therefore the mean particle size of the individual, treated silicon dioxide granules in the silicon dioxide granulate becoming too large. An enlargement of the agglomerates can hinder the further processing or have disadvantageous impacts on the properties of the glass product prepared by the inventive process, or a combination of both effects. A mechanical treatment of the silicon dioxide granulate also promotes a uniform contact of the surfaces of the individual silicon dioxide granules with the gas or gases. This is in particular achieved by concurrent mechanical and chemical treatment with one or more reactands. In this way, the effect of the chemical treatment can be improved.

The mechanical treatment of the silicon dioxide granulate can be carried out by moving two or more silicon dioxide granules relative to each other, for example by rotating the tube of a rotary kiln.

Preferably, the silicon dioxide granulate I is treated with a reactand, thermally and mechanically. Preferably, a simultaneous treatment with a reactand, a thermal and a mechanical treatment of the silicon dioxide granulate I is carried out.

In the treatment with a reactand, the content of impurities in the silicon dioxide granulate I is reduced. For this, the silicon dioxide granulate I can be treated in a rotary kiln at raised temperature and under a chlorine and oxygen containing atmosphere. Water present in the silicon dioxide granulate I evaporates, organic materials react to form CO and CO₂. Metal impurities can be converted to volatile chlorine containing compounds.

Preferably, the silicon dioxide granulate I is treated in a chlorine and oxygen containing atmosphere in a rotary kiln at a temperature of at least 500° C., preferably in a temperature range from 550 to 1300° C. or from 600 to 1260° C. or from 650 to 1200° C. or from 700 to 1000° C., particularly preferably in a temperature range from 700 to 900° C. The chlorine containing atmosphere contains for example HCl or Cl₂ or a combination of both. This treatment causes a reduction of the carbon content.

Furthermore, preferably alkali and iron impurities are reduced. Preferably, a reduction of the number of OH groups is achieved. At temperatures under 700° C., treatment periods can be long, at temperatures above 1100° C. there is a risk that pores of the granulate close, trapping chlorine or gaseous chlorine compounds.

Preferably, it is also possible to carry out sequentially multiple treatment steps comprising a reactand, each concurrent with thermal and mechanical treatment. For example, the silicon dioxide granulate I can first be treated in a chlorine containing atmosphere and subsequently in an oxygen containing atmosphere. The low concentrations of carbon, hydroxyl groups and chlorine resulting therefrom facilitate the melting down of the silicon dioxide granulate II.

According to a further preferred embodiment, step II.2) is characterised by at least one, for example by at least two or at least three, particularly preferably by a combination of all of the following features:
N1) The reactant comprises HCl, Cl₂ or a combination therefrom;
N2) The treatment is carried out in a rotary kiln;
N3) The treatment is carried out at a temperature in a range from 600 to 900° C.;
N4) The reactant forms a counter flow;
N5) The reactant has a gas flow in a range from 50 to 2000 L/h, preferably 100 to 1000 L/h, particularly preferably 200 to 500 L/h;
N6) The reactant has a volume proportion of inert gas in a range from 0 to less than 50 vol.-%.

The silicon dioxide granulate I has a particle diameter which is greater than the particle diameter of the silicon dioxide powder. Preferably, the particle diameter of the silicon dioxide granulate I is up to 300 times as great as the particle diameter of the silicon dioxide powder, for example up to 250 times as great or up to 200 times as great or up to 150 times as great or up to 100 times as great or up to 50 times as great or up to 20 times as great or up to 10 times as great, particularly preferably 2 to 5 times as great.

Particle size means the size of the particles of aggregated primary particles, which are present in a silicon dioxide powder, in a slurry or in a silicon dioxide granulate. The mean particle size means the arithmetic mean of all particle sizes of the indicated material. The D₅₀ value indicates that 50% of the particles, based on the total number of particles, are smaller than the indicated value. The D₁₀ value indicates that 10% of the particles, based on the total number of particles, are smaller than the indicated value. The D₉₀ value indicates that 90% of the particles, based on the total number of particles, are smaller than the indicated value. The particle size is measured by the dynamic photo analysis process according to ISO 13322-2:2006-11.

Preferably, the silicon dioxide granulate II has a carbon content w_{C(2)}. The carbon content w_{C(2)} of the silicon dioxide granulate II is less than the carbon content w_{C(1)} of the silicon dioxide granulate I. Preferably, w_{C(2)} is 0.5 to 50%, for example 1 to 45% or 50 to 95%, particularly preferably 1.5 to 40% less than w_{C(1)}. The carbon content w_{C(2)} is preferably less than 5 ppm, for example less than 3 ppm, particularly preferably less than 1 ppm, each based on the total weight of the silicon dioxide granulate II. Often, the silicon dioxide granulate II has a carbon content w_{C(2)} of 1 ppb or more.

Preferably, the silicon dioxide granulate II has an alkali earth metal content w_{M(2)}. The alkali earth metal content w_{M(2)} of the silicon dioxide granulate II is less than the alkali earth metal content w_{M(1)} of the silicon dioxide granulate I. Preferably, w_{M(2)} is 0.5 to 50%, for example 1 to 45%, particularly preferably 1.5 to 40% less than w_{M(1)}. The alkali earth metal content w_{M(2)} is preferably less than 500 ppb, for example less than 450 ppb or 400 ppb or 350 ppb, particularly preferably less than 300 ppb, each based on the total weight of the silicon dioxide granulate II. Often, the silicon dioxide granulate II has an alkali earth metal content w_{M(2)} of 1 ppb or more.

Preferably, the silicon dioxide granulate II has at least one, for example at least two or at least three or at least four, particularly preferably at least five of the following features:
(A) a chlorine content of less than 500 ppm, preferably of less than 400 ppm, for example less than 350 ppm or preferably of less than 330 ppm or in a range from 1 ppb to 500 ppm or from 10 ppb to 450 ppm particularly preferably from 50 ppb to 300 ppm;
(B) an aluminium content of less than 200 ppb, for example of less than 150 ppb or from less than 100 ppb or from 1 to 150 ppb or from 1 to 100 ppb, particularly preferably in a range from 1 to 80 ppb;
(C) a metal content of metals different to aluminium, of less than 300 ppb, for example in a range from 1 to 200 ppb, particularly preferably in a range from 1 to 100 ppb;
(D) a BET surface in the range from 20 to 40 m²/g, for example in a range from 10 to 30 m²/g, particularly preferably in a range from 20 to 30 m²/g;
(E) a pore volume in a range from 0.1 to 2.5 mL/g, for example in a range from 0.2 to 1.5 mL/g; particularly preferably in a range from 0.4 to 1 mL/g;
(F) a residual moisture of less than 3 wt.-%, for example in a range from 0.001 wt.-% to 2 wt.-%, particularly preferably from 0.01 to 1 wt.-%,
(G) a bulk density in a range from 0.7 to 1.2 g/cm³, for example in a range from 0.75 to 1.1 g/cm³, particularly preferably in a range from 0.8 to 1.0 g/cm³;
(H) a tamped density in a range from 0.7 to 1.2 g/cm³, for example in a range from 0.75 to 1.1 g/cm³, particularly preferably in a range from 0.8 to 1.0 g/cm³;
(I) a particle size distribution D₁₀ in a range from 50 to 150 μm
(J) a particle size distribution D₅₀ in a range from 150 to 250 μm;
(K) a particle size distribution D₉₀ in a range from 250 to 450 μm,
wherein the wt.-%, ppm and ppb are each based on the total weight of the silicon dioxide granulate II.

Preferably, the silicon dioxide granulate II has a micropore proportion in a range from 1 to 2 m²/g; for example in a range from 1.2 to 1.9 m²/g; particularly preferably in a range from 1.3 to 1.8 m²/g.

The silicon dioxide granulate II preferably has a density in a range from 0.5 to 2.0 g/cm³, for example from 0.6 to 1.5 g/cm³, particularly preferably from 0.8 to 1.2 g/cm³. The density is measured according to the method described in the test methods.

The silicon dioxide granulate II preferably has a particle size D₅₀ in a range from 150 to 250 μm, for example in a range from 180 to 250 μm, particularly preferably in a range from 200 to 250 μm. Furthermore, preferably, the silicon dioxide granulate II has a particle size D₁₀ in a range from 50 to 150 μm, for example in a range from 80 to 150 μm, particularly preferably in a range from 100 to 150 μm. Furthermore, preferably, the silicon dioxide granulate II has a particle size D₉₀ in a range from 250 to 450 μm, for example in a range from 280 to 420 μm, particularly preferably in a range from 300 to 400 μm.

Preferably, the granules of the silicon dioxide granulate II have a spherical morphology. Spherical morphology means a round to oval form of the particle. The granules of the silicon dioxide granulate II preferably have a mean sphericity in a range from 0.7 to 1.3 SPHT3, for example a mean sphericity in a range from 0.8 to 1.2 SPHT3, particularly preferably a mean sphericity in a range from 0.85 to 1.1 SPHT3. The feature SPHT3 is described in the test methods.

Furthermore, the granules of the silicon dioxide granulate II preferably have a mean symmetry in a range from 0.7 to 1.3 Symm3, for example a mean symmetry in a range from 0.8 to 1.2 Symm3, particularly preferably a mean symmetry in a range from 0.85 to 1.1 Symm3. The feature of the mean symmetry Symm3 is described in the test methods.

Preferably, the silicon dioxide granulate II has a metal content of metals different to aluminium of less than 1000 ppb, for example of less than 500 ppb, particularly preferably of less than 100 ppb, in each case based on the total weight of the silicon dioxide granulate II. Often however, the silicon dioxide granulate II has a content of metals different to aluminium of at least 1 ppb. Often, the silicon dioxide granulate has a metal content of metals different to aluminium of less than 1 ppm, preferably in a range from 40 to 900 ppb, for example in a range from 50 to 700 ppb, particularly preferably in a range from 60 to 500 ppb, in each case based on the total weight of the silicon dioxide granulate II. Such metals are for example sodium, lithium, potassium, magnesium, calcium, strontium, germanium, copper, molybdenum, titanium, iron and chromium. These can for example be present as an element, as an ion, or as part of a molecule or of an ion or of a complex.

The silicon dioxide granulate II can comprise further constituents, for example in the form of molecules, ions or elements. Preferably, the silicon dioxide granulate II comprises less than 500 ppm of further constituents, for example less than 300 ppm, particularly preferably less than 100 ppm, in each case based on the total weight of the silicon dioxide granulate II. Often, at least 1 ppb of further constituents are comprised. The further constituents can in particular be selected from the group consisting of carbon, fluoride, iodide, bromide, phosphorus or a mixture of at least two thereof.

Preferably, the silicon dioxide granulate II comprises less than 100 ppm of further constituents, for example less than 80 ppm, particularly preferably less than 70 ppm, in each case based on the total weight of the silicon dioxide granulate II. Often, however, at least 1 ppb of further constituents are comprised.

The silicon dioxide granulate II preferably has the feature combination (A)/(B)/(C) or (A)/(B)/(D) or (A)/(B)/(H), further preferably the feature combination (A)/(B)/(C)/(D) or (A)/(B)/(C)/(H) or (A)/(B)/(D)/(H), particularly preferably the feature combination (A)/(B)/(C)/(D)/(H).

The silicon dioxide granulate II preferably has the feature combination (A)/(B)/(C), wherein the chlorine content is less than 330 ppm, the aluminium content is less than 100 ppb and the metal content of metals different to aluminium is in a range from I to 100 ppb.

The silicon dioxide granulate II preferably has the feature combination (A)/(B)/(D), wherein the chlorine content is less than 330 ppm, the aluminium content is less than 100 ppb and the BET surface is in a range from 10 to 30 m²/g.

The silicon dioxide granulate II preferably has the feature combination (A)/(B)/(H), wherein the chlorine content is less than 330 ppm, the aluminium content is less than 100 ppb and the tamped density is in a range from 0.8 to 1.0 g/mL.

The silicon dioxide granulate II preferably has the feature combination (A)/(B)/(C)/(D), wherein the chlorine content is less than 330 ppm, the aluminium content is less than 100 ppb, the metal content of metals different to aluminium is in a range from 1 to 100 ppb and the BET surface is in a range from 10 to 30 m²/g.

The silicon dioxide granulate II preferably has the feature combination (A)/(B)/(C)/(H), wherein the chlorine content is less than 330 ppm, the aluminium content is less than 100 ppb, the metal content of metals different to aluminium is in a range from 1 to 100 ppb and the tamped density is in a range from 0.8 to 1.0 g/mL.

The silicon dioxide granulate II preferably has the feature combination (A)/(B)/(D)/(H), wherein the chlorine content is less than 330 ppm, the aluminium content is less than 100 ppb, the BET surface is in a range from 10 to 30 m²/g and the tamped density is in a range from 0.8 to 1.0 g/mL.

The silicon dioxide granulate II preferably has the feature combination (A)/(B)/(C)/(D)/(H), wherein the chlorine content is less than 330 ppm, the aluminium content is less than 100 ppb, the metal content of metals different to aluminium is in a range from 1 to 100 ppb, the BET surface is in a range from 10 to 30 m²/g and the tamped density is in a range from 0.8 to 1.0 g/mL.

### Pre-Compacting

It is in principle possible to subject the silicon dioxide granulate provided in step i.) to one or more pre-treatment steps, before it is heated in step ii.) to obtain a glass melt. Possible pre-treatment steps are for example thermal or mechanical treatment steps. For example the silicon dioxide granulate can be compacted before the heating in step ii.). “Compacting” means a reduction in the BET surface area and a reduction of the pore volume.

The silicon dioxide granulate is preferably compacted thermally by heating the silicon dioxide granulate or mechanically by exerting a pressure to the silicon dioxide granulate, for example rolling or pressing of the silicon dioxide granulate. Preferably, the silicon dioxide granulate is compacted by heating. Particularly preferably, the compacting of the silicon dioxide granulate is performed by heating by means of a pre-heating section which is connected to the melting oven.

Preferably, the silicon dioxide is compacted by heating at a temperature in a range from 800 to 1400° C., for example at a temperature in a range from 850 to 1300° C., particularly preferably at a temperature in a range from 900 to 1200° C.

In a preferred embodiment of the first aspect of the invention, the BET surface area of the silicon dioxide granulate is not reduced to less than 5 m²/g prior to the heating in step ii.), preferably not to less than 7 m²/g or not to less than 10 m²/g, particularly preferably not to less than 15 m²/g. Furthermore, it is preferred, that the BET surface area of the silicon dioxide granulate is not reduced prior to the heating in step ii.) compared with the silicon dioxide granulate provided in step i.).

In a preferred embodiment of the first aspect of the invention, the BET surface area of the silicon dioxide granulate is reduced to less than 20 m²/g, for example to less than 15 m²/g, or to less than 10 m²/g, or to a range from more than 5 to less than 20 m²/g or from 7 to 15 m²/g, particularly preferably to a range from 9 to 12 m²/g. Preferably, the BET surface area of the silicon dioxide granulate is reduced prior to the heating in step ii.) in comparison to the silicon dioxide granulate provided in step i.) by less than 40 m²/g, for example by 1 to 20 m²/g or by 2 to 10 m²/g, particularly preferably by 3 to 8 m²/g, the BET surface area after the compacting being more than 5 m²/g.

The compacted silicon dioxide granulate is referred to in the following as silicon dioxide granulate III. Preferably, the silicon dioxide granulate III has at least one, for example at least two or at least three or at least four, particularly preferably at least five of the following features:
A. a BET surface area in a range from more than 5 to less than 40 m²/g, for example from 10 to 30 m²/g, particularly preferably in a range from 15 to 25 m²/g;
B. a particle size D₁₀ in a range from 100 to 300 μm, particularly preferably in a range from 120 to 200 μm;
C. a particle size D₅₀ in a range from 150 to 550 μm, particularly preferably in a range from 200 to 350 μm;
D. a particle size D₉₀ in a range from 300 to 650 μm, particularly preferably in a range from 400 to 500 μm;
E. a bulk density in a range from 0.8 to 1.6 g/cm³, particularly preferably from 1.0 to 1.4 g/cm³;
F. a tamped density in a range from 1.0 to 1.4 g/cm³, particularly preferably from 1.15 to 1.35 g/cm³;
G. a carbon content of less than 5 ppm, for example of less than 4.5 ppm, particularly preferably of less than 4 ppm;
H. a Cl content of less than 500 ppm, particularly preferably from 1 ppb to 200 ppm,
wherein the ppm and ppb are each based on the total weight of the silicon dioxide granulate III.

The silicon dioxide granulate III preferably has the feature combination A./F./G. or A./F./H. or A./G./H., further preferably the feature combination A./F./G./H.

The silicon dioxide granulate III preferably has the feature combination A./F./G., wherein the BET surface area is in a range from 10 to 30 m²/g, the tamped density is in a range from 1.15 to 1.35 g/mL and the carbon content is less than 4 ppm.

The silicon dioxide granulate III preferably has the feature combination A./F./H., wherein the BET surface area is in a range from 10 to 30 m²/g, the tamped density is in a range from 1.15 to 1.35 g/mL and the chlorine content is in a range from 1 ppb to 200 ppm.

The silicon dioxide granulate III preferably has the feature combination A./G./H., wherein the BET surface area is in a range from 10 to 30 m²/g, the carbon content is less than 4 ppm and the chlorine content is in a range from 1 ppb to 200 ppm.

The silicon dioxide granulate III preferably has the feature combination A./F./G./H., wherein the BET surface area is in a range from 10 to 30 m²/g, the tamped density is in a range from 1.15 to 1.35 g/mL, the carbon content is less than 4 ppm and the chlorine content is in a range from 1 ppb to 200 ppm.

Preferably, in at least one process step, a silicon component different to silicon dioxide is introduced. The introduction of a silicon component different to silicon dioxide is also referred to in the following as Si-doping. In principle, the Si-doping can be performed in any process step. Preferably, the Si-doping is preferred in step i.) or in step ii.).

The silicon component which is different to silicon dioxide can in principle be introduced in any form, for example as a solid, as a liquid, as a gas, in solution or as a dispersion. Preferably, the silicon component different to silicon dioxide is introduced as a powder. Also, preferably, the silicon component different to silicon dioxide can be introduced as a liquid or as a gas.

The silicon component which is different to silicon dioxide is preferably introduced in an amount in a range from 1 to 100,000 ppm, for example in a range from 10 to 10,000 ppm or from 30 to 1000 ppm or in a range from 50 to 500 ppm, particularly preferably in a range from 80 to 200 ppm, further particularly preferably in a range from 200 to 300 ppm, in each case based on the total weight of silicon dioxide.

The silicon component which is different to silicon dioxide can be solid, liquid or gaseous. If it is solid, it preferably has a mean particle size of up to 10 mm, for example of up to 1000 μm of up to 400 μm or in a range from 1 to 400 μm, for example 2 to 200 μm or 3 to 100 μm, particularly preferably in a range from 5 to 50 μm. The particle size values are based on the state of the silicon component which is different to silicon dioxide at room temperature.

The silicon component preferably has a purity of at least 99.5 wt.-%, for example at least 99.8 wt.-% or at least 99.9 wt.-%, particularly preferably at least 99.94 wt.-%, in each case based on the total weight of the silicon component. Preferably, the silicon component has a carbon content of not more than 1000 ppm, for example not more than 700 ppm, particularly preferably not more than 500 ppm, in each case based on the total weight of the silicon component. Particularly preferably, this applies to silicon employed as the silicon component. Preferably, the silicon component has an amount of impurities selected from the group consisting of Al, Ca, Co, Cr, Cu, Fe, Ge, Hf, K, Li, Mg, Mn, Mo, Na, Nb, Ni, Ti, V, W, Zn, Zr of not more than 250 ppm, for example not more than 150 ppm, particularly preferably not more than 100 ppm, in each case based on the total weight of the silicon component. Particularly preferably, this applies where silicon is employed as the silicon component.

Preferably, a silicon component which is different to silicon dioxide is introduced in process step i.). Preferably, the silicon component which is different to silicon dioxide is introduced during the processing of the silicon dioxide powder to obtain a silicon dioxide granulate (step II.). For example the silicon component which is different to silicon dioxide can be introduced before, during or after the granulation.

Preferably, the silicon dioxide can be Si-doped by adding the silicon component which is different to silicon dioxide to the slurry comprising silicon dioxide powder. For example, the silicon component which is different to silicon dioxide can be mixed with silicon dioxide powder and subsequently slurried, or the silicon component which is different to silicon dioxide can be introduced into a slurry of silicon dioxide powder a liquid and then slurried, or the silicon dioxide powder can be introduced into a slurry or solution of the silicon component which is different to silicon dioxide in a liquid and then slurried.

Preferably, the silicon dioxide can be Si-doped by adding the silicon component which is different to silicon dioxide during granulation. It is in principle possible to introduce the silicon component which is different to silicon dioxide at any point in time during the granulation. In the case of spray granulation, the silicon component which is different to silicon dioxide can for example be sprayed through the nozzle into the spray tower together with the slurry comprising silicon dioxide powder. In the case of roll granulation, the silicon component which is different to silicon dioxide can preferably be introduced in solid form or as a slurry comprising silicon dioxide powder, for example after introducing the slurry comprising silicon dioxide powder into the stirring vessel.

Furthermore, preferably, the silicon dioxide can be Si-doped by adding the silicon component which is different to silicon dioxide after the granulation. For example, the silicon dioxide can be doped during the treatment of the silicon dioxide granulate I to obtain silicon dioxide granulate II, preferably by adding the silicon component which is different to silicon dioxide during the thermal or mechanical treatment of the silicon dioxide granulate I.

Preferably, the silicon dioxide granulate II is doped with the silicon component which is different to silicon dioxide.

Furthermore, preferably, the silicon component which is different to silicon dioxide can also be added during several of the above mentioned sections, in particular during and after the thermal or mechanical treatment of the silicon dioxide granulate I, to obtain the silicon dioxide granulate II.

The silicon component which is different to silicon dioxide can in principle be silicon or any silicon containing compound known to a person skilled in the art and which has a reducing effect. Preferably, the silicon component which is different to silicon dioxide is silicon, a silicon-hydrogen compound, for example a silane, a silicon-oxygen compound, for example silicon monoxide, or a silicon-hydrogen-oxygen compound, for example disiloxane. Examples of preferred silanes are monosilane, disilane, trisilane, tetrasilane, pentasilane, hexasilane, heptasilane, higher homologous compounds as well as isomers of the aforementioned, and cyclic silanes like cyclo-pentasilane.

Preferably, a silicon component which is different to silicon dioxide is introduced in process step ii.).

Preferably, the silicon component which is different to silicon dioxide can be introduced directly into the melting crucible together with the silicon dioxide granulate. Preferably, silicon as the silicon component which is different to silicon dioxide can be introduced into the melting crucible with the silicon dioxide granulate. The silicon is added preferably as powder, in particular with the particle size previously given for the silicon component which is different to silicon dioxide.

Preferably, the silicon component which is different to silicon dioxide is added to the silicon dioxide granulate before introduction into the melting crucible. The addition can in principle be performed at any time after the formation of the granulate, for example in the pre-heating section, before or during the pre-compacting of the silicon dioxide granulate II, or to the silicon dioxide granulate III.

A silicon dioxide granulate obtained by addition of a silicon component which is different to silicon dioxide is referred to in the following as “Si-doped granulate”. Preferably, the Si-doped granulate has at least one, for example at least two or at least three or at least four, particularly preferably at least five of the following features:
[1] a BET surface area in a range from more than 5 to less than 40 m²/g, for example from 10 to 30 m²/g, particularly preferably in a range from 15 to 25 m²/g;
[2] a particle size D₁₀ in a range from 100 to 300 μm, particularly preferably in a range from 120 to 200 μm;
[3] a particle size D₅₀ in a range from 150 to 550 μm, particularly preferably in a range from 200 to 350 μm;
[4] a particle size D₉₀ in a range from 300 to 650 μm, particularly preferably in a range from 400 to 500 μm;
[5] a bulk density in a range from 0.8 to 1.6 g/cm³, particularly preferably from 1.0 to 1.4 g/cm³;
[6] a tamped density in a range from 1.0 to 1.4 g/cm³, particularly preferably from 1.15 to 1.35 g/cm³;
[7] a carbon content of less than 5 ppm, for example of less than 4.5 ppm, particularly preferably of less than 4 ppm;
[8] a Cl content of less than 500 ppm, particularly preferably from 1 ppb to 200 ppm;
[9] an Al content of less than 200 ppb, particularly preferably from 1 ppb to 100 ppb;
[10] a metal content of metals which are different to aluminium, of less than 1000 ppb, for example in a range from 1 to 400 ppb, particularly preferably in a range from 1 to 200 ppb;
[11] a residual moisture content of less than 3 wt.-%, for example in a range from 0.001 wt.-% to 2 wt.-%, particularly preferably from 0.01 to 1 wt.-%;
wherein the wt.-%, ppm and ppb are each based on the total weight of the Si-doped granulate.

### Step ii.)

According to step ii.), a first glass melt is formed out of the silicon dioxide granulate. Normally, the silicon dioxide granulate is warmed until a first glass melt is obtained. The warming of the silicon dioxide granulate to obtain a first glass melt can in principle by carried out by any way known to the skilled man for this purpose.

### Preparation of a First Glass Melt Using a Crucible Drawing Process

The formation of a first glass melt from the silicon dioxide granulate, for example by warming, can be carried out by a continuous process. In the process according to the invention for the preparation of a glass product, the silicon dioxide granulate can preferably be introduced continuously into an oven or the first glass melt can be removed continuously from the oven, or both. Particularly preferably, the silicon dioxide granulate is introduced continuously into the oven and the first glass melt is removed continuously from the oven.

For this, an oven which has at least one inlet and at least one outlet is in principle suitable. An inlet means an opening through which silicon dioxide and optionally further materials can be introduced into the oven. An outlet means an opening through which at least a part of the silicon dioxide can be removed from the oven. The oven can for example be arranged vertically or horizontally. Preferably, the oven is arranged vertically. Preferably, at least one inlet is located above at least one outlet. “Above” in connection with fixtures and features of an oven means, in particular in connection with an inlet and outlet, that the fixture or the features which is arranged “above” another has a higher position above the zero of absolute height. “Vertical” means that the line directly joining the inlet and the outlet of the oven deviates not more than 30° from the direction of gravity. In a preferred embodiment of the first aspect of the invention, step ii.) is performed in a melting crucible. Preferably, the melting crucible has an inlet and an outlet, wherein the inlet is positioned above of the relative position of the outlet.

According to a preferred embodiment of the first aspect of the invention, the oven comprises a hanging metal sheet crucible. Into the hanging metal sheet crucible is introduced the silicon dioxide granulate and warmed to obtain a first glass melt. A metal sheet crucible means a crucible which comprises at least one rolled metal sheet. Preferably, a metal sheet crucible has multiple rolled metal sheets. A hanging metal sheet crucible means a metal sheet crucible as previously described which is arranged in an oven in a hanging position.

The hanging metal sheet crucible can in principle be made of all materials which are known to the skilled man and which are suitable for melting silicon dioxide. Preferably, the metal sheet of the hanging metal sheet crucible comprises a sintered material, for example a sinter metal. Sinter metals means metals or alloys which are obtained by sintering of metal powders.

Preferably, the metal sheet of the metal sheet crucible comprises at least one item selected from the group consisting of the refractory metals. Refractory metals means metals of group 4 (Ti, Zr, Hf), of group 5 (V, Nb, Ta) and of group 6 (Cr, Mo, W).

Preferably, the metal sheet of the metal sheet crucible comprises a sinter metal selected from the group consisting of molybdenum, tungsten or a combination thereof. Furthermore, preferably, the metal sheet of the metal sheet crucible comprises at least one further refractory metal, particularly preferably rhenium, osmium, iridium, ruthenium or a combination of two or more thereof.

Preferably, the metal sheet of the metal sheet crucible comprises an alloy of molybdenum with a refractory metal, or tungsten with a refractory metal. Particularly preferred alloy metals are rhenium, osmium, iridium, ruthenium or a combination of two or more thereof. According to a further example, the metal sheet of the metal sheet crucible is an alloy of molybdenum with tungsten, rhenium, osmium, iridium, ruthenium or a combination of two or more thereof. For example the metal sheet of the metal sheet crucible can be an alloy of tungsten with molybdenum, rhenium, osmium, iridium, ruthenium or a combination of two or more thereof.

Preferably, the above described metal sheet of the metal sheet crucible can be coated with a refractory metal. According to a preferred example, the metal sheet of the metal sheet crucible is coated with rhenium, osmium, iridium, ruthenium, molybdenum or tungsten, or a combination of two or more thereof.

Preferably, the metal sheet and the coating have different compositions. For example a molybdenum metal sheet can be coated with one or multiple coats of rhenium, osmium, iridium, ruthenium, tungsten or a combination of two or more thereof. According to another example, a tungsten metal sheet is coated with one or multiple layers of rhenium, osmium, iridium, ruthenium, molybdenum or a combination of two or more thereof. According to a further example, the metal sheet of the metal sheet crucible can be made of molybdenum alloyed with rhenium or of tungsten alloyed with rhenium, and be coated on the inner side of the crucible with one or multiple layers comprising rhenium, osmium, iridium, ruthenium or a combination of two or more thereof.

Preferably, the metal sheet of the hanging metal sheet crucible has a density 95% or greater of the theoretical density, for example from 95% to 98% or from 96% to 98%. More preferable are higher theoretical densities, in particular in the range from 98 to 99.95%. The theoretical density of a basic material corresponds to the density of a pore free and 100% dense material. A density of the metal sheet of the metal sheet crucible of more than 95% of the theoretical density can for example be obtained by sintering a sinter metal and subsequent compactification of the sintered metal. Particularly preferably, a metal sheet crucible is obtainable by sintering of a sinter metal, rolling to obtain a metal sheet and processing the metal sheet to obtain a crucible.

Preferably, the metal sheet crucible has at least a lid, a wall and a base plate. Preferably, the hanging metal sheet crucible has at least one, for example at least two or at least three or at least four, particularly preferably at least five or all of the following features:
(a) at least one, e.g. more than one or at least two or at least three or at least five, particularly preferably three or four layers of the metal sheet;
(b) at least one metal sheet, e.g. at least three or at least four or at least six or at least eight or at least twelve or at least 15 or at least 16 or at least 20 metal sheets, particularly preferably twelve or 16 metal sheets;
(c) at least one join between two metal sheet parts, e.g. at least two or at least five or at least ten or at least 18 or at least 24 or at least 36 or at least 48 or at least 60 or at least 72 or at least 48 or at least 96 or at least 120 or at least 160, particularly preferably 36 or 48 joins between two of the same or between multiple different metal sheet parts of the hanging metal sheet crucible;
(d) The metal sheet parts of the hanging metal sheet crucible are riveted, e.g. by deep drawing at least one join e.g. joined by a combination of deep drawing with metal sheet collaring or countersinking, screwed or welded e.g. electron beam welding and sintering of the weld points, particularly preferably riveted;
(e) The metal sheet of the hanging metal sheet crucible is obtainable by a shaping step which is associated with an increase of the physical density, preferably by shaping of a sintered metal or of a sintered alloy; furthermore, preferably, the shaping is a rolling;
(f) A hanger assembly of copper, aluminium, steel, iron, nickel or a refractory metal, e.g. of the crucible material, preferably a water cooled hanger assembly of copper or steel;
(g) A nozzle, preferably a nozzle permanently fixed to the crucible;
(h) A mandrel, for example a mandrel fixed to the nozzle with pins or a mandrel fixed to the lid with a supporting rod or a mandrel attached underneath the crucible with a supporting rod;
(i) at least one gas inlet, e.g. in the form of a filling pipe or as a separate inlet;
(j) at least one gas outlet, e.g. as a separate outlet in the lid or in the wall of the crucible;
(k) a cooled jacket, preferably a water cooled jacket;
(l) an insulation on the outside, preferably an insulation on the outside made of zirconium oxide.

The hanging metal sheet crucible can in principle be heated in any way which is known to the skilled person and which seems to him to be suitable. The hanging metal sheet crucible can for example be heated by means of electrical heating elements (resistive) or by induction. In the case of resistive heating, the solid surface of the metal sheet crucible is warmed from the outside and delivers the energy from there to its inner side.

According to a preferred embodiment of the present invention, the energy transfer into the melting crucible is not performed by warming the melting crucible, or a bulk material present therein, or both, using a flame, such as for example a burner flame directed into the melting crucible or onto the melting crucible.

By means of the hanging arrangement, the hanging metal sheet crucible can be moved in the oven. Preferably, the crucible can be at least partially moved into and moved out of the oven. If different heating zones are present in the oven, their temperature profile will be transferred to the crucible which is present in the oven. By changing the position of the crucible in the oven, multiple heating zones, varying heating zones or multiple varying heating zones can be produced in the crucible.

The metal sheet crucible has a nozzle. The nozzle is made of a nozzle material. Preferably, the nozzle material comprises a pre-compactified material, for example with a density in a range of more than 95%, for example from 98 to 100%, particularly preferably from 99 to 99.999%, in each case based on the theoretical density of the nozzle material. Preferably, the nozzle material comprises a refractory metal, for example molybdenum, tungsten or a combination thereof with a further refractory metal. Molybdenum is a particularly preferred nozzle material. Preferably, a nozzle comprising molybdenum can have a density of 100% of the theoretical density.

Preferably, the base plate comprised in a metal sheet crucible is thicker than the sides of the metal sheet crucible. Preferably, the base plate is made of the same material as the sides of the metal sheet crucible. Preferably, the base plate of the metal sheet crucible is not a rolled metal sheet. The base plate is for example 1.1 to 5000 times as thick or 2 to 1000 times as thick or 4 to 500 times as thick, particularly preferably 5 to 50 times as thick, each time compared with a wall of the metal sheet crucible.

According to a preferred embodiment of the first aspect of the invention, the oven comprises a hanging or a standing sinter crucible. The silicon dioxide granulate is introduced into the hanging or standing sinter crucible and warmed to obtain a glass melt.

A sinter crucible means a crucible which is made from a sinter material which comprises at least one sinter metal and has a density of not more than 96% of the theoretical density of the metal. Sinter metal means metals of alloys which are obtained by sintering of metal powders. The sinter material and the sinter metal in a sinter crucible are not rolled.

Preferably, the sinter material of the sinter crucible has a density of 85% or more of the theoretical density of the sinter material, for example a density from 85% to 95% or from 90% to 94%, particularly preferably from 91% to 93%.

The sinter material can in principle be made of any material which is known to the skilled person and which is suitable for melting silicon dioxide. Preferably, the sinter material is made of at least one of the elements selected from the group consisting of refractory metals, graphite or materials lined with graphite foil.

Preferably, the sinter material comprises a first sinter metal selected from the group consisting of molybdenum, tungsten and a combination thereof. Furthermore, preferably, the sinter material additionally comprises at least one further refractory metal which is different to the first sinter metal particularly preferably selected from the group consisting of molybdenum, tungsten, rhenium, osmium, iridium, ruthenium or a combination of two or more thereof.

Preferably, the sinter material comprises an alloy of molybdenum with a refractory metal, or tungsten with a refractory metal. Particularly preferable alloy metals are rhenium, osmium, iridium, ruthenium or a combination of two or more thereof. According to a further example, the sinter material comprises an alloy of molybdenum with tungsten, rhenium, osmium, iridium, ruthenium or a combination of two or more thereof. For example the sinter material can comprise an alloy of tungsten with molybdenum, rhenium, osmium, iridium, ruthenium or a combination of two or more thereof.

According to a further preferred embodiment, the above described sinter material can comprise a coating which comprises a refractory metal, in particular rhenium, osmium, iridium, ruthenium or a combination of two or more thereof. According to a preferred example, the coating comprises rhenium, osmium, iridium, ruthenium, molybdenum or tungsten, or a combination of two or more thereof.

Preferably, the sinter material and its coating have different compositions. An example is a sinter material comprising molybdenum which is coated with one or more layers of rhenium, osmium, iridium, ruthenium, tungsten or of a combination of two or more thereof. According to another example, a sinter material comprising tungsten is coated with one or more layers of rhenium, osmium, iridium, ruthenium, molybdenum or of a combination of two or more thereof. According to another example, the sinter material can be made of molybdenum alloyed with rhenium or of tungsten alloyed with rhenium, and coated on the inner side of the crucible with one or multiple layers comprising rhenium, osmium, iridium, ruthenium or comprising a combination of two or more thereof.

Preferably, a sinter crucible is made by sintering the sinter material to obtain a mould. The sinter crucible can be made in a mould as a whole. It is also possible for individual parts of the sinter crucible to be made in a mould and subsequently processed to obtain the sinter crucible. Preferably, the crucible is made out of more than one part, for example a base plate and one or more side parts. The side parts are preferably made in one piece, based on the circumference of the crucible. Preferably, the sinter crucible can be made of multiple side parts arranged on top of each other. Preferably, the side parts of the sinter crucible are sealed by means of screwing or by means of a tongue and groove connection. A screwing is preferably achieved by making side parts which have a thread at the borders. In the case of a tongue and groove connection, two side parts which are to be joined each have a notch at the borders into which tongue is introduced as the connecting third part, such that a form-closed connection is formed perpendicular to the plane of the crucible wall. Particularly preferably, a sinter crucible is made of more than one side part, for example of two or more side parts, particularly preferably of three or more side parts. Particularly preferably, the parts of the hanging sinter crucible are screwed. Particularly preferably, the parts of the standing sinter crucible are connected by means of a tongue and groove connection.

The base plate can in principle be connected with the crucible wall by any means known to the skilled person and which is suitable for this purpose. According to a preferred embodiment, the base plate has an outward thread and the base plate is connected with the crucible wall by being screwed into it. According to a further preferred embodiment, the base plate is connected with the crucible wall by means of screws. According to a further preferred embodiment, the base plate is suspended in the sinter crucible, for example by laying the base plate on an inward flange of the crucible wall. According to a further preferred embodiment, at least a part of the crucible wall and a compactified base plate are sintered in one piece. Particularly preferably, the base plate and the crucible wall of the hanging sinter crucible are screwed. Particularly preferably, the base plate and the crucible wall of the standing sinter crucible are connected by means of a tongue and groove connection.

Preferably, the base plate comprised by a sinter crucible is thicker than the sides, for example 1.1 to 20 times as thick or 1.2 to 10 times as thick or 1.5 to 7 times as thick, particularly preferably 2 to 5 times as thick. Preferably, the sides have a constant wall thickness over the circumference and over the height of the sinter crucible.

The sinter crucible has a nozzle. The nozzle is made of a nozzle material. Preferably, the nozzle material comprises a pre-compactified material, for example with a density in a range of more than 95%, for example from 98 to 100%, particularly preferably from 99 to 99.999%, in each case based on the theoretical density of the nozzle material.

Preferably, the nozzle material comprises a refractory metal, for example molybdenum, tungsten or a combination therefrom with a refractory metal. Molybdenum is a particularly preferred nozzle material. Preferably, a nozzle comprising molybdenum can have a density of 100% of the theoretical density.

The hanging sinter crucible can be heated in any way known to the skilled person and which appears to him to be suitable. The hanging sinter crucible can for example be heated inductively or resistively. In the case of inductive heating, the energy is introduced directly via coils in the side wall of the sinter crucible and delivered from there to the inside of the crucible. In the case of resistive heating, the energy is introduced by radiation, whereby the solid surface is warmed from the outside and the energy is delivered from there to the inside. Preferably, the sinter crucible is heated inductively.

Preferably, the sinter crucible has one or more than one heating zones, for example one or two or three or more than three heating zones, preferably one or two or three heating zones, particularly preferably one heating zone. The heating zones of the sinter crucible can be brought up to the same temperature or different temperatures. For example, all heating zones can be brought up to one temperature, or all heating zones can be brought up to different temperatures, or two or more heating zones can be brought up to one temperature and one or more heating zones can, independently of each other, be brought up to other temperatures. Preferably, all heating zones are brought up to the different temperatures, for example the temperature of the heating zones increases in the direction of the material transport of the silicon dioxide granulate.

A hanging sinter crucible means a sinter crucible as previously described which is arranged hanging in an oven.

Preferably, the hanging sinter crucible has at least one, for example at least two or at least three or at least four, particularly preferably all of the following features:
{a} a hanging assembly, preferably a height adjustable hanging assembly;
{b} at least two rings sealed together as side parts, preferably at least two rings screwed to each other as side parts;
{c} a nozzle, preferably a nozzle which is permanently attached to the crucible;
{d} a mandrel, for example a mandrel fixed to the nozzle with pins or a mandrel fixed to the lid with a supporting rod or a mandrel attached underneath the crucible with a supporting rod;
{e} at least one gas inlet, e.g. in the form of a filling pipe or as a separate inlet, particularly preferably in the form of a filling pipe;
{f} at least one gas outlet, e.g. at the lid or in the wall of the crucible.
{g} A cooled jacket, particularly preferably a water cooled jacket;
{h} An insulation on the outside of the crucible, for example on the outside of the cooled jacket, preferably an insulation layer made of zirconium oxide.

The hanging assembly is preferably a hanging assembly which is installed during the construction of the hanging sinter crucible, for example a hanging assembly which is provided as an integral component of the crucible, particularly preferably a hanging assembly which is provided out of the sinter material as an integral component of the crucible. Furthermore, the hanging assembly is preferably a hanging assembly which is installed onto the sinter crucible and which is made of a material which is different to the sinter material, for example of aluminium, steel, iron, nickel or copper, preferably of copper, particularly preferably a cooled, for example a water cooled, hanging assembly made of copper which is installed on the sinter crucible.

By virtue of the hanging assembly, the hanging sinter crucible can be moved in the oven. Preferably, the crucible can be at least partially introduced and withdrawn from the oven. If different heating zones are present in the oven, their temperature profile will be transferred to the crucible which is present in the oven. By changing the position of the crucible in the oven, multiple heating zones, varying heating zones or multiple varying heating zones can be produced in the crucible.

A standing sinter crucible means a sinter crucible of the type previously described which is arranged standing in an oven.

Preferably, the standing sinter crucible has at least one, for example at least two or at least three or at least four, particularly preferably all of the following features:
/a/ A region formed as a standing area, preferably a region formed as a standing area on the base of the crucible, further preferably a region formed as a standing area in the base plate of the crucible, particularly preferably a region formed as a standing area at the outer edge of the base of the crucible;
/b/ at least two rings sealed together as side parts, preferably at least two rings sealed together by means of a tongue and groove connection as side parts;
/c/ a nozzle, preferably a nozzle which is permanently attached to the crucible, particularly preferably a region of the base of the crucible which is not formed as a standing area;
/d/ a mandrel, for example a mandrel fixed to the nozzle with pins or a mandrel fixed to the lid with pins or a mandrel attached from underneath the crucible with supporting rod;
/e/ at least one gas inlet, e.g. in the form of a filling tube or as a separate inlet;
/f/ at least one gas outlet, e.g. as a separate outlet in the lid or in the wall of the crucible;
/g/ a lid.

The standing sinter crucible preferably has a separation of the gas compartments in the oven and in the region underneath the oven. The region underneath the oven means the region underneath the nozzle, in which the removed first glass melt is present. Preferably, the gas compartments are separated by the surface on which the crucible stands. Gas which is present in the gas compartment of the oven between the inner wall of the oven and the outer wall of the crucible, cannot leak down into the region underneath the oven. The removed first glass melt does not contact the gases from the gas compartment of the oven. Preferably, first glass melts removed from an oven with a sinter crucible in a standing arrangement and glass products formed therefrom have a higher surface purity than first glass melts removed from an oven with a sinter crucible in a hanging arrangement and glass products formed therefrom.

Preferably, the crucible is connected with the inlet and the outlet of the oven in such a way that silicon dioxide granulate can enter into the crucible via the crucible inlet and through the inlet of the oven and the first glass melt can be removed through the outlet of the crucible and the outlet of the oven.

Preferably, the crucible comprises, in addition to the at least one inlet, at least one opening, preferably multiple openings, through which the gas can be introduced and removed. Preferably, the crucible comprises at least two openings, whereby at least one can be used as a gas inlet and at least one can be used as a gas outlet. Preferably, the use of at least one opening as gas inlet and at least one opening as gas outlet leads to a gas flow in the crucible.

The silicon dioxide granulate is introduced into the crucible through the inlet of the crucible and subsequently warmed in the crucible. The warming can be carried out in the presence of a gas or of a gas mixture of two or more gases. Furthermore, during the warming, water attached to the silicon dioxide granulate can transfer to the gas phase and form a further gas. The gas or the mixture of two or more gases is present in the gas compartment of the crucible.

The gas compartment of the crucible means the region inside the crucible which is not occupied by a solid or liquid phase. Suitable gases are for example hydrogen, inert gases as well as two or more thereof. Inert gases mean those gases which up to a temperature of 2400° C. do not react with the materials present in the crucible. Preferred inert gases are nitrogen, helium, neon, argon, krypton and xenon, particularly preferably argon and helium. Preferably, the warming is carried out in reducing atmosphere. This can be provided by means of hydrogen or a combination of hydrogen and an inert gas, for example a combination of hydrogen and helium, or of hydrogen and nitrogen, or of hydrogen and argon, particularly preferably a combination of hydrogen and helium.

Preferably, an at least partial gas exchange of air, oxygen and water in exchange for hydrogen, at least at least one inert gas, or in exchange for a combination of hydrogen and at least one inert gas is carried out on the silicon dioxide granulate. The at least partial gas exchange is carried out on the silicon dioxide granulate during introduction of the silicon dioxide granulate, or before the warming, or during the warming, or during at least two of the aforementioned activities. Preferably, the silicon dioxide granulate is warmed to melting in a gas flow of hydrogen and at least one inert gas, for example argon or helium.

Preferably, the dew point of the gas on exiting through the gas outlet is less than 0° C. The dew point means the temperature beneath which at fixed pressure a part of the gas or gas mixture in question condenses. In general, this means the condensation of water. The dew point is measured with a dew point mirror hygrometer according to the test method described in the methods section.

Preferably, the oven has at least one gas outlet, as does preferably also a melting crucible found therein, through which gas introduced into the oven and gas formed during the running of the oven is removed. The oven can additionally have at least one dedicated gas inlet. Alternatively or additionally, gas can be introduced through the inlet, also referred to as the solids inlet, for example together with the silicon dioxide particles, or beforehand, afterwards, or by a combination of two or more of the aforementioned possibilities.

Preferably, the gas which is removed from the oven through the gas outlet has a dew point of less than 0° C., for example of less than −10° C., or less than −20° C. on exiting from the oven through the gas outlet. The dew point is measured according to the test method described in the methods section at a slight overpressure of 5 to 20 mbar. A suitable measuring device is for example an “Optidew” device from the company Michell Instruments GmbH, D-61381 Friedrichsdorf.

The dew point of the gas is preferably measured at a measuring location at a distance of 10 cm or more from the gas outlet of the oven. Often, this distance is between 10 cm and 5 m. In this range of distances—here referred to as “on exiting”—the distance of the measuring location from the gas outlet of the oven is insignificant for the result of the dew point measurement. The gas is conveyed to the measurement location by fluid connection, for example in a hose or a tube. The temperature of the gas at the measurement location is often between 10 and 60° C., for example 20 to 50° C., in particular 20 to 30° C.

Suitable gases and gas mixtures have already been described. It was established in the context of separate tests that the above disclosed values apply to each of the named gases and gas mixtures.

According to a further preferred embodiment, the gas or gas mixture has a dew point of less than −50° C. prior to entering into the oven, in particular into the melting crucible, for example less than −60° C., or less than −70° C., or less than −80° C. A dew point commonly does not exceed −60° C. Also, the following ranges for the dew point upon entering into the oven are preferred: from −50 to −100° C.; from −60 to −100° C. and from −70 to −100° C.

According to a further preferred embodiment, the dew point of the gas prior to entering into the oven is at least 50° C. less than on exiting from the melting crucible, for example at least 60° C., or even 80° C. For measuring the dew point on exiting from the melting crucible, the above disclosures apply. For measuring the dew point prior to entry into the oven, the disclosures apply analogously. Since no source of contribution to moisture is present and there is no possibility of condensing out between the measuring location and the oven, the distance of the measuring location to the gas inlet of the oven is not relevant.

According to a preferred embodiment, the oven, in particular the melting crucible, is operated with a gas exchange rate in a range from 200 to 3000 L/h.

According to a preferred embodiment, the dew point is measured in a measuring cell, the measuring cell being separated by a membrane from the gas passing through the gas outlet. The membrane is preferably permeable to moisture. By these means, the measuring cell can be protected from dust and other particles present in the gas flow and which are conveyed out of the melting oven, in particular out of a melting crucible, along with the gas flow By these means, the working time of a measuring probe can be increased considerably. The working time means the time period of operation of the oven during which neither replacement of the measuring probe, nor cleaning of the measuring probe is required.

According to a preferred embodiment, a dew point mirror measuring device is employed.

The dew point at the gas outlet of the oven can be configured. Preferably, a process for configuring the dew point at the outlet of the oven comprises the following steps:
I) Providing an input material in an oven, wherein the input material has a residual moisture;
II) Operating the oven, wherein a gas flow is passed through the oven, and
III) Varying the residual moisture of the input material, or the gas replacement rate of the gas flow.

Preferably, this process can be used to configure the dew point to a range of less than 0° C., for example less than −10° C., particularly preferably less than −20° C. Further preferably, the dew point can be configured to a range of less than 0° C. to −100° C., for example less than −10° C. to −80° C., particularly preferably less than −20° C. to −60° C.

For the preparation of a glass body, “Input material” means silicon dioxide particles which are provided, preferably silicon dioxide granulate, silicon dioxide grain, or combinations thereof. The silicon dioxide particles, the granulate and the grain are preferably characterised by the features described in the context of the first aspect.

The oven and the gas flow are preferably characterised by the features described in the context of the first aspect. Preferably, the gas flow is formed by introducing a gas into the oven through an inlet and by removing a gas out of the oven through an outlet. The “gas replacement rate” means the volume of gas which is passed out of the oven through the outlet per unit time. The gas replacement rate is also called the throughput of the gas flow or volume throughput.

The configuration of the dew point can in particular be performed by varying the residual moisture of the input material or the gas replacement rate of the gas flow. For example, the dew point can be increased by residual moisture of the input material. By decreasing the residual moisture of the input material, the dew point can be reduced. An increase in the gas replacement rate can lead to a reduction in the dew point. A reduced gas replacement rate on the other hand can yield an increased dew point.

Preferably, the gas replacement rate of the gas flow is in a range from 200 to 3000 L/h, for example 200 to 2000 L/h, particularly preferably 200 to 1000 L/h.

The residual moisture of the input material is preferably in a range from 0.001 wt. % to 5 wt. %, for example from 0.01 to 1 wt. %, particularly preferably 0.03 to 0.5 wt. %, in each case based on the total weight of the input material.

Preferably, the dew point can also be affected by further factors. Examples of such means are the dew point of the gas flow on entry into the oven, the oven temperature and the composition of the gas flow. A reduction of the dew point of the gas flow on entry into the oven, a reduction of the oven temperature or a reduction of the temperature of the gas flow at the outlet of the oven can lead to a reduction of the dew point of the gas flow at the outlet. The temperature of the gas flow at the outlet of the oven has no effect on the dew point, as long as it is above the dew point.

Particularly preferably, the dew point is configured by varying the gas replacement rate of the gas flow.

Preferably, the process is characterised by at least one, for example at least two or at least three, particularly preferably at least four of the following feature:
I} A residual moisture of the input material in a range from 0.001 to 5 wt. %, for example from 0.01 to 1 wt. %, particularly preferably from 0.03 to 0.5 wt. %, in each case based on the total weight of the input material.
II} A gas replacement rate of the gas flow in a range from 200 to 3000 L/h, for example from 200 to 2000 L/h, particularly preferably from 200 to 1000 L/h;
III} An oven temperature in a range from 1700 to 2500° C., for example in a range from 1900 to 2400° C., particularly preferably in a range from 2100 to 2300° C.;
IV} A dew point of the gas flow on entry into the oven in a range from −50° C. to −100° C., for example from −60° C. to −100° C., particularly preferably from −70° C. to −100° C.;
V} The gas flow comprises helium, hydrogen or a combination thereof, preferably helium and hydrogen in a ratio from 20:80 to 95:5;
VI} A temperature of the gas at the outlet in a range from 10 to 60° C., for example from 20 to 50° C., particularly preferably from 20 to 30° C.

It is particularly preferred, when employing a silicon dioxide granulate with a high residual moisture, to employ a gas flow with a high gas replacement rate and a low dew point at the inlet of the oven. By contrast, when employing a silicon dioxide granulate with a low residual moisture, a gas flow with a low gas replacement rate and a high dew point at the inlet of the oven can be used.

Particularly preferably, when employing a silicon dioxide granulate with a residual moisture of less than 3 wt. %, the gas replacement rate of a gas flow comprising helium and hydrogen can be in a range from 200 to 3000 L/h.

If a silicon dioxide granulate with a residual moisture of 0.1% is fed to the oven at 30 kg/h, a gas replacement rate of the gas flow in a range from 2800 to 3000 l/h is selected in the case of He/H₂=50:50 and in a range from 2700 to 2900 l/h is selected in the case of He/H₂=30:70, and a dew point of the gas flow before entry into the oven of −90° C. is selected. A dew point of less than 0° C. is thereby obtained at the gas outlet.

If a silicon dioxide granulate with a residual moisture of 0.05% is fed to the oven at 30 kg/h, a gas replacement rate of the gas flow in a range from 1900 to 2100 l/h is selected in the case of He/H₂=50:50 and in a range from 1800 to 200 l/h is selected in the case of He/H₂=30:70, and a dew point of the gas flow before entry into the oven of −90° C. is selected. A dew point of less than 0° C. is thereby obtained at the gas outlet.

If a silicon dioxide granulate with a residual moisture of 0.03% is fed to the oven at 30 kg/h, a gas replacement rate of the gas flow in a range from 1400 to 1600 l/h is selected in the case of He/H₂=50:50 and in a range from 1200 to 1400 l/h is selected in the case of He/H₂=30:70, and a dew point of the gas flow before entry into the oven of −90° C. is selected. A dew point of less than 0° C. is thereby obtained at the gas outlet.

The oven temperature for melting the silicon dioxide granulate is preferably in the range from 1700 to 2500° C., for example in the range from 1900 to 2400° C., particularly preferably in the range from 2100 to 2300° C.

Preferably, the holding time in the oven is in a range from 1 hour to 50 hours, for example 1 to 30 hours, particularly preferably 5 to 20 hours. In the context of the present invention, the holding time means the time which is required, when carrying out the process according to the invention, to remove the fill quantity of the melting oven from the melting oven in which the glass melt is formed, in a manner according to the invention. The fill quantity is the entire mass of silicon dioxide in the melting oven. In this connection, the silicon dioxide can be present as a solid and as a glass melt.

Preferably, the oven temperature increases over the length in the direction of the material transport. Preferably, the oven temperature increases over the length in the direction of the material transport by at least 100° C., for example by at least 300° C. or by at least 500° C. or by at least 700° C., particularly preferably by at least 1000° C. Preferably, the maximum temperature in the oven is 1700 to 2500° C., for example 1900 to 2400° C., particularly preferably 2100 to 2300° C. The increase of the oven temperature can proceed uniformly or according to a temperature profile.

Preferably, the oven temperature decreases before the glass melt is removed from the oven. Preferably, the oven temperature decreases before the glass melt is removed from the oven by 50 to 500° C., for example by 100° C. or by 400° C., particularly preferably by 150 to 300° C. Preferably, the temperature of the glass melt on removal is 1750 to 2100° C., for example 1850 to 2050° C., particularly preferably 1900 to 2000° C.

Preferably, the oven temperature increases over the length in the direction of the material transport and decreases before the glass melt is removed from the oven. In this connection, the oven temperature preferably increases over the length in the direction of the material transport by at least 100° C., for example by at least 300° C. or by at least 500° C. or by at least 700° C., particularly preferably by at least 1000° C. Preferably, the maximum temperature in the oven is 1700 to 2500° C., for example 1900 to 2400° C., particularly preferably 2100 to 2300° C. Preferably, the oven temperature decreases before the glass melt is removed from the oven by 50 to 500° C., for example by 100° C. or by 400° C., particularly preferably by 150 to 300° C.

### Pre-Heating Section

Preferably, the oven has at least a first and a further chamber joined to each other by a passage, the first and the second chamber having a different temperature, the temperature of the first chamber being lower than the temperature of the further chamber. In the further chamber, a first glass melt is formed from the silicon dioxide granulate. This chamber is referred to as melting chamber in the following. A chamber which is joined to the melting chamber via a duct but which is upstream of it is also referred to as pre-heating section. An example is those in which at least one outlet is directly connected with the inlet of the melting chamber. The arrangement above may also be made in independent ovens, in which case the melting chamber is a melting oven. In the further description, however, the term ‘melting oven’ may be taken as being identical to the term ‘melting chamber’: so what is said concerning the melting oven may also be taken as applying to the melting chamber and vice versa. The term ‘pre-heating section’ means the same in both cases.

Preferably, the silicon dioxide granulate has a temperature in a range from 20 to 1300° C. on entry into the oven.

According to a first embodiment, the silicon dioxide granulate is not tempered prior to entry into the melting chamber. The silicon dioxide granulate has for example a temperature in a range from 20 to 40° C. on entry into the oven, particularly preferably from 20 to 30° C. If silicon dioxide granulate II is provided according to step i.), it preferably has a temperature on entry into the oven in a range from 20 to 40° C., particularly preferably from 20 to 30° C.

According to another embodiment, the silicon dioxide granulate is tempered up to a temperature in a range from 40 to 1300° C. prior to entry into the oven. Tempering means setting the temperature to a selected value. The tempering can in principle be carried out in any way known to the skilled person and known for the tempering of silicon dioxide granulate. For example, the tempering can be carried out in an oven arranged separate from the melting chamber or in an oven connected to the melting chamber.

Preferably, the tempering is carried out in a chamber connected to the melting chamber. Preferably, the oven therefore comprises a pre-heating section in which the silicon dioxide can be tempered. Preferably, the pre-heating section is itself a feed oven, particularly preferably a rotary kiln. A feed oven means a heated chamber which, in operation, effects a movement of the silicon dioxide from an inlet of the feed oven to an outlet of the feed oven. Preferably, the outlet is directly connected to an inlet of the melting oven. In this way, the silicon dioxide granulate can arrive from the pre-heating section into the melting oven without further intermediate steps or means.

It is further preferred that the pre-heating section comprises at least one gas inlet and at least one gas outlet. Through the gas inlet, the gas can arrive in the interior, the gas chamber of the pre-heating section, and through the gas outlet it can be removed. It is also possible to introduce gas into the pre-heating section via the inlet of the pre-heating section for the silicon dioxide granulate. Also, gas can be removed via the outlet of the pre-heating section and subsequently separated from the silicon dioxide granulate. Furthermore, preferably, the gas can be introduced via the inlet for the silicon dioxide granulate and a gas inlet of the pre-heating section, and removed via the outlet of the pre-heating section and a gas outlet of the pre-heating section.

Preferably, a gas flow is produced in the pre-heating section by use of the gas inlet and of the gas outlet. Suitable gases are for example hydrogen, inert gases as well as two or more thereof. Preferred inert gases are nitrogen, helium, neon, argon, krypton and xenon, particularly preferably nitrogen and helium. Preferably, a reducing atmosphere is present in the pre-heating section. This can be provided in the form of hydrogen or a combination of hydrogen and an inert gas, for example a combination of hydrogen and helium or of hydrogen and nitrogen, particularly preferably a combination of hydrogen and helium. Furthermore, preferably, an oxidising atmosphere is present in the pre-heating section. This can preferably be provided in the form of oxygen or a combination of oxygen and one or more further gases, air being particularly preferable. Further preferably, it is possible of the silicon dioxide to be tempered at reduced pressure in the pre-heating section.

For example, the silicon dioxide granulate can have a temperature on entry into the oven in a range from 100 to 1100° C. or from 300 to 1000 or from 600 to 900° C. If silicon dioxide granulate II is provided according to step i.), it preferably has a temperature on entry into the oven in a range from 100 to 1100° C. or from 300 to 1000 or from 600 to 900° C.

According to a preferred embodiment of the first aspect of the invention, the oven comprises at least two chambers. Preferably, the oven comprises a first and at least one further chamber. The first and the further chamber are connected to each other by a passage.

The at least two chambers can in principle be arranged in the oven in any manner, preferably vertical or horizontal, particularly preferably vertical. Preferably, the chambers are arranged in the oven in such a way that on carrying out the process according to the first aspect of the invention, silicon dioxide granulate passes through the first chamber and is subsequently heated in the further chamber to obtain a first glass melt. The further chamber preferably has the above described features of the melting oven and of the crucible arranged therein.

Preferably, each of the chambers comprises an inlet and an outlet. Preferably, the inlet of the oven is connected to the inlet of the first chamber via a passage. Preferably, the outlet of the oven is connected to the outlet of the further chamber via a passage. Preferably, the outlet of the first chamber is connected to the inlet of the further chamber via a passage.

Preferably, the chambers are arranged in such a manner that the silicon dioxide granulate can arrive in the first chamber through the inlet of the oven. Preferably, the chambers are arranged in such a manner that a first glass melt can be removed from the further chamber through the outlet of the oven. Particularly preferably, the silicon dioxide granulate can arrive in the first chamber through the inlet of the oven and a first glass melt can be removed from a further chamber through the outlet of the oven.

The silicon dioxide, in the form of granulate or powder, can go from a first into a further chamber through the passage in the direction of material transport as defined by the process. Reference to chambers connected by a passage includes arrangements in which further intermediate elements arrange in the direction of the material transport between a first and a further chamber. In principle, gases, liquids and solids can pass through the passage. Preferably, silicon dioxide powder, slurries of silicon dioxide powder and silicon dioxide granulate can pass through the passage between a first and a further chamber. Whilst the process according to the invention is carried out, all of the materials introduced into the first chamber can arrive in the further chamber via the passage between the first and the further chamber. Preferably, only silicon dioxide in the form of granulate or powder arrive in the further chamber via the passage between the first and the further chamber. Preferably, the passage between the first and the further chamber is closed up by the silicon dioxide, such that the gas chamber of the first and the further chamber are separated from each other, preferably such that in different gases or gas mixtures, different pressures or both can be present in the gas chambers. According to another preferred embodiment, the passage is formed of a gate, preferably a rotary gate valve.

Preferably, the first chamber of the oven has at least one gas inlet and at least one gas outlet. The gas inlet can in principle have any form which is known to the skilled person and which is suitable for introduction of a gas, for example a nozzle, a vent or a tube. The gas outlet can in principle have any form known to the skilled person and which is suitable for removal of a gas, for example a nozzle, a vent or a tube.

Preferably, silicon dioxide granulate is introduced into the first chamber through the inlet of the oven and warmed. The warming can be carried out in the presence of a gas or of a combination of two or more gases. To this end, the gas or the combination of two or more gases is present in the gas chamber of the first chamber. The gas chamber of the first chamber means the region of the first chamber which is not occupied by a solid or liquid phase. Suitable gases are for example hydrogen, oxygen, inert gases as well as two or more thereof. Preferred inert gases are nitrogen, helium, neon, argon, krypton and xenon, particularly preferred are nitrogen, helium and a combination thereof. Preferably, the warming is carried out in a reducing atmosphere. This can preferably be provided in the form of hydrogen or a combination of hydrogen and helium. Preferably, the silicon dioxide granulate is warmed in the first chamber in a flow of the gas or of the combination of two or more gases.

It if further preferred that the silicon dioxide granulate is warmed in the first chamber at reduced pressure, for example at a pressure of less than 500 mbar or less than 300 mbar, for example 200 mbar or less.

Preferably, the first chamber has at least one device with which the silicon dioxide granulate is moved. In principle, all devices can be selected which are known to the skilled person for this purpose and which appear suitable. Preferably, stirring, shaking and slewing devices.

According to a preferred embodiment of the first aspect of the invention, the temperatures in the first and in the further chamber are different. Preferably, the temperature in the first chamber is lower than the temperature in the further chamber. Preferably, the temperature difference between the first and the further chamber is in a range from 600 to 2400° C., for example in a range from 1000 to 2000° C. or from 1200 to 1800° C., particularly preferably in a range from 1500 to 1700° C. Furthermore, preferably, the temperature the first chamber is 600 to 2400° C., for example 1000 to 2000° C. or 1200 to 1800° C., particularly preferably 1500 to 1700° C. lower than the temperature in the further chamber.

According to a preferred embodiment, the first chamber of the oven is a pre-heating section, particularly preferably a pre-heating section as described above, which has the features as described above. Preferably, the pre-heating section is connected to the further chamber via a passage. Preferably, silicon dioxide goes from the pre-heating section via a passage into the further chamber. The passage between the pre-heating section and the further chamber can be closed off, so that no gases introduces into the pre-heating section go through the passage into the further chamber. Preferably, the passage between the pre-heating section and the further chamber is closed off, so that the silicon dioxide does not come into contact with water. The passage between the pre-heating section and the further chamber can be closed off, so that the gas chamber of the pre-heating section and the first chamber are separated from each other in such a way that different gases or gas mixtures, different pressures or both can be present in the gas chambers. A suitable passage is preferably as per the above described embodiments.

According to a further preferred embodiment, the first chamber of the oven is not a pre-heating section. For example, the first chamber can be a levelling chamber. A levelling chamber is a chamber of the oven in which variations in throughput in a pre-heating section upstream thereof, or throughput differences between a pre-heating section and the further chamber are levelled. For example, as described above a rotary kiln can be arranged upstream of the first chamber. This commonly has a throughput which can vary by an amount up to 6% of the average throughput. Preferably, silicon dioxide is held in a levelling chamber at the temperature at which it arrives in the levelling chamber.

It is also possible for the oven to have a first chamber and more than one further chambers, for example two further chambers or three further chambers or four further chambers or five further chambers or more than five further chambers, particularly preferably two further chambers. If the oven has two further chambers, the first chamber is preferably a pre-heating section, the first of the further chambers a levelling chamber and the second of the further chambers the melting chamber, based on the direction of the material transport.

According to a further preferred embodiment, an additive is present in the first chamber. The additive is preferably selected from the group consisting of halogens, inert gases, bases, oxygen or a combination of two or more thereof.

In principle, halogens in elemental form and halogen compounds are suitable additives. Preferred halogens are selected from the group consisting of chlorine, fluorine, chlorine containing compounds and fluorine containing compounds. Particularly preferable are elemental chlorine and hydrogen chloride.

In principle, all inert gases as well as mixtures of two or more thereof are suitable additives. Preferred inert gases are nitrogen, helium or a combination thereof.

In principle bases are also suitable additives. Preferred bases for use as additives are inorganic and organic bases.

Further, oxygen is a suitable additive. The oxygen is preferably present as an oxygen containing atmosphere, for example in combination with an inert gas or a mixture of two or more inert gases, particularly preferably in combination with nitrogen, helium or nitrogen and helium.

The first chamber can in principle comprise any material which is known to the skilled person and which is suitable for heating silicon dioxide. Preferably, the first chamber comprises at least one element selected from the group consisting of quartz glass, a refractory metal, aluminium and a combination of two or more thereof, particularly preferably, the first chamber comprises quartz glass or aluminium.

Preferably, the temperature in the first chamber does not exceed 600° C. if the first chamber comprises a polymer or aluminium. Preferably, the temperature in the first chamber is 100 to 1100° C., if the first chamber comprises quartz glass. Preferably, the first chamber comprises mainly quartz glass.

In the transportation of the silicon dioxides from the first chamber to the further chamber through the passage between the first and the further chamber, the silicon dioxide can in principle be present in any state. Preferably, the silicon dioxide is present as a solid, for example as particles, powder or granulate. According to a preferred embodiment of the first aspect of the invention, the transportation of the silicon dioxides from the first to the further chamber as granulate.

According to a further preferred embodiment, the further chamber is a crucible made of a metal sheet or of a sinter material, wherein the sinter material comprises a sinter metal, wherein the metal sheet or the sinter metal is selected from the group consisting of molybdenum, tungsten and a combination thereof.

The first glass melt is removed from the oven through the outlet, preferably via a nozzle.

### Preparing a First Glass Melt by Vacuum Sintering

Heating of the silicon dioxide granulate to obtain a first glass melt can be performed by vacuum sintering. This process is a discontinuous process in which the silicon dioxide granulate is heated in batches for melting.

Preferably, the silicon dioxide granulate is heated in an evacuatable crucible. The crucible is arranged in a melting oven. The crucible can be arranged standing or hanging, preferably hanging. The crucible can be a sintering crucible or sheet metal crucible. Preferred are rolled metal sheet crucibles made out of multiple sheets which are riveted together. Examples of suitable crucible materials are refractory metals, in particular W, Mo and Ta, graphite or crucibles lined with graphite foil; graphite crucibles are particularly preferred.

During vacuum sintering, the silicon dioxide granulate is heated in the vacuum until it melts. The term vacuum is understood to mean a residual pressure of less than 2 mbar. For this, the crucible containing the silicon dioxide granulate is evacuated to a residual pressure of less than 2 mbar.

Preferably, the crucible is heated in the melting oven to a melting temperature in the range from 1500 to 2500° C., for example in the range from 1700 to 2300° C., particularly preferably in the range from 1900 to 2100° C.

The preferred holding time of the silicon dioxide granulate in the crucible at the melting temperature depends on the content. Preferably, the holding time of the silicon dioxide granulate in the crucible at the melting temperature is 0.5 to 10 hours, for example 1 to 8 hours or 1.5 to 6 hours, particularly preferably 2 to 5 hours.

The silicon dioxide granulate can be agitated during heating. The silicon dioxide granulate is agitated preferably by stirring, shaking or slewing.

### Preparing a First Glass Melt by Gas Pressure Sintering (GDS)

Heating the silicon dioxide granulate to obtain a first glass melt can be performed by gas pressure sintering (abbreviated as: “GDS”, which is the German acronym for gas pressure sintering). This process is a discontinuous process in which the silicon dioxide granulate is heated in batches for melting.

Preferably, the silicon dioxide granulate is introduced into a sealable crucible and inserted in a melting oven. Examples of suitable crucible materials are graphite, refractory metals, in particular W, Mo and Ta, or crucibles lined with graphite foil; graphite crucibles are particularly preferred. The crucible comprises at least one gas inlet and at least one gas outlet. Gas can be introduced into the interior of the crucible through the gas inlet. Gas can be guided out of the crucible interior through the gas outlet. Preferably, it is possible to operate the crucible in the gas flow and in the vacuum.

With gas pressure sintering, the silicon dioxide granulate is heated to melting in the presence of at least one gas or two or more gases. Suitable gases are for example H₂, and inert gases (N₂, He, Ne, Ar, Kr), as well as two or more thereof. Preferably, gas pressure sintering is carried out in a reducing atmosphere, particularly preferably in the presence of H₂ or H₂/He. A gas exchange of air with H₂ or H₂/He takes place.

Preferably, the silicon dioxide granulate is heated at a gas pressure of more than 1 bar, for example in the range from 2 to 200 bar or from 5 to 200 bar or from 7 to 50 bar, particularly preferably from 10 to 25 bar.

Preferably, the crucible is heated in the oven to a melting temperature in the range from 1500 to 2500° C., for example in the range from 1550 to 2100° C. or from 1600 to 1900° C., particularly preferably in the range from 1650 to 1800° C.

The preferred holding time of the silicon dioxide granulate in the crucible at the melting temperature under gas pressure depends on the content. Preferably, the holding time of the silicon dioxide granulate in the crucible at the melting temperature is 0.5 to 10 hours, for example 1 to 9 hours or 1.5 to 8 hours, particularly preferably 2 to 7 hours, with a content of 20 kg.

Preferably, the silicon dioxide granulate is melted in the vacuum, then in a H₂ atmosphere or an atmosphere containing H₂ and He, particularly preferably in a counter flow of these gases. With this process, the temperature in the first step is preferably lower than in the further step. The temperature difference between heating in the vacuum and in the presence of the gas(es) is preferably 0 to 200° C., for example 10 to 100° C., particularly preferably 20 to 80° C.

### Forming a Semicrystalline Phase Before Melting

In principle it is also possible that the silicon dioxide granulate is pre-treated before melting. For example, the silicon dioxide granulate can be heated such that an at least semicrystalline phase is formed before the semicrystalline silicon dioxide granulate is heated until it melts.

To form a semicrystalline phase, the silicon dioxide granulate is preferably heated at reduced pressure or in the presence of one or more gases. Suitable gases are, for example HCl, Cl₂, F₂, O₂, H₂, C₂F₆, air, inert gas (N₂, He, Ne, Ar, Kr), as well as two or more thereof. Preferably, the silicon dioxide granulate is heated at reduced pressure.

Preferably, the silicon dioxide granulate is heated to a treatment temperature at which the silicon dioxide granulate softens without completely melting, for example to a temperature in the range from 1000 to 1700° C. or from 1100 to 1600° C. or from 1200 to 1500° C., particularly preferably to a temperature in the range from 1250 to 1450° C.

Preferably, the silicon dioxide granulate is heated in a crucible which is arranged in an oven. The crucible can be arranged standing or hanging, preferably hanging. The crucible can be a sintering crucible or a sheet metal crucible. Preferred are rolled metal sheet crucibles made out of multiple sheets which are riveted together. Examples of suitable crucible materials are refractory metals, in particular W, Mo and Ta, graphite or crucibles lined with graphite foil; graphite crucibles are particularly preferred. The preferred holding time of the silicon dioxide granulate in the crucible at the treatment temperature is 1 to 6 hours, for example 2 to 5 hours, particularly preferably 3 to 4 hours.

Preferably, the silicon dioxide granulate is heated in a continuous process, particularly preferably in a rotary kiln. The mean holding time in the oven is preferably 10 to 180 min, for example 20 to 120 min, particularly preferably 30 to 90 min.

Preferably, the oven used for pre-treatment can be integrated in the feed to the melting oven in which the silicon dioxide granulate is heated until it melts. Further preferably, the pre-treatment can be performed in the melting oven.

A “crucible drawing process” is understood to mean a process in which the melt material is heated until it melts in an oven aligned vertically and suitable for a continuous process, and subsequently at least one part of the melt is removed at the outlet of the oven through a nozzle (step iii.)). Those embodiments are preferred which were described as preferable in the context of steps ii.) and iii.) for continuous processes in a vertically aligned oven.

A “GDS process” (GDS is the German acronym for “Gasdrucksintem”; in English: “Gas pressure sintering”) is understood to mean a process in which the melt material is processed to obtain a glass melt by gas pressure sintering in a sintering mould, and then set in this mould to obtain a glass product or a quartz glass body. Those embodiments are preferred which were described as preferable in the context of steps ii.) and iii.) in this respect.

A “melt material” is understood to mean the material to be melted, in respect of step ii.) also silicon dioxide granulate and in respect of step v.) a quartz glass grain.

The glass product in step iii.) and the quartz glass body in step iv.) can each be formed, independently of one another, by similar or different processes. For example, the glass product in step iii.) and the quartz glass body in step vi.) can be formed, independently of one another, by crucible drawing process, GDS processes or IDD processes.

In a preferred embodiment of the first aspect of the invention, the melting energy is transferred to the silicon dioxide granulate via a solid surface.

A solid surface is understood to mean a surface which is different to the surface of the silicon dioxide granulate and which does not melt or decompose at the temperatures to which the silicon dioxide granulate is heated for melting. Suitable materials for the solid surface are for example the materials which are suitable as crucible materials.

The solid surface can in principle be any surface which is known to a person skilled in the art and which is suitable for this purpose. For example the crucible or a separate component which is not the crucible can be used as the solid surface.

The solid surface can in principle be heated in any manner known to a person skilled in the art and which is suitable for this purpose, in order to transfer the melting energy to the silicon dioxide granulate. Preferably, the solid surface is heated by resistive heating or inductive heating. In the case of inductive heating, the energy is directly coupled into the solid surface by means of coils and delivered from there to its interior. In the case of resistive heating, the solid surface is heated from the exterior and passes the energy from there to its interior. In this connection, a heating chamber gas with low heat capacity is advantageous, for example an argon atmosphere or an argon containing atmosphere. For example, the solid surface can be heated electrically or also by firing the solid surface with a flame from the outside. Preferably, the solid surface is heated to a temperature which can transfer an amount of energy to the silicon dioxide granulate and/or part melted silicon dioxide granulate which is sufficient for melting the silicon dioxide granulate.

If a separate component is used as the solid surface, this can be brought into contact with the silicon dioxide granulate in any manner, for example by laying the component on the silicon dioxide granulate or by introducing the component between the granules of the silicon dioxide granulate or by inserting the component between the crucible and the silicon dioxide granulate or by a combination of two or more thereof. The component can be heated before, or during or before and during the transfer of the melting energy.

Preferably, the melting energy is transferred to the silicon dioxide granulate via the interior of the crucible. In this case, the crucible is heated enough so that the silicon dioxide granulate melts. The crucible is preferably heated resistively or inductively. The heat is transferred from the exterior to the interior of the crucible. The solid surface of the interior of the crucible transfers the melting energy to the silicon dioxide granulate.

According to a further preferred embodiment of the present invention, the melting energy is not transferred to the silicon dioxide granulate via a gas chamber. Furthermore, preferably, the melting energy is not transferred to the silicon dioxide granulate by firing of the silicon dioxide granulate with a flame. Examples of these excluded means of transferring energy are directing one or more burner flames from above in the melting crucible, or onto the silicon dioxide, or both.

### Step iii.)

A glass product is made out of at least one part of the first glass melt. For this, preferably at least one part of the glass melt made in step ii) is removed and the glass product is made out of it.

The removal of a part of the glass melt made in step ii) can in principle be carried out continuously from the melting oven or the melting chamber or after the preparation of the first glass melt has been finished. Preferably, a part of the glass melt is removed continuously. The first glass melt is removed through the outlet of the oven or through the outlet of the melting chamber, in each case preferably via a nozzle.

The first glass melt can be cooled before, during or after the removal, to a temperature which enables the forming of the first glass melt. A rise in the viscosity of the glass melt is connected to the cooling of the first glass melt. The first glass melt is preferably cooled to such an extent that in the forming, the produced form holds and the forming is at the same time as easy and reliable as possible and can be carried out with little effort. A person skilled in the art can easily establish the viscosity of the first glass melt for forming by varying the temperature of the first glass melt at the forming tool. Preferably, the first glass melt has a temperature on removal in the range from 1750 to 2100° C., for example 1850 to 2050° C., particularly preferably 1900 to 2000° C. Preferably, the glass melt is cooled to a temperature of less than 500° C. after removal, for example of less than 200° C. or less than 100° C. or less than 50° C., particularly preferably to a temperature in the range from 20 to 30° C.

Further preferably, cooling takes place at a rate in a range from 0.1 to 50 K/min, for example from 0.2 to 10 K/min or from 0.3 to 8 K/min or from 0.5 to 5 K/min, particularly preferably in a range from 1 to 3 K/min.

It is further preferred to cool according to the following profile:
1. Cooling to a temperature in a range from 1180 to 1220° C.;
2. Holding at this temperature over a period of 30 to 120 min, for example from 40 to 90 min, particularly preferably from 50 to 70 min;
3. Cooling to a temperature of less than 500° C., for example of less than 200° C. or less than 100° C. or less than 50° C., particularly preferably to a temperature in the range from 20 to 30° C.,
wherein cooling takes place in each case at a rate in a range from 0.1 to 50 K/min, for example from 0.2 to 10 K/min or from 0.3 to 8 K/min or from 0.5 to 5 K/min, particularly preferably in a range from 1 to 3 K/min.

The glass product which is formed can be a solid body or a hollow body. A solid body means a body which is mainly made out of a single material. Nevertheless, a solid body can have one or more inclusions, e.g. gas bubbles. Such inclusions in a solid body commonly have a size of 65 mm³ or less, for example of less than 40 mm³, or of less than 20 mm³, or of less than 5 mm³, or of less than 2 mm³, particularly preferably of less than 0.5 mm³. Preferably, a solid body comprises less than 0.02 vol.-% of its volume as inclusion, for example less than 0.01 vol.-% or less than 0.001 vol.-%, in each case based on the total volume of the solid body.

The glass product has an exterior form. The exterior form means the form of the outer edge of the cross section of the glass product. The exterior form of the glass product in cross section is preferably round, elliptical or polygonal with three or more corners, for example 4, 5, 6, 7 or 8 corners, particularly preferably the quartz glass body is round.

Preferably, the glass product has a length in the range from 100 to 10000 mm, for example from 1000 to 4000 mm, particularly preferably from 1200 to 3000 mm.

Preferably, the glass product has an outer diameter in the range from 1 to 500 mm, for example in a range from 2 to 400 mm, particularly preferably in a range from 5 to 300 mm.

The forming of the glass product can be performed by a nozzle. The first glass melt is guided through the nozzle. The exterior form of a glass product formed through the nozzle is determined by the form of the nozzle opening. If the opening is round, a cylinder will be made in forming the glass product. If the opening of the nozzle has a structure, this structure will be transferred to the exterior form of the quartz glass body. A glass product which is made by a nozzle with structures at the opening has an image of the structures in longitudinal direction along the glass strand.

The nozzle is integrated in the melting oven. Preferably, it is integrated in the melting oven as part of the crucible, particularly preferably as part of the outlet of the crucible. This process for forming the quartz glass body is preferred if the silicon dioxide granulate is heated in a vertically aligned oven for melting which is suitable for a continuous process.

The forming of the quartz glass body can be performed by forming the glass melt in a mould, for example in a shaped crucible. Preferably, the glass melt is cooled in the mould and then subsequently removed from same. The cooling can preferably be performed by cooling the mould from outside. This process for forming the quartz glass body is preferred if the silicon dioxide is heated for melting by gas pressure sintering or by vacuum sintering.

Preferably, the glass product is cooled after the forming, so that it maintains its form. Preferably, the glass product is cooled after the forming to a temperature which is at least 1000° C. below the temperature of the first glass melt in the forming, for example at least 1500° C. or at least 1800° C., particularly preferably 1900 to 1950° C. Preferably, the glass product is cooled to a temperature of less than 500° C., for example of less than 200° C. or less than 100° C. or less than 50° C., particularly preferably to a temperature in the range from 20 to 30° C.

### Posttreatment of Glass Products

According to a preferred embodiment of the first aspect of the invention, the obtained glass product can be treated with at least one procedure selected from the group consisting of chemical, thermal or mechanical treatment.

Preferably, the glass product is chemically post treated. Post treatment relates to treatment of a glass product which has already been made. Chemical post treatment of the glass product means in principle any procedure which is known to the skilled person and appears suitable for employing materials for changing the chemical structure of the composition of the surface of the glass product, or both. Preferably, the chemical post treatment comprises at least one means selected from the group consisting of treatment with fluorine compounds and ultrasound cleaning.

Possible fluorine compounds are in particular hydrogen fluoride and fluorine containing acids, for example hydrofluoric acid. The liquid preferably has a content of fluorine compounds in a range from 35 to 55 wt.-%, preferably in a range from 35 to 45 wt.-%, the wt.-% in each case based on the total amount of liquid. The remainder up to 100 wt.-% is usually water. Preferably, the water is fully desalinated water or deionised water.

Ultrasound cleaning is preferably performed in a liquid bath, particularly preferably in the presence of detergents.

In the case of ultrasound cleaning, commonly no fluorine compounds, for example neither hydrofluoric acid nor hydrogen fluoride.

The ultrasound cleaning of the glass product is preferably carried out under at least one, for example at least two or at least three or at least four or at least five, particularly preferably all of the following conditions:
The ultrasound cleaning performed in a continuous process.
The equipment for the ultrasound cleaning has six chambers connected to each other by tubes.
The holding time for the glass products in each chamber can be set. Preferably, the holding time of the glass products in each chamber is the same. Preferably, the holding time in each chamber is in a range from 1 to 120 min, for example of less than 5 min or from 1 to 5 min or from 2 to 4 min or of less than 60 min or from 10 to 60 min or from 20 to 50 min, particularly preferably in a range from 5 to 60 min.
The first chamber comprises a basic medium, preferably containing water and a base, and an ultrasound cleaner.
The third chamber comprises an acidic medium, preferably containing water and an acid, and an ultrasound cleaner.
In the second chamber and in the fourth to sixth chamber, the glass product is cleaned with water, preferably with desalinated water.
The fourth to sixth chambers are operated with cascades of water. Preferably, the water is only introduced in the sixth chamber and funs from the sixth chamber into the fifth and from the fifth chamber into the fourth.

Preferably, the glass product is thermally post-treated. Thermal post-treatment of the glass product is understood to mean in principle a procedure known to a person skilled in the art and which appears suitable for changing the form or structure or both of the glass product by means of temperature. Preferably, the thermal post-treatment comprises at least one means selected from the group consisting of tempering, compressing, inflating, drawing, welding, and a combination of two or more thereof. Preferably, the thermal post-treatment is not performed for the purpose of removing material.

The tempering is preferably performed by heating the glass product in an oven, preferably at a temperature in a range from 900 to 1300° C., for example in a range from 900 to 1250° C. or from 1040 to 1300° C., particularly preferably in a range from 1000 to 1050° C. or from 1200 to 1300° C. Preferably, in the thermal treatment, a temperature of 1300° C. is not exceeded for a continuous period of more than 1 h, particularly preferably a temperature of 1300° C. is not exceeded during the entire duration of the thermal treatment. The tempering can in principle be performed at reduced pressure, at normal pressure or at increased pressure, preferably at reduced pressure, particularly preferably in a vacuum.

The compressing is preferably performed by heating the glass products, preferably to a temperature of about 2100° C., and subsequent forming during a rotating turning motion, preferably with a rotation speed of about 60 rpm. For example, a glass product in the form of a rod can be formed into a cylinder.

A glass product can preferably be drawn. The drawing is preferably performed by heating the glass product, preferably to a temperature of about 2100° C., and subsequently pulling with a controlled pulling speed to the desired outer diameter of the glass product.

Preferably, the glass product is mechanically post-treated. A mechanical post-treatment of the glass product means in principle any procedure known to a person skilled in the art and which appears suitable for using an abrasive means to change the shape of the glass product or to split the glass product into multiple pieces. In particular, the mechanical post-treatment comprises at least one means selected from the group consisting of grinding, drilling, honing, sawing, waterjet cutting, laser cutting, roughening by sandblasting, milling and a combination of two or more thereof.

Preferably, the glass product is treated with a combination of these procedures, for example with a combination of a chemical and a thermal post-treatment, or a chemical and a mechanical post-treatment, or a chemical and a mechanical post-treatment, particularly preferably with a combination of a chemical, a thermal and a mechanical posttreatment. Furthermore, preferably, the glass product can be subjected to several of the above mentioned procedures, each independently from the others.

The above described process according to the first aspect of the invention relates to the preparation of a glass product.

According to further preferred embodiments of the first aspect of the invention, the glass product can be prepared according to one of the processed named hereinafter.

### Preparing a First Glass Melt by IDD Processes

An “IDD process” is understood to mean a process in which a glass body is prepared in a continuous process. IDD stands for “die-drawn ingot”. For this, firstly a quartz glass melt is produced from a silicon dioxide-melt material in a fire-resistant container, the wall of which contains at least one nozzle. The quartz glass melt is held by heating at least one synthesis burner. The surface of the quartz glass melt is heated directly by the synthesis brenner. The silicon dioxide-melt material formed in the synthesis burner is thereby melted onto the surface of the quartz glass melt (step ii.). Quartz glass is drawn through the nozzle from the quartz glass melt and shaped to obtain a glass product (step iii.). This process is described in detail for example in EP 1097110 B 1.

Preferably, a silicon dioxide granulate is used in the IDD process, for example silicon dioxide granulate I or silicon dioxide granulate II, which is produced as described in the context of step i.) from siloxanes, for example from siloxanes selected from the group consisting of hexamethyldisiloxane, hexamethylcyclotrisiloxane (D3), octamethylcyclotetrasiloxane (D4) and decamethylcyclopentasiloxane (D5) or a combination of two or more thereof. The obtained glass product can, as described previously, be post-treated in one or more steps.

### Preparing a First Glass Melt by Horizontal Flame Melting Processes

Horizontal flame melting comprises the following steps:
Introducing the silicon dioxide granulate in a precipitation burner;
Precipitating silicon dioxide particles on a deposition surface of a carrier rotating about a central axis, and
vitrifying the deposited silicon dioxide particles to obtain a glass product.

This process is described in detail for example in DE 10058558 A1. The obtained glass product can, as described previously, be post-treated in one or more steps.

### Preparing a First Glass Melt by Plasma-Electric Arc Melting Processes

The plasma/electric arc melting process comprises the following steps:
Introducing the silicon dioxide granulate in a rotatable hollow mould;
Heating the silicon dioxide granulate in the rotating hollow mould to obtain a melt, with the result that the melt is pressed to the inner wall of the hollow mould due to centrifugal force (step ii.); and
Setting the melt in the mould while continuing the rotation to obtain a glass product (step iii.).

Heating can be performed preferably by a heating source arranged inside the hollow mould. Preferably, an electric arc or a plasma source is used as a heating source. The atmosphere in the hollow mould during heating, setting or both can be reducing, neutral or oxidising. This process is also described in detail in DE 543957. The obtained glass product can, as described previously, be post-treated in one or more steps.

### Preparing a First Glass Melt by Horizontal Cladding Tube Melting Processes

Cladding tube melting comprises the following steps:
Providing a cladding tube made of quartz glass with one closed end and one open end;
Introducing silicon dioxide granulate into the cladding tube;
continuous, vertical introduction of the filled cladding tube, starting with the closed end, with a controllable supply speed in a heating zone;
Softening in a softening zone (step ii.);
Drawing a glass product from the softening region with a controllable drawing speed (step iii.).

Preferably, low pressure is preferred inside the cladding tube, compared with the external pressure acting on the cladding tube from the outside, for example in a range from 1 to 1*10⁵ Pa. Preferably, inside the cladding tube is a helium-containing atmosphere. This process is also described in detail in EP 729918 B1. The obtained glass product can, as described previously, be post-treated in one or more steps.

Preferably, the glass product has at least one of the following features, for example at least two or at least three or at least four, particularly preferably at least five of the following features:
A] a transmission of more than 0.3, particularly preferably of more than 0.5;
B] a blistering in a range from 5 to 5000 based on 1 kg of the glass product;
C] a mean bubble size in a range from 0.5 to 10 mm, for example from 0.8 to 7 mm, particularly preferably from 1 to 5 mm;
D] a BET surface of less than 1 m²/g, for example of less than 0.5 m²/g, particularly preferably of less than 0.2 m²/g;
E] a density in a range from 2.1 to 2.3;
F] a carbon content of less than 5 ppm, for example of less than 4.5 ppm, or from less than 4 ppm, or in a range from 1 ppb to 3 ppm, particularly preferably in a range from 10 ppb to 2 ppm;
G] a total metal content of metals different to aluminium of less than 2000 ppb, for example of less than 1000 ppb, or of less than 500 ppb, particularly preferably of less than 100 ppb;
H] a cylindrical form;
I] an OH content of less than 500 ppm, for example of less than 400 ppm, particularly preferably of less than 300 ppm;
J] a chlorine content of less than 60 ppm, preferably of less than 40 ppm, for example of less than 40 ppm or less than 2 ppm or less than 0.5 ppm, particularly preferably of less than 0.1 ppm;
K] an aluminium content of less than 200 ppb, for example of less than 100 ppb, particularly preferably of less than 80 ppb;
L] an ODC content of less than 5·10¹⁵/cm³, for example in a range from 0.1·10¹⁵ to 3·10¹⁵/cm³, particularly preferably in a range from 0.5·10¹⁵ to 2.0·10¹⁵/cm³;
M] a viscosity (p=1013 hPa) in a range from log₁₀ (η (1250° C.)/dPas)=11.4 to log₁₀ (η (1250° C.)/dPas)=12.9 and/or log₁₀ (η (1300° C.)/dPas)=11.1 to log₁₀ (η (1300° C.)/dPas)=12.2 and/or log₁₀ (η (1350° C.)/dPas)=10.5 to log₁₀ (η (1350° C.)/dPas)=11.5;
N] a standard deviation of the OH content of not more than 10%, preferably not more than 5%, based on the OH content A] of the quartz glass body;
O] a standard deviation of the chlorine content of not more than 10%, preferably not more than 5%, based on the chlorine content B] of the quartz glass body;
P] a standard deviation of the aluminium content of not more than 10%, preferably not more than 5%, based on the aluminium content C] of the quartz glass body;
Q] a refractive index homogeneity of less than 10⁴;
R] a tungsten content of less than 1000 ppb, for example of less than 500 ppb or of less than 300 ppb or of less than 100 ppb or in a range from 1 to 500 ppb or from 1 to 300 ppb, particularly preferably in a range from 1 to 100 ppb;
S] a molybdenum content of less than 1000 ppb, for example of less than 500 ppb or of less than 300 ppb or of less than 100 ppb or in a range from 1 to 500 ppb or from 1 to 300 ppb, particularly preferably in a range from 1 to 100 ppb,
   wherein the ppb and ppm are each based on the total weight of the glass product.

Particularly preferably, the glass product has at least one of the following features, for example at least two or at least three or at least four, particularly preferably at least five of the following features:
A] a transmission of more than 0.3, particularly preferably of more than 0.5;
B] a blistering in a range from 5 to 5000 based on 1 kg of the glass product;
C] a mean bubble size in a range from 0.5 to 10 mm, for example from 0.8 to 7 mm, particularly preferably from 1 to 5 mm;
D] a BET surface of less than 1 m²/g, for example of less than 0.5 m²/g, particularly preferably of less than 0.2 m²/g;
E] a density in a range from 2.1 to 2.3;
F] a carbon content of less than 5 ppm, for example of less than 4.5 ppm, or of less than 4 ppm, or in a range from 1 ppb to 3 ppm, particularly preferably in a range from 10 ppb to 2 ppm;
G] a total metal content of metals different to aluminium of less than 2000 ppb, for example of less than 1000 ppb, or of less than 500 ppb, particularly preferably of less than 100 ppb; and
H] a cylindrical form;
wherein the ppb and ppm are each based on the total weight of the glass product.

Quite particularly preferably, the glass product has the following features:
A] a transmission of more than 0.3, particularly preferably of more than 0.5;
B] a blistering in a range from 5 to 5000 based on 1 kg of the glass product; and
C] a mean bubble size in a range from 0.5 to 10 mm, for example from 0.8 to 7 mm, particularly preferably from 1 to 5 mm.

The transmission describes the ratio of intensity of the emergent light to the intensity of the incident light (I/I₀). The indicated values describe the transmission at wavelengths in the range from 400 to 780 nm and with a sheet thickness of the material sample of 10 mm. A material with a transmission of at least 0.5 at wavelengths in the range from 400 to 780 nm and with a sheet thickness of the material sample of 10 mm is considered transparent.

Often however, the glass product has a content of metals different to aluminium of at least 1 ppb. Such metals are for example sodium, lithium, potassium, magnesium, calcium, strontium, germanium, copper, molybdenum, titanium, iron and chromium. These can for example be present as an element, as an ion, or as part of a molecule or of an ion or of a complex.

The glass product can comprise further constituents. Preferably, the glass product comprises less than 500 ppm, for example less than 450 ppm, particularly preferably less than 400 ppm of further constituents, the ppm in each case being base on the total weight of the glass product. Possible other constituents are for example carbon, fluorine, iodine, bromium and phosphorus. These can for example be present as an element, as an ion or as part of a molecule, an ion or a complex. Often however, the glass product has a content of further constituents of at least 1 ppb.

Preferably, the glass product comprises less than 5 ppm carbon, for example less than 4.5 ppm, particularly preferably less than 4 ppm, in each case based on the total weight of the glass product. Often however, the glass product has a carbon content of at least 1 ppb.

Preferably, the glass product has a homogeneously distributed OH content, Cl content or Al content. An indicator of the homogeneity of the glass product can be expressed as the standard deviation of OH content, Cl content or Al content. The standard deviation is the measure of the measure of the spread of the values of a variable from their arithmetic mean, here the OH content, chlorine content or aluminium content. For measuring the standard deviation, the content in the sample of the component in question e.g. OH, chlorine or aluminium, is measured in at least seven measuring locations.

The glass product preferably has the feature combination A]/B]/C] or A]/B]/D] or A]/B]/F], further preferred the feature combination A]/B]/C]/D] or A]/B]/C]/F] or A]/B]/D]/F], further preferably the feature combination A]/B]/C]/D]/F].

The glass product preferably has the feature combination A]/B]/C], wherein the OH content is less than 400 ppm, the chlorine content is less than 100 ppm and the aluminium content is less than 80 ppb.

The glass product preferably has the feature combination A]/B]/D], the OH content is less than 400 ppm, the chlorine content is less than 100 ppm and the ODC content is in a range from 0.1·10¹⁵ to 3·10¹⁵/cm³.

The glass product preferably has the feature combination A]/B]/F], wherein the OH content is less than 400 ppm, the chlorine content is less than 100 ppm and the viscosity (p=1013 hPa) is in a range from log₁₀ (η (1250° C.)/dPas)=11.4 to log₁₀ (η (1250° C.)/dPas)=12.9.

The glass product preferably has the feature combination A]/B]/C]/D], wherein the OH content is less than 400 ppm, the chlorine content is less than 100 ppm, the aluminium content is less than 80 ppb and the ODC content is in a range from 0.1·10¹⁵ to 3·10¹⁵/cm³.

The glass product preferably has the feature combination A]/B]/C]/F], wherein the OH content is less than 400 ppm, the chlorine content is less than 100 ppm, the aluminium content is less than 80 ppb and the viscosity (p=1013 hPa) is in a range from log₁₀ (η (1250° C.)/dPas)=11.4 to log₁₀ (η (1250° C.)/dPas)=12.9.

The glass product preferably has the feature combination A]/B]/D]/F], wherein the OH content is less than 400 ppm, the chlorine content is less than 100 ppm, the ODC content is in a range from 0.1·10¹⁵ to 3·10¹⁵/cm³ and the viscosity (p=1013 hPa) is in a range from log₁₀ (η (1250° C.)/dPas)=11.4 to log₁₀ (η (1250° C.)/dPas)=12.9.

The glass product preferably has the feature combination A]/B]/C]/D]/F], wherein the OH content is less than 400 ppm, the chlorine content is less than 100 ppm, the aluminium content is less than 80 ppb and the ODC content is in a range from 0.1·10¹⁵ to 3·10¹⁵/cm³ and the viscosity (p=1013 hPa) is in a range from log₁₀ (η (1250° C.)/dPas)=11.4 to log₁₀ (η (1250° C.)/dPas)=12.9.

### Step iv.)

According to the invention, as step iv.), the process comprises the reduction in size of the glass product from step iii.). A quartz glass grain is obtained. Reducing the size of the glass product can in principle take place in all ways which are known to a person skilled in the art and suitable for this purpose. Preferably, the glass product is mechanically or electromechanically reduced in size.

Particularly preferably, the glass product is electromechanically reduced in size. Preferably, the electromechanical reduction in size takes place using high voltage discharge pulses, for example using an electric arc.

Preferably, the glass product is reduced to particles with a particle size D₅₀ in a range from 50 μm to 5 mm. It is preferred to reduce the glass product to a quartz glass grain with a particle size D₅₀ in a range from 50 μm to 500 μm, for example in a range from 75 to 350 μm, particularly preferably in a range from 100 to 250 μm. It is additionally preferred to reduce the glass product to a quartz glass grain with a particle size D₅₀ in a range from 500 μm to 5 mm, for example in a range from 750 μm to 3.5 mm, particularly preferably in a range from 1 to 2.5 mm.

In the context of a further embodiment it is possible that the glass product is firstly electromechanically, and then mechanically, further reduced in size. Preferably, the electromechanical reduction in size takes place as described previously. Preferably, the glass product is reduced in size electromechanically to particles with a particle size D₅₀ of at least 2 mm, for example in a range from 2 to 50 mm or from 2.5 to 20 mm, particularly preferably in a range from 3 to 5 mm.

Preferably, the mechanical reduction in size takes place by pressure crushing, impact crushing, shearing or friction, preferably using crushers or grinders, for example using jaw crushers, rolling crushers, conical crushers, impact crushers, hammer crushers, shredders or ball mills, particularly preferably using jaw crushers or rolling crushers.

Preferably the quartz glass grain obtained after mechanical reduction in size has a particle size D₅₀ in a range from 50 μm to 5 mm.

Preferably, a quartz glass grain, the preparation of which comprises a mechanical reduction in size, is purified in a further processing step. Preferred purification measures are flotation steps, magnetic separation, acidification, preferably with HF, hot chlorination with HCl, Cl₂ or a combination thereof.

Preferably, the fines of the quartz glass grain are removed. The fines are removed for example by screening or sieving or a combination thereof. Quartz glass grain with a core size of less than 10 μm, for example less than 20 μm or of less than 30 μm, particularly preferably less than 50 μm, are removed as fines.

Preferably, the quartz glass grain has at least one of the following features, for example at least two or at least three or at least four, particularly preferably at least five of the following features:
I/ an OH content of less than 500 ppm, for example of less than 400 ppm, particularly preferably of less than 300 ppm;
II/ a chlorine content of less than 60 ppm, preferably of less than 40 ppm, for example of less than 40 ppm or less than 2 ppm or less than 0.5 ppm, particularly preferably of less than 0.1 ppm;
III/ an aluminium content of less than 200 ppb, for example of less than 100 ppb, particularly preferably of less than 50 ppb;
IV/ a BET surface area of less than 1 m²/g, for example of less than 0.5 m²/g, particularly preferably of less than 0.2 m²/g;
V/ a bulk density in a range from 1.1 to 1.4 g/cm³, for example in a range from 1.15 to 1.35 g/cm³, particularly preferably in a range from 1.2 to 1.3 g/cm³;
VI/ a particle size D₅₀ for melting in a range from 50 to 5000 μm, for example in a range from 100 to 3000 μm or from 250 to 2000 μm, particularly preferably in a range from 500 to 1000 μm;
VII/ a particle size D₅₀ for the slurry in a range from 0.5 to 5 mm, for example in a range from 0.8 to 3 mm, or from 1 to 4.2 mm;
VIII/ a metal content of metals which are different to aluminium, of less than 2000 ppb, for example of less than 500 ppb, particularly preferably of less than 100 ppb;
IX/ viscosity (p=1013 hPa) in a range from log₁₀ (η (1250° C.)/dPas)=11.4 to log₁₀ (η (1250° C.)/dPas)=12.9 and/or log₁₀ (η (1300° C.)/dPas)=11.1 to log₁₀ (η (1300° C.)/dPas)=12.2 and/or log₁₀ (η (1350° C.)/dPas)=10.5 to log₁₀ (η (1350° C.)/dPas)=11.5;
wherein the ppb and ppm are each based on the total weight of the quartz glass grain.

Preferably, the quartz glass grain has a metal content of metals different to aluminium of less than 1000 ppb, for example of less than 500 ppb, particularly preferably of less than 100 ppb, in each case based on the total weight of the quartz glass grain. Often however, the quartz glass grain has a content of metals different to aluminium of at least 1 ppb. Such metals are for example sodium, lithium, potassium, magnesium, calcium, strontium, germanium, copper, molybdenum, titanium, iron and chromium. These can for example be present as an element, as an ion, as part of a molecule or of an ion or of a complex.

The quartz glass grain can comprise further constituents. Preferably, the quartz glass grain comprises less than 500 ppm, for example less than 450 ppm, particularly preferably less than 400 ppm of further constituents, wherein the ppm are each based on the total weight of the quartz glass grain. Often however, the quartz glass grain has a carbon content of at least 1 ppb.

Preferably, the quartz glass grain comprises carbon in a quantity of less than 5 ppm, for example less than 4 ppm or less than 3 ppm, particularly preferably less than 2 ppm, in each case based on the total weight of the quartz glass grain. Often however, the quartz glass grain has a carbon content of at least 1 ppb.

The quartz glass grain preferably has the feature combination I//II/III/ or I//II/IV/ or I//II//IV/, further preferred the feature combination I//II//III//IV/ or I//II//III//V/ or I//II//IV//V/, further preferably the feature combination I//II//III//IV//V/.

The quartz glass grain preferably has the feature combination I//II//III/, wherein the OH content is less than 400 ppm, the chlorine content is less than 40 ppm and the aluminium content is less than 200 ppb.

The quartz glass grain preferably has the feature combination I//II//IV/, the OH content is less than 400 ppm, the chlorine content is less than 40 ppm and the BET surface area is less than 0.5 m²/g.

The quartz glass grain preferably has the feature combination I//II//V/, wherein the OH content is less than 400 ppm, the chlorine content is less than 40 ppm and the bulk density is in a range from 1.15 to 1.35 g/cm³.

The quartz glass grain preferably has the feature combination I//II//III//IV/, wherein the OH content is less than 400 ppm, the chlorine content is less than 40 ppm, the aluminium content is less than 50 ppb and the BET surface area is less than 0.5 m²/g.

The quartz glass grain preferably has the feature combination I//II//III//V/, wherein the OH content is less than 400 ppm, the chlorine content is less than 40 ppm, the aluminium content is less than 50 ppb and the bulk density is in a range from 1.15 to 1.35 g/cm³.

The quartz glass grain preferably has the feature combination I//II//IV//V/, wherein the OH content is less than 400 ppm, the chlorine content is less than 40 ppm, the BET surface area is less than 0.5 m²/g and the bulk density is in a range from 1.15 to 1.35 g/cm³.

The quartz glass grain preferably has the feature combination I//II//III/IV//V/, wherein the OH content is less than 400 ppm, the chlorine content is less than 40 ppm, the aluminium content is less than 50 ppb, the BET surface area is less than 0.5 m²/g and the bulk density is in a range from 1.15 to 1.35 g/cm³.

### Step v.)

According to the invention, the process contains, as step v.), the formation of a further glass melt from the quartz glass grain. Conventionally, the quartz glass grain is heated until a further glass melt is obtained. The heating of the quartz glass grain to obtain a further glass melt can in principle be performed in all ways known for this purpose to a person skilled in the art.

Preferably, the further glass melt is formed according to one of the processes named for forming the first glass melt (step ii.)). As a substantial difference from step ii.), in step iv.) the quartz glass grain formed in step iii.) is melted by heating instead of the silicon dioxide granulate from step ii.).

The preferred embodiments described in the context of step ii.) are also preferred for carrying out step v.).

According to a preferred embodiment of the first aspect of the invention, step v.) is carried out in a melting crucible which has an inlet and an outlet, wherein the inlet is arranged above the outlet. Particularly preferably, the melting of the quartz glass grain in step v.) is performed under the conditions for preparing a glass melt in a crucible drawing process described in the context of step ii.), wherein the quartz glass grain formed in step iii.) is supplied to the melting crucible instead of the silicon dioxide granulate from step ii.).

According to a preferred embodiment of the first aspect of the invention, the melt energy in step v.) is transferred to the quartz glass grain via a solid surface. Preferably, the transfer of melt energy is performed as described in the context of step ii.). The embodiments preferred in this context are also preferred at this point for carrying out step v.).

### Step vi.)

According to the invention, the process contains, as step vi.), the formation of the quartz glass body from the further glass melt.

Preferably, the quartz glass body is formed an analogous manner to the formation of the glass product (step iii.)). The difference from step iii.) is the use of the further glass melt formed in step v.) instead of the first glass melt.

The preferred embodiments described in the context of step iii.) are also preferred for carrying out step vi.).

The glass bodies obtainable according to the first aspect of the invention can in principle take on any shape. For example, quartz glass bodies can be produced in solid form, such as cylinders, sheets, plates, cuboids, spheres or in the form of hollow bodies, e.g. hollow bodies with an opening, hollow bodies with two openings such as tubes and flanges, or with more than two openings.

The quartz glass body can for example be shaped by correspondingly shaped nozzles on the outlet of the oven when removing the glass melt. Preferred forms and embodiments are described in the context of step iii.). These preferred shapes and embodiments are also preferred in the context of step vi.).

The shaping can be achieved by thermal post-treatment. Thermal post treatment of the quartz glass body means in principle a procedure known to the skilled person and which appears suitable for changing the form or structure or both of the quartz glass body by means of temperature. Preferably, the thermal post treatment comprises at least a one means selected from the group consisting of tempering, compressing, inflating, drawing, welding, and a combination of two or more thereof. Preferably, the thermal post treatment is not performed for the purpose of removing material.

The tempering is preferably performed by heating the quartz glass body in an oven, preferably at a temperature in a range from 900 to 1300° C., for example in a range from 900 to 1250° C. or from 1040 to 1300° C., particularly preferably in a range from 1000 to 1050° C. or from 1200 to 1300° C. Preferably, in the thermal treatment, a temperature of 1300° C. is not exceeded for continuous period of more than 1 h, particularly preferably a temperature of 1300° C. is not exceeded during the entire duration of the thermal treatment. The tempering can in principle be performed at reduced pressure, at normal pressure or at increased pressure, preferably at reduced pressure, particularly preferably in a vacuum.

The compressing is preferably performed by heating the quartz glass body, preferably to a temperature of about 2100° C., and subsequent forming during a rotating turning motion, preferably with a rotation speed of about 60 rpm. For example, a quartz glass body in the form of a rod can be formed into a cylinder.

Preferably, a quartz glass body can be inflated by injecting a gas into the quartz glass body. For example, a quartz glass body can by formed into a large-diameter tube by inflating. For this, preferably the quartz glass body is heated to a temperature of about 2100° C., whilst a rotating turning motion is performed, preferably with a rotation speed of about 60 rpm, and the interior is flushed with a gas, preferably at a defined and controlled inner pressure of up to about 100 mbar. A large-diameter tube means a tube with an outer diameter of at least 500 mm.

A quartz glass body can preferably be drawn. The drawing is preferably performed by heating the quartz glass body, preferably to a temperature of about 2100° C., and subsequently pulling with a controlled pulling speed to the desired outer diameter of the quartz glass body. For example lamp tubes can be formed from quartz glass bodies by drawing.

Shaping can be performed by mechanical post-treatment. A mechanical post-treatment of the quartz glass body is understood to mean in principle any procedure known to a person skilled in the art and which appears suitable for using an abrasive means to change the shape of the quartz glass body or to split the quartz glass body into multiple pieces. In particular, the mechanical post-treatment comprises at least one means selected from the group consisting of grinding, drilling, honing, sawing, waterjet cutting, laser cutting, roughening by sandblasting, milling and a combination of two or more thereof.

Preferably, the quartz glass body is subjected to a combination of a thermal and a mechanical post-treatment. Furthermore, preferably, the quartz glass body can be subjected to several of the above mentioned procedures, each independently from the others.

The quarz glass product is produced by melting a silicon dioxide granulate to obtain a first glass melt according to step ii.) and subsequent forming of the glass product according to step iii.). Steps ii.) and iii.) can each be carried out in different ways. In principle, all combinations of the preferred embodiments of steps ii.) and iii.) are possible to obtain the glass product. Preferably, the glass product is formed by crucible drawing processes, GDS (gas pressure sintering) processes or IDD (die drawn ingot) processes, particularly preferably by crucible drawing processes.

The quartz glass body is produced by melting the quartz glass grain to obtain a further glass melt according to step v.) and subsequent forming of the quartz glass body according to step vi.). Steps v.) and vi.) can each be carried out in different ways. In principle, all combinations of the preferred embodiments of steps v.) and vi.) are possible to obtain the glass product. Preferably, the glass product is formed by crucible drawing processes, GDS processes or IDD processes, particularly preferably by crucible drawing processes.

For example, the glass product in step iii.) is formed by crucible drawing processes and the quartz glass body in step vi.) is formed by GDS processes.

For example, the glass product in step iii.) is formed by crucible drawing processes and the quartz glass body in step vi.) is formed by IDD processes.

For example, the glass product in step iii.) is formed by GDS processes and the quartz glass body in step vi.) is formed by crucible drawing processes.

For example, the glass product in step iii.) is formed by GDS processes and the quartz glass body in step vi.) is formed by IDD processes.

For example, the glass product in step iii.) is formed by IDD processes and the quartz glass body in step vi.) is formed by crucible drawing processes.

For example, the glass product in step iii.) is formed by IDD processes and the quartz glass body in step vi.) is formed by GDS processes.

According to a preferred embodiment of the first aspect of the invention, the glass product in step iii.), the quartz glass body in step vi.) or both are formed by crucible drawing processes.

Preferably, the glass product in step iii.) and the quartz glass body in step vi.) are formed by crucible drawing processes, or the glass product in step iii.) and the quartz glass body in step vi.) are formed by GDS processes, or the glass product in step iii.) and the quartz glass body in step vi.) are formed by IDD processes. According to a particularly preferred embodiment of the first aspect of the invention, the glass product in step iii.) and the quartz glass body in step vi.) are formed by crucible drawing processes.

According to a preferred embodiment of the first aspect of the invention, the melt energy in at least one of steps ii.) and v.) is transferred to the melt material via a solid surface. Particularly preferably, the melt energy of steps ii.)

and v.) is transferred to the melt material via a solid surface.

Preferably, the quartz glass body has the following features:
[A] a transmission of more than 0.5, for example more than 0.6 or more than 0.7, particularly preferably more than 0.9; and
[B] a blistering in a range from 0.5 to 500 based on 1 kg of the quartz glass body.

Preferably, the quartz glass body also has at least one, for example at least two or at least three or at least four, particularly preferably at least five of the following features:
[C] a mean bubble size in a range from 0.05 to 1 mm, particularly preferably of 0.1 to 0.5 mm;
[D] a BET surface of less than 1 m²/g, for example of less than 0.5 m²/g, particularly preferably of less than 0.2 m²/g;
[E] a density in a range from 2.1 to 2.3 g/cm³, particularly preferably in a range from 2.18 to 2.22 g/cm³;
[F] a carbon content of less than 5 ppm, for example of less than 3 ppm, particularly preferably of less than 2 ppm;
[G] a total metal content of metals different to aluminium of less than 2000 ppb, for example of less than 500 ppb, particularly preferably of less than 100 ppb;
[H] a cylindrical form;
[I] a sheet;
[J] an OH content of less than 500 ppm, for example of less than 400 ppm, particularly preferably of less than 300 ppm;
[K] a chlorine content of less than 60 ppm, preferably of less than 40 ppm, for example of less than 20 ppm or less than 2 ppm or less than 0.5 ppm, particularly preferably of less than 0.1 ppm;
[L] an aluminium content of less than 200 ppb, for example of less than 150 ppb, particularly preferably of less than 100 ppb;
[M] an ODC content of less than 5*10¹⁸/cm³;
wherein the ppm and ppb are each based on the total weight of the quartz glass body.

A sheet is understood to mean a planar extent of a material on a substrate.

Preferably, the quartz glass body has a metal content of metals different to aluminium of less than 1000 ppb, for example of less than 500 ppb, particularly preferably of less than 100 ppb, in each case based on the total weight of the quartz glass body. Often however, the quartz glass body has a content of metals different to aluminium of at least 1 ppb. Such metals are for example sodium, lithium, potassium, magnesium, calcium, strontium, germanium, copper, molybdenum, titanium, iron and chromium. This can for example be present as an element, as an ion, or as part of a molecule or of an ion or of a complex.

The quartz glass body can comprise further constituents. Preferably, the quartz glass body comprises less than 500 ppm, for example less than 450 ppm, particularly preferably less than 400 ppm of further constituents, the ppm in each case being base on the total weight of the quartz glass body. Often however, the quartz glass body has a content of further constituents of at least 1 ppb.

Preferably, the quartz glass body comprises less than 5 ppm carbon, for example less than 4 ppm, or less than 3 ppm, particularly preferably less than 2 ppm, in each case based on the total weight of the quartz glass body. Often however, the quartz glass body has a carbon content of at least 1 ppb.

Preferably, the blistering of the quartz glass body is less, by a factor of at least 10, for example of at least 25 or of at least 50, particularly preferably of at least 100, than the blistering of the glass product.

Preferably, the mean bubble size of the bubbles contained in the quartz glass body is less, by a factor of at least 10, for example of at least 25 or of at least 50, particularly preferably of at least 100, than the mean bubble size of the bubbles contained in the glass product.

The quartz glass body preferably has the feature combination [I]/[II]/[VI] or [I]/[II]/[VIII] or [I]/[MIX], further preferred the feature combination [I]/[II]/[VI]/[VIII] or [I]/[II]/[VI]/[IX] or [I]/[II]/[VIII]/[IX], further preferably the feature combination [I]/[II]/[VI]/[VIII]/[IX].

The quartz glass body preferably has the feature combination [I]/[II]/[VI], wherein the opacity is more than 20, the BET surface area is less than 0.2 in²/g and the chlorine content is less than 20 ppm.

The quartz glass body preferably has the feature combination [I]/[II]/[VIII], wherein the opacity is more than 20, the BET surface area is less than 0.2 m²/g and the ODC content is less than 5*10¹⁸/cm³.

The quartz glass body preferably has the feature combination [I]/[II]/[IX], wherein the opacity is more than 20, the BET surface area is less than 0.2 m²/g and the carbon content is less than 3 ppm.

The quartz glass body preferably has the feature combination [I]/[II]/[VI]/[VIII], wherein the opacity is more than 20, the BET surface area is less than 0.2 m²/g, the chlorine content is less than 20 ppm and the ODC content is less than 5*10¹⁸/cm³.

The quartz glass body preferably has the feature combination [I]/[II]/[VI]/[IX], wherein the opacity is more than 20, the BET surface area is less than 0.2 m²/g the chlorine content is less than 20 ppm and the carbon content is less than 3 ppm.

The quartz glass body preferably has the feature combination [I]/[II]/[VIII]/[IX], wherein the opacity is more than 20, the BET surface area is less than 0.2 m²/g, the ODC content is less than 5*10¹⁸/cm³ and the carbon content is less than 3 ppm.

The quartz glass body preferably has the feature combination [I]/[II]/[VI]/[VIII]/[IX], wherein the opacity is more than 20, the BET surface area is less than 0.2 m²/g the chlorine content is less than 20 ppm, the ODC content is less than 5*10¹⁸/cm³ and the carbon content is less than 3 ppm.

A second aspect of the present invention is a quartz glass body obtainable by a process according to the first aspect of the invention.

The process is preferably characterized by the features described in the context of the first aspect. The quartz glass body is preferably characterised by the features described in the context of the first aspect.

A third aspect of the present invention is a process for preparing a light duct containing the following steps:
A/ Providing a quartz glass body according to the second aspect of the invention or obtainable according to a process according to the first aspect of the invention, wherein the quartz glass body is first processed to obtain a hollow body with at least one opening;
B/ Introducing one or more core rods into the hollow body from step A/ through the at least one opening to obtain a precursor;
C/ Drawing the precursor in the heat to obtain a light duct with one or more cores and a jacket M1.

### Step A/

The quartz glass body provided in step A/ is a hollow body with at least one opening. The quartz glass body provided in step A/ is preferably characterised by the features according to the second aspect of the invention. The quartz glass body provided in step A/ is preferably obtainable by a process according to the first aspect of the invention containing the formation of a hollow body with at least one opening from the quartz glass body.

The hollow body which is made, has an interior and an exterior form. Interior form is understood to mean the form of the inner edge of the cross section of the hollow body. The interior and exterior form of the cross section of the hollow body can be the same or different. The interior and exterior form of the hollow body of the cross section can be round, elliptical or polygonal with three or more corners, for example 4, 5, 6, 7 or 8 corners.

Preferably, the exterior form of the cross section corresponds to the interior form of the hollow body. Particularly preferably, the hollow body has in cross section a round interior and a round exterior form.

In another embodiment, the hollow body can differ in the interior and exterior form. Preferably, the hollow body has in cross section a round exterior form and a polygonal interior form. Particularly preferably, the hollow body in cross section has a round exterior form and a hexagonal interior form.

Preferably, the hollow body has a length in the range from 100 to 10000 mm, for example from 1000 to 4000 mm, particularly preferably from 1200 to 2000 mm.

Preferably, the hollow body has a wall thickness in a range from 0.8 to 50 mm, for example in a range from 1 to 40 mm or from 2 to 30 mm or from 3 to 20 mm, particularly preferably in a range from 4 to 10 mm.

Preferably, the hollow body has an outer diameter of 2.6 to 400 mm, for example in a range from 3.5 to 450 mm, particularly preferably in a range from 5 to 300 mm.

Preferably, the hollow body has an inner diameter of 1 to 300 mm, for example in a range from 5 to 280 mm or from 10 to 200 mm, particularly preferably in a range from 20 to 100 mm.

The hollow body comprises one or more openings. Preferably, the hollow body comprises one opening. Preferably, the hollow body has an even number of openings, for example 2, 4, 6, 8, 10, 12, 14, 16, 18 or 20 openings. Preferably, the hollow body comprises two openings. Preferably, the hollow body is a tube. This form of the hollow body is particularly preferred if the light duct comprises only one core. The hollow body can comprise more than two openings. The openings are preferably located in pairs situated opposite each other at the ends of the quartz glass body. For example, each end of the quartz glass body can have 2, 3, 4, 5, 6, 7 or more than 7 openings, particularly preferably 5, 6 or 7 openings. Preferred forms are for example tubes, twin tubes, i.e. tubes with two parallel channels, and multi-channel tubes, i.e. tubes with more than two parallel channels.

The hollow body can in principle be formed by any method known to a person skilled in the art. Preferably, the hollow body is formed by means of a nozzle. Preferably, the nozzle comprises in the middle of its opening a device which deviates the glass melt in the forming. In this way, a hollow body can be formed from a glass melt.

A hollow body can be made by using a nozzle and subsequent post-treatment. Suitable post-treatments are in principle all process known to a person skilled in the art for making a hollow body out of a solid body, for example compressing channels, drilling, honing or grinding. Preferably, a suitable post-treatment is to send the solid body over one or more mandrels, whereby a hollow body is formed. Also, the mandrel can be introduced into the solid body to make a hollow body. Preferably, the hollow body is cooled after the forming.

Preferably, the hollow body is cooled to a temperature of less than 500° C. after the forming, for example less than 200° C. or less than 100° C. or less than 50° C., particularly preferably to a temperature in the range from 20 to 30° C.

### Step B/

One or more core rods are introduced through the at least one opening of the quartz glass body (step B/). A core rod in the context of the present invention means an object which is designed to be introduced into a jacket, for example a jacket M1, and processed to obtain a light duct. The core rod has a core of quartz glass. Preferably, the core rod comprises a core of quartz glass and jacket layer M0 which surrounds the core.

Each core rod has a form which is selected such that it fits into the quartz glass body. Preferably, the exterior form of the core rod corresponds to the form of the opening of the quartz glass body. Particularly preferably, the quartz glass body is a tube and the core rod is a rod with a round cross section.

The diameter of the core rod is smaller than the inner diameter of the hollow body. Preferably, the diameter of the core rod is 0.1 to 3 mm smaller than the inner diameter of the hollow body, for example 0.3 to 2.5 mm smaller or 0.5 to 2 mm smaller or 0.7 to 1.5 mm smaller, particularly preferably 0.8 to 1.2 mm smaller.

Preferably, the ratio of the inner diameter of the quartz glass body to the diameter of the core rod is in the range from 2:1 to 1.0001:1, for example in the range from 1.8:1 to 1.01:1 or in the range from 1.6:1 to 1.005:1 or in the range from 1.4:1 to 1.01:1, particularly preferably in the range from 1.2:1 to 1.05:1.

Preferably, a region inside the quartz glass body which is not filled by the core rod can be filled with at least one further component, for example with a silicon dioxide powder or with a silicon dioxide granulate.

It is also possible for a quartz glass body to have introduced into it a core rod which is already present in at least one further quartz glass body. The further quartz glass body has an outer diameter which is smaller than the inner diameter of the quartz glass body. The core rod which is introduced into the quartz glass body can also be present in two or more further quartz glass bodies, for example in 3 or 4 or 5 or 6 or more further quartz glass bodies.

A quartz glass body with one or more core rods obtainable in this way will be referred to in the following as “precursor”.

### Step C/

The precursor is drawn in the heat (step C/). The obtained product is a light duct with one or more cores and at least one jacket M1.

Preferably, the drawing of the precursor is performed with a speed in the range from 1 to 100 m/h, for example with a speed in the range from 2 to 50 m/h or from 3 to 30 m/h. Particularly preferably, the drawing of the quartz glass body is performed with a speed in the range from 5 to 25 m/h.

Preferably, the drawing is performed in the heat at a temperature of up to 2500° C., for example at a temperature in the range from 1700 to 2400° C., particularly preferably at a temperature in the range from 2100 to 2300° C.

Preferably, the precursor is guided through an oven which heats the precursor from the outside.

Preferably, the precursor is stretched until the desired thickness of the light duct is achieved. Preferably, the precursor is stretched to 1,000 to 6,000,000 times the length, for example to 10,000 to 500,000 times the length or to 30,000 to 200,000 times the length, in each case based on the length of the quartz glass body provided in step A/. Particularly preferably, the precursor is stretched to 100,000 to 10,000,000 times the length, for example to 150,000 to 5,800,000 times the length or to 160,000 to 640,000 times the length or to 1,440,000 to 5,760,000 times the length or to 1,440,000 to 2,560,000 times the length, in each case based on the length of the quartz glass body provided in step A/.

Preferably, the diameter of the precursor is reduced by the stretching by a factor in a range from 100 to 3,500, for example in a range from 300 to 3,000 or from 400 to 800 or from 1,200 to 2,400 or from 1,200 to 1,600, in each case based on the diameter of the quartz glass body provided in step A/.

The light duct, also referred to as light wave guide, can comprise any material which is suitable for conducting or guiding electromagnetic radiation, in particular light.

Conducting or guiding radiation means propagating the radiation over the longitudinal extension of the light duct without significant obstruction or attenuation of the intensity of the radiation. For this, the radiation is coupled into the duct via one end of the light duct. Preferably, the light duct conducts elekctromagnetic radiation in a wavelength range from 170 to 5000 nm. Preferably, the attenuation of the radiation by the light duct in the wavelength range in question is in a range from 0.1 to 10 dB/km. Preferably, the light duct has a transfer rate of up to 50 Tbit/s.

The light duct preferably has a curl parameter of more than 6 m. The curl parameter in the context of the invention is understood to mean the bending radius of a fibre, e.g. of a light duct or of a jacket M1, which is present as a freely moving fibre free from external forces.

The light duct is preferably made to be pliable. Pliable in the context of the invention means that the light duct is characterised by a bending radius of 20 mm or less, for example of 10 mm or less, particularly preferably less than 5 mm or less. A bending radius means the smallest radius which can be formed without fracturing the light duct and without impairing the ability of the light duct to conduct radiation. An impairment is present where there is attenuation of more than 0.1 dB of light guided through a bend in the light duct. The attenuation is preferably applied at a reference wavelength of 1550 nm.

Preferably, the quartz is composed of silicon dioxide with less than 1 wt.-% of other substances, for example with less than 0.5 wt.-% of other substances, particularly preferably with less than 0.3 wt.-% of other substances, in each case based on the total weight of the quartz. Furthermore, preferably, the quartz comprises at least 99 wt.-% silicon dioxide, based on the total weight of the quartz.

The light duct preferably has an elongate form. The form of the light duct is defined by its longitudinal extension L and its cross section Q. The light duct preferably has a round outer wall along its longitudinal extension L. A cross section Q of the light duct is always determined in a plane which is perpendicular to the outer wall of the light duct. If the light duct is curved in the longitudinal extension L, then the cross section Q is determined perpendicular to the tangent at a point on the outer wall of the light duct. The light duct preferably has a diameter & in a range from 0.04 to 1.5 mm. The light duct preferably has a length in a range from 1 m to 100 km.

According to the invention, the light duct comprises one or more cores, for example one core or two cores or three cores or four cores or five cores or six cores or seven cores or more than seven cores, particularly preferably one core. Preferably, more than 90%, for example more than 95%, particularly preferably more than 98%, of the electromagnetic radiation which is conducted through the light duct is conducted in the cores. For the transport of light in the cores, the preferred wavelength ranges apply, as already given for the light duct. Preferably, the material of the core is selected from the group consisting of glass or quartz glass, or a combination of both, particularly preferably quartz glass. The cores can, independently of each other, be made of the same material or of different materials. Preferably, all of the cores are made of the same material, particularly preferably of quartz glass.

Each core has a, preferably round, cross section Q_{K} and has an elongate form with length L_{K}. The cross section Q_{K} of a core is independent from the cross section Q_{K} of each other core. The cross section Q_{K} of the cores can be the same or different. Preferably, the cross sections Q_{K} of all the cores are the same. A cross section Q_{K} of a core is always determined in a plane which is perpendicular to the outer wall of the core or the outer wall of the light duct. If the core is curved in longitudinal extension, then the cross section Q_{K} will be perpendicular to the tangent at a point on the outer wall of the core. The length L_{K} of a core is independent of the length L_{K} of each other core. The lengths L_{K} of the cores can be the same or different. Preferably, the lengths L_{K} of all the cores are the same. Each core preferably has a length L_{K} in a range from 1 m to 100 km. Each core has a diameter d_{K}. The diameter d_{K} of a core is independent of the diameter d_{K} of each other core. The diameters d_{K} of the cores can be the same or different. Preferably, the diameters d_{K} of all the cores are the same. Preferably, the diameter d_{K} of each core is in a range from 0.1 to 1000 μm, for example from 0.2 to 100 μm or from 0.5 to 50 μm, particularly preferably from 1 to 30 μm.

Each core has at least one distribution of refractive index perpendicular to the maximum extension of the core. “Distribution of refractive index” means the refractive index is constant or changes in a direction perpendicular to the maximum extension of the core. The preferred distribution of refractive index corresponds to a concentric distribution of refractive index, for example to a concentric profile of refractive index in which a first region with the maximum refractive index is present in the centre of the core and which is surrounded by a further region with a lower refractive index. Preferably, each core has only one refractive index distribution over its length L_{K}. The distribution of refractive index of a core is independent of the distribution of refractive index in each other core. The distributions of refractive index of the cores can be the same or different. Preferably, the distributions of refractive index of all the cores are the same. In principle, it is also possible for a core to have multiple different distributions of refractive index.

Each distribution of refractive index perpendicular to the maximum extension of the core has a maximum refractive index n_{K}. Each distribution of refractive index perpendicular to the maximum extension of the core can also have further lower refractive indices. The lowest refractive index of the distribution of refractive index is preferably not more than 0.5 smaller than the maximum refractive index n_{K} of the distribution of refractive index. The lowest refractive index of the distribution of refractive index is preferably 0.0001 to 0.15, for example 0.0002 to 0.1, particularly preferably 0.0003 to 0.05, less than the maximum refractive index n_{K} of the distribution of refractive index.

Preferably, the core has a refractive index n_{K} in a range from 1.40 to 1.60, for example in a range from 1.41 to 1.59, particularly preferably in a range from 1.42 to 1.58, in each case measured at a reference wavelength of X, =589 nm (sodium D-line), at a temperature of 20° C. and at normal pressure (p=1013 hPa). For further details in this regard, see the test methods section. The refractive index n_{K} of a core is independent of the refractive index n_{K} of each other core. The refractive indices n_{K} of the cores can be the same or different. Preferably, the refractive indices n_{K} of all the cores are the same.

Preferably, each core of the light duct has a density in a range from 1.9 to 2.5 g/cm³, for example in a range from 2.0 to 2.4 g/cm³, particularly preferably in a range from 2.1 to 2.3 g/cm³. Preferably, the cores have a residual moisture content of less than 100 ppb, for example of less than 20 ppb or of less than 5 ppb, particularly preferably of less than 1 ppb, in each case based on the total weight of the core. The density of a core is independent of the density of each other core. The densities of the cores can be the same or different. Preferably, the densities of all cores are the same.

If a light duct comprises more than one core, then each core is, independently of the other cores, characterised by the above features. It is preferred for all cores to have the same features.

According to the invention, the cores are surrounded by at least one jacket M1. The jacket M1 preferably surrounds the cores over the entire length of the cores. Preferably, the jacket M1 surrounds the cores for at least 95%, for example at least 98% or at least 99%, particularly preferably 100% of the exterior surface, that is to say the entire outer wall, of the cores. Often, the cores are entirely surrounded by the jacket M1 up until the ends (in each case the last 1-5 cm). This serves to protect the cores from mechanical impairment.

The jacket M1 can comprise any material, including silicon dioxide, which has a lower refractive index than at least on point P along the profile of the cross section Q_{K} of the core. Preferably, this at least one point in the profile of the cross section Q_{K} of the core is the point which lies at the centre of the core. Furthermore, preferably, the point P in the profile of the cross section of the core is the point which has a maximum refractive index n_{Kmax} in the core. Preferably, the jacket M1 has a refractive index u_{M1} which is at least 0.0001 lower than the refractive index of the core n_{K} at the at least one point in the profile of the cross section Q of the core. Preferably, the jacket M1 has a refractive index u_{M1} which is lower than the refractive index of the core n_{K} by an amount in the range from 0.0001 to 0.5, for example in a range from 0.0002 to 0.4, particularly preferably in a range from 0.0003 to 0.3.

The jacket M1 preferably has a refractive index u_{M1} in a range from 0.9 to 1.599, for example in a range from 1.30 to 1.59, particularly preferably in a range from 1.40 to 1.57. Preferably, the jacket M1 forms a region of the light duct with a constant refractive index u_{M1}. A region with constant refractive index means a region in which the refractive index does not deviate from the mean of u_{M1} by more than 0.0001.

In principle, the light duct can comprise further jackets. Particularly preferably at least one of the further jackets, preferably several or all of them, a refractive index which is lower than the refractive index n_{K} of each core. Preferably, the light duct has one or two or three or four or more than four further jackets which surround the jacket M1. Preferably, the further jackets which surround the jacket M1 have a refractive index which is lower than the refractive index u_{M1} of the jacket M1.

Preferably, the light duct has one or two or three or four or more than four further jackets which surround the cores and which are surrounded by the jacket M1, i.e. situated between the cores and the jacket M1. Furthermore, preferably, the further jackets situated between the cores and the jacket M1 have a refractive index which is higher than the refractive index u_{M1} of the jacket M1.

Preferably, the refractive index decreases from the core of the light duct to the outermost jacket. The reduction in the refractive index from the core to the outermost jacket can occur in steps or continuously. The reduction in the refractive index can have different sections. Furthermore, preferably, the refractive index can be stepped in at least one section and be continuous in at least one other section. The steps can be of the same or different height. It is certainly possible to arrange sections with increasing refractive index between sections with decreasing refractive index.

The different refractive indices of the different jackets can for example be configured by doping of the jacket M1, of the further jackets and/or of the cores.

Depending on the manner of preparation of a core, a core can already have a first jacket layer M0 following its preparation. This jacket layer M0 which is directly adjacent to the core is sometimes also called an integral jacket layer. The jacket layer M0 is situated closer to the middle point of the core than the jacket M1 and, if they are present, the further jackets. The jacket layer M0 commonly does not serve for light conduction or radiation conduction. Rather, the jacket layer M0 serves more to keep the radiation inside the core where it is transported. The radiation which is conducted in the core is thus preferably reflected at the interface from the core to the jacket layer M0. This interface from the core to the jacket layer M0 is preferably characterised by a change in refractive index. The refractive index of the jacket layer M0 is preferably lower than the refractive index n_{K} of the core. Preferably, the jacket layer M0 comprises the same material as the core, but has a lower refractive index to the core on account of doping or of additives.

Preferably, at least the jacket M1 is made out of silicon dioxide and has at least one, preferably several or all of the following features:
a) an OH content of less than 10 ppm, for example of less than 5 ppm, particularly preferably of less than 1 ppm;
b) a chlorine content of less than 200 ppm, preferably of less than 100 ppm, for example of less than 80 ppm, particularly preferably of less than 60 ppm;
c) an aluminium content of less than 200 ppb, preferably of less than 100 ppb, for example of less than 80 ppb, particularly preferably of less than 60 ppb;
d) an ODC content of less than 5·10¹⁵/cm³, for example in a range from 0.1·10¹⁵ to 3·10¹⁵/cm³, particularly preferably in a range from 0.5·10¹⁵ to 2.0·10¹⁵/cm³;
e) a metal content of metals which are different to aluminium, of less than 1 ppm, for example of less than 0.5 ppm, particularly preferably of less than 0.1 ppm;
f) a viscosity (p=1013 hPa) in a range from log₁₀ (η (1250° C.)/dPas)=11.4 to log₁₀ (η (1250° C.)/dPas)=12.9 and/or log 10 (η (1300° C.)/dPas)=11.1 to log₁₀ (η (1300° C.)/dPas)=12.2 and/or log₁₀ (η (1350° C.)/dPas)=10.5 to log₁₀ (η (1350° C.)/dPas)=11.5;
g) a curl parameter of more than 6 m;
h) a standard deviation of the OH content of not more than 10%, preferably not more than 5%, based on the OH content a) of the jacket M1;
i) a standard deviation of the Cl content of not more than 10%, preferably not more than 5%, based on the Cl content b) of the jacket M1;
j) a standard deviation of the Al content of not more than 10%, preferably not more than 5%, based on the Al content c) of the jacket M1;
k) a refractive index homogeneity of less than 1·10⁻⁴;
l) a transformation point Tg in a range from 1150 to 1250° C., particularly preferably in a range from 1180 to 1220° C.,
wherein the ppb and ppm are each based on the total weight of the jacket M1.

Preferably, the jacket has a refractive index homogeneity of less than 1·10⁻⁴. The refractive index homogeneity indicates the maximum deviation of the refractive index at each position of a sample, for example of a jacket M1 or of a quartz glass body, based on the mean value of all the refractive indices measured in the sample. For measuring the mean value, the refractive index is measured at least seven measuring locations.

Preferably, the jacket M1 has a metal content of metals different to aluminium of less than 1000 ppb, for example of less than 500 ppb, particularly preferably of less than 100 ppb, in each case based on the total weight of the jacket M1. Often however, the jacket M1 has a content of metals different to aluminium of at least 1 ppb. Such metals different to aluminium are for example sodium, lithium, potassium, magnesium, calcium, strontium, germanium, copper, molybdenum, titanium, iron and chromium. These can be present, for example, as an element, as an ion or as part of a molecule or of an ion or of a complex.

The jacket M1 can comprise further constituents. Preferably, the jacket comprises less than 500 ppm, for example less than 450 ppm, particularly preferably less than 400 ppm of further constituents, the ppm in each case based on the total weight of the jacket M1. Possible further constituents are for example carbon, fluorine, iodine, bromine and phosphorus. These can be present for example as an element, as an ion or as part of a molecule, of an ion or of a complex. Often however, the jacket M1 has a content of further constituents of at least 1 ppb.

Preferably, the jacket M1 comprises less than 5 ppm carbon, for example less than 4 ppm or less than 3 ppm, particularly preferably less than 2 ppm, in each case based on the total weight of the jacket M1. Often however, the jacket M1 has a carbon content of at least 1 ppb. Preferably, the jacket M1 has a homogeneous distribution of OH content, Cl content or Al content.

In a preferred embodiment of the light duct, the jacket M1 contributes by weight at least 80 wt.-%, for example at least 85 wt.-%, particularly preferably at least 90 wt.-%, in each case based on the total weight of the jacket M1 and the cores. Preferably, the jacket M1 contributes by weight at least 80 wt.-%, for example at least 85 wt.-%, particularly preferably at least 90 wt.-%, in each case based on the total weight of the jacket M1, the cores and the further jackets situated between the jacket M1 and the cores. Preferably, the jacket M1 contributes by weight at least 80 wt.-%, for example at least 85 wt.-%, particularly preferably at least 90 wt.-%, in each case based on the total weight of the light duct.

Preferably, the jacket M1 has a density in a range from 2.1 to 2.3 g/cm³, particularly preferably in a range from 2.18 to 2.22 g/cm³.

A fourth aspect of the present invention is a process for preparing an illuminant containing the following steps:
(i) Providing a quartz glass body according to the second aspect of the invention or obtainable according to a process according to the first aspect of the invention, wherein the quartz glass body is first processed to obtain a hollow body;
(ii) Optionally fitting the hollow body with electrodes;
(iii) Filling the hollow body with a gas.

### Step (i)

In step (i), a hollow body is provided. The hollow body provided in step (i) comprises at least one opening, for example one opening or two openings or three openings or four openings, particularly preferably one opening or two openings.

Preferably, a hollow body with at least one opening is provided in step (i) which is obtainable by a process according to the first aspect of the invention comprising the formation of a hollow body with at least one opening from the quartz glass body. Preferably, the hollow body has the features described in the context of the first or second aspect of the invention.

Preferably, a hollow body is provided in step (i) which is obtainable from a quartz glass body according to the second aspect of the invention. There are many possibilities for processing a quartz glass body according to the second aspect of the invention to obtain a hollow body.

Preferably, a hollow body with two openings can be formed in the context of the third aspect of the invention.

The processing of the quartz glass body to obtain a hollow body with an opening can in principle be performed by means of any process known to a person skilled in the art and which are suitable for the preparation of glass hollow bodies with an opening. For example, processes comprising a pressing, blowing, sucking or combinations thereof are suitable. It is also possible to form a hollow body with one opening from a hollow body with two openings by closing an opening, for example by melting shut.

The obtained hollow body preferably has the features described in the context of the first and second aspect of the invention.

The hollow body is made of a material which comprises silicon dioxide, preferably in in a range from 98 to 100 wt. %, for example in a range from 99.9 to 100 wt.-%, particularly preferably 100 wt.-%, in each case based on the total weight of the hollow body.

The material out of which the hollow body is prepared preferably has at least one, preferably several, for example two, or preferably all of the following features:
HK1. a silicon dioxide content of preferably more than 95 wt.-%, for example more than 97 wt.-%, particularly preferably more than 99 wt.-%, based on the total weight of the material;
HK2. a density in a range from 2.1 to 2.3 g/cm³, particularly preferably in a range from 2.18 to 2.22 g/cm³;
HK3. a light transmittivity at at least one wavelength in the visible range from 350 to 750 nm in a range from 10 to 100%, for example in a range from 30 to 99.99%, particularly preferably in a range from 50 to 99.9%, based on the amount of light which is produced inside the hollow body;
HK4. an OH content of less than 500 ppm, for example of less than 400 ppm, particularly preferably of less than 300 ppm;
HK5. a chlorine content of less than 200 ppm, preferably of less than 100 ppm, for example of less than 80 ppm, particularly preferably of less than 60 ppm;
HK6. an aluminium content of less than 200 ppb, for example of less than 100 ppb, particularly preferably of less than 80 ppb;
HK7. a carbon content of less than 5 ppm, for example of less than 4.5 ppm, particularly preferably of less than 4 ppm;
HK8. an ODC content of less than 5·10¹⁵/cm³;
HK9. a metal content of metals which are different to aluminium, of less than 1 ppm, for example of less than 0.5 ppm, particularly preferably of less than 0.1 ppm;
HK10. a viscosity (p=1013 hPa) in a range from log₁₀ η (1250° C.)=11.4 to log₁₀ η (1250° C.)=12.4 and/or log₁₀ η (1300° C.)=11.1 to log₁₀ η (1350° C.)=11.7 and/or log₁₀ η (1350° C.)=10.5 to log₁₀ η (1350° C.)=11.1;
HK11. A transformation point Tg in a range from 1150 to 1250° C., particularly preferably in a range from 1180 to 1220° C.;
wherein the ppm and ppb are each based on the total weight of the hollow body.

### Step (ii)

Preferably, the hollow body of step (i) is fitted with electrodes, preferably with two electrodes, before filling with a gas. Preferably, the electrodes are connected to a source of electrical current. Preferably, the electrodes are connected to an illuminant socket.

The material of the electrodes is preferably selected from the group of metals. In principle the electrode material can be selected from any metal which does not oxidise, corrode, melt or otherwise become impaired in its form or conductivity as electrode under the operative conditions of the illuminant. The electrode material is preferably selected from the group consisting of iron, molybdenum, copper, tungsten, rhenium, gold and platinum or at least two selected therefrom, wherein tungsten, molybdenum or rhenium are preferred.

Step (iii)

The hollow body provided in step (i) and optionally fitted with electrodes in step (ii) is filled with a gas.

The filling can be performed in any process known to a person skilled in the art and which is suitable for the filling. Preferably, a gas is conducted into the hollow body through the at least at least one opening.

Preferably, the hollow body is evacuated prior to filling with a gas, preferably evacuated to a pressure of less than 2 mbar. By subsequent introduction of a gas, the hollow body is filled with the gas. These steps can be repeated in order to reduce air impurities, in particular oxygen. Preferably, these steps are repeated at least twice, for example at least three times or at least four times, particularly preferably at least five times, until the amount of other gas impurities such as air, in particular oxygen, is sufficiently low. This procedure is particularly preferred for filling hollow bodies with one opening.

If the hollow body comprises two or more openings, the hollow body is preferably filled through one of the openings. The air present in the hollow body prior to filling with the gas can exit through the at least one further opening. The gas is fed through the hollow body until the amount of other gas impurities such as air, in particular oxygen, is sufficiently low.

Preferably, the hollow body is filled with an inert gas or with a combination of two or more inert gases, for example with nitrogen, helium, neon, argon, krypton, xenon or a combination of two or more thereof, particularly preferably with krypton, xenon or a combination of nitrogen and argon. Further preferred filling materials for the hollow body of illuminants are deuterium and mercury.

Preferably, the hollow body is closed after being filled with a gas, with the result that the gas does not exit during the further processing, with the result that no air enters from outside during the further processing, or both. The closing can be performed by melting or placing a cap. Suitable caps are for example quartz glass caps, which are for example melted onto the hollow body, or illuminant sockets. Preferably, the hollow body is closed by melting.

The illuminant according to the fifth aspect of the invention comprises a hollow body and optionally electrodes. The illuminant preferably has at least one, for example at least two or at least three or at least four, particularly preferably at least five of the following features:
I.) a volume in a range from 0.1 cm³ to 10 m³, for example in a range from 0.3 cm³ to 8 m³, particularly preferably in a range from 0.5 cm³ to 5 m³;
II.) a length in a range from 1 mm to 100 m, for example in a range from 3 mm to 80 m, particularly preferably in a range from 5 mm to 50 m;
III.) an angle of radiation in a range from 2 to 360°, for example in a range from 10 to 360°, particularly preferably in a range from 30 to 360′;
IV.) a radiation of light in a wavelength range from 145 to 4000 nm, for example in a range from 150 to 450 nm, or from 800 to 4000 nm, particularly preferably in a range from 160 to 280 nm;
V.) a power in a range from 1 mW to 100 kW, particularly preferably in a range from 1 kW to 100 kW, or in a range from 1 to 100 Watt.

A fifth aspect of the present invention is a process for the preparation of a formed body containing the following steps:
(1) Providing a quartz glass body according to the second aspect of the invention or obtainable according to a process according to the first aspect of the invention;
(2) Forming the quartz glass body to obtain the formed body.

The quartz glass body provided in step (1) is a quartz glass body according to the second aspect of the invention or obtainable according to a process according to the first aspect of the invention. Preferably, the provided quartz glass body has the features of the first or second aspect of the invention.

### Step (2)

For forming the quartz glass body provided in step (1), in principle any processes known to a person skilled in the art and which are suitable for forming quartz glass are possible. Preferably, the quartz glass body is formed as described in the context of the first, fourth and fifth aspect of the invention to obtain a formed body. Furthermore, preferably, the formed body can be formed by means of techniques known to glass blowers.

The formed body can in principle take any shape which is formable out of quartz glass. Preferred formed bodies are for example:
hollow bodies with at least one opening such as round bottomed flasks and standing flasks,
fixtures and caps for such hollow bodies,
open articles such as bowls and boats (wafer carrier),
crucibles, arranged either open or closable,
sheets and windows,
cuvettes,
tubes and hollow cylinders, for example reaction tubes, section tubes, cuboid chambers,
rods, bars and blocks, for example in round or angular, symmetric or asymmetric format,
tubes and hollow cylinders closed off at one end or both ends,
domes and bells,
flanges,
lenses and prisms,
parts welded to each other,
curved parts, for example convex or concave surfaces and sheets, curved rods and tubes.

According to a preferred embodiment, the formed body can be treated after the forming. For this, in principle all processes described in connection with the first aspect of the invention which are suitable for post-treatment of the quartz glass body are possible. Preferably, the formed body can be mechanically processed, for example by drilling, honing, external grinding, reducing in size or drawing.

### FIGURES

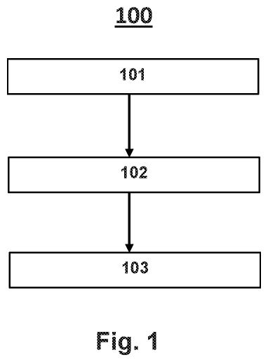

FIG. 1 flow diagram (process for the preparation of a quartz glass body)

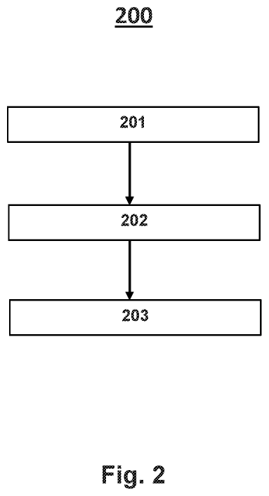

FIG. 2 flow diagram (process for the preparation of a silicon dioxide granulate I)

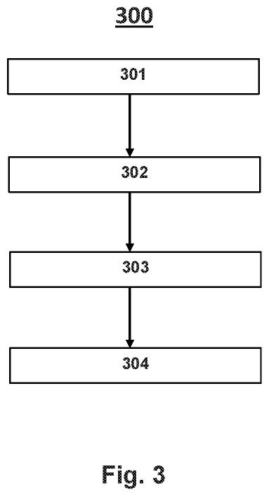

FIG. 3 flow diagram (process for the preparation of a silicon dioxide granulate II)

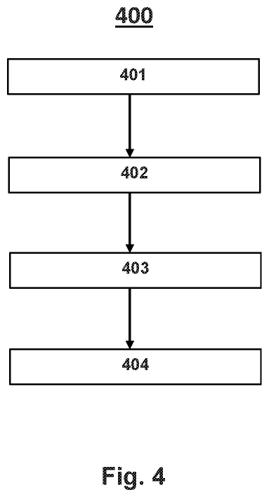

FIG. 4 flow diagram (process for the preparation of a quartz glass grain)

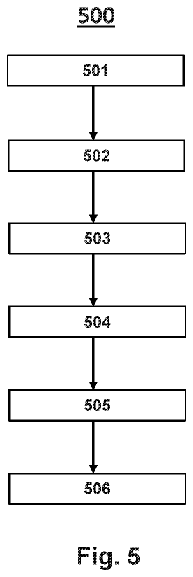

FIG. 5 flow diagram (process for the preparation of a quartz glass body)

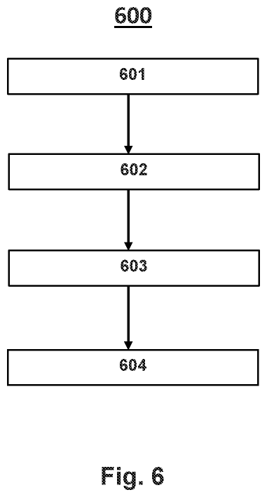

FIG. 6 flow diagram (process for the preparation of a light duct)

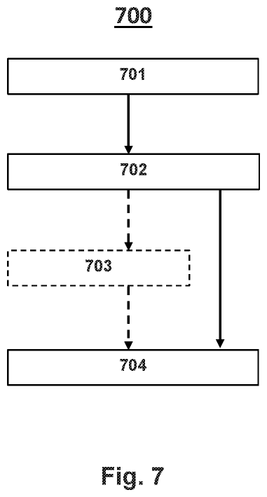

FIG. 7 flow diagram (process for the preparation of an illuminant

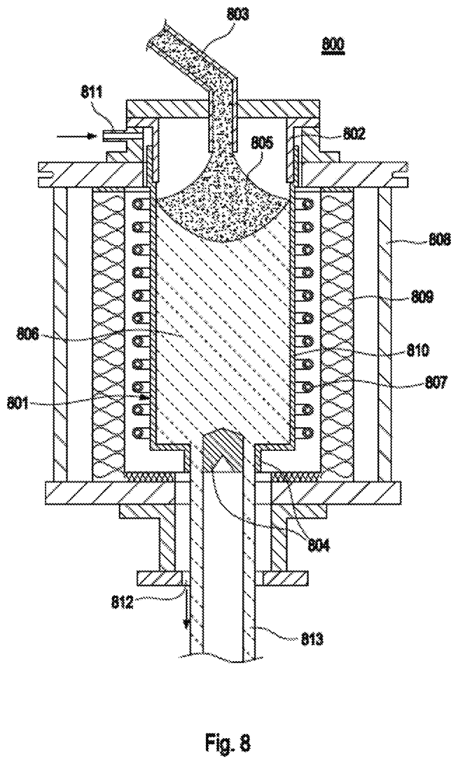

FIG. 8 schematic representation of a hanging crucible in an oven

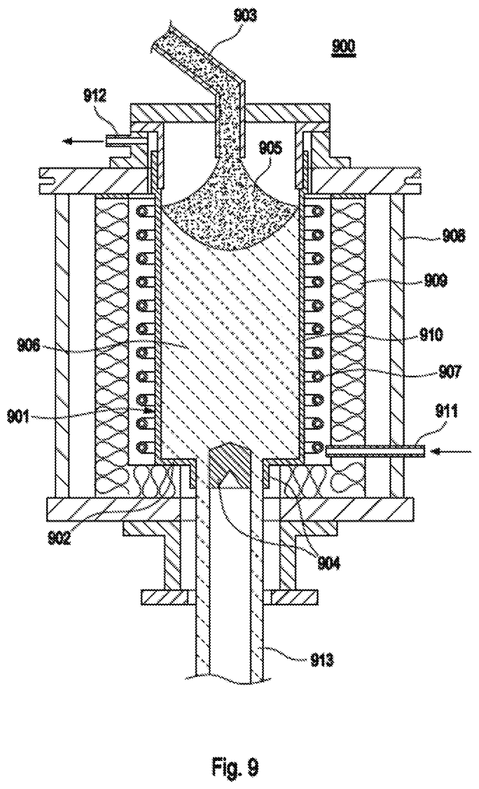

FIG. 9 schematic representation of a standing crucible in an oven

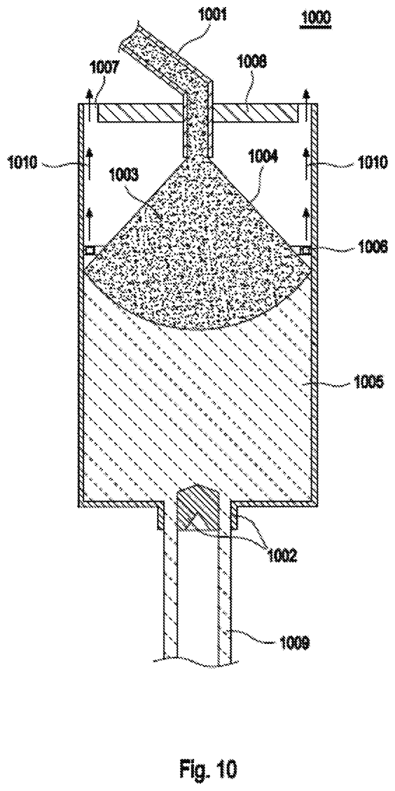

FIG. 10 schematic representation of a crucible with a flushing ring

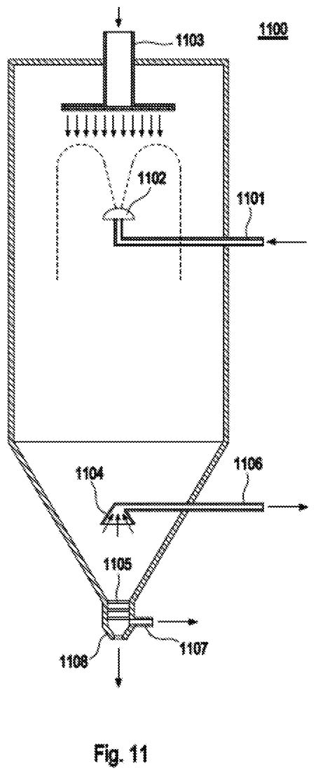

FIG. 11 schematic representation of a spray tower

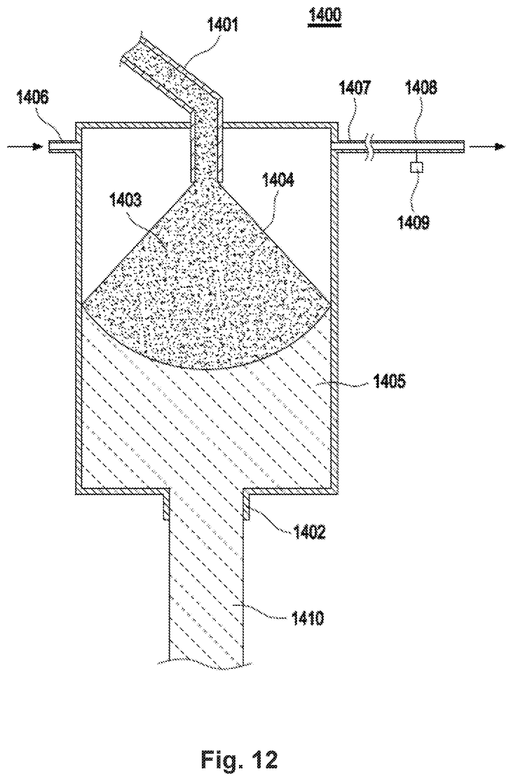

FIG. 12 schematic representation of a crucible with a dew point measuring device

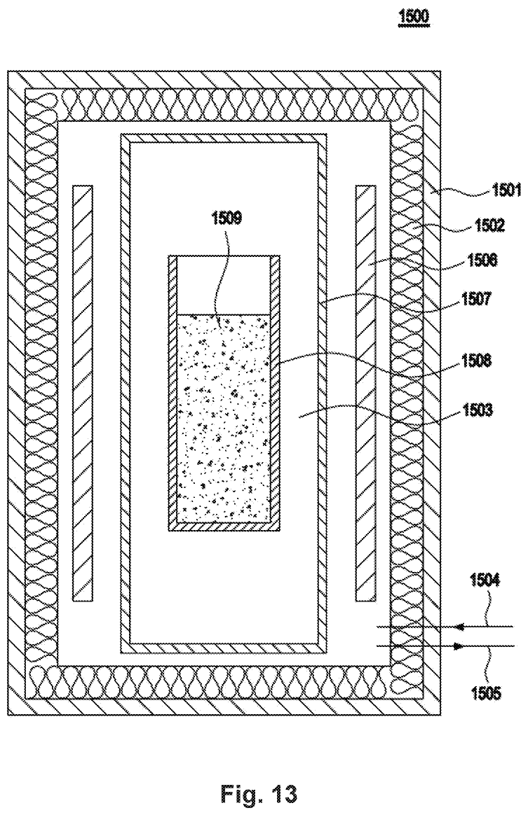

FIG. 13 schematic representation of a gas pressure sinter oven (GDS oven)

### DESCRIPTION OF THE FIGURES

FIG. 1 shows a flow diagram containing the steps 101 to 103 of a process 100 for the preparation of a glass product according to the present invention. In a first step 101, a silicon dioxide granulate is provided. In a second step 102, a first glass melt is made from the silicon dioxide granulate.

Preferably, moulds are used for the melting which can be introduced into and removed from an oven. Such moulds are often made of graphite. They provide a negative form for the caste item. The silicon dioxide granulate is filled into the mould and is first melted in the mould in step 103. Subsequently, the glass product is formed in the same mould by cooling the melt. It is then freed from the mould. This procedure is discontinuous. The forming of the melt is preferably performed at reduced pressure, in particular in a vacuum. Further, it is possible during step 103 to charge the oven intermittently with a reducing, hydrogen containing atmosphere.

In another procedure, hanging or standing crucibles are preferably employed. The melting is preferably performed in a reducing, hydrogen containing atmosphere. In a third step 103, a glass product is formed. The formation of the glass product is preferably performed by removing at least a part of the first glass melt from the crucible and cooling. The removal is preferably performed through a nozzle at the lower end of the crucible. In this case, the form of the glass product can be determined by the design of the nozzle. In this way, for example, solid bodies can be obtained. Hollow bodies are obtained for example if the nozzle additionally has a mandrel. This example of a process for the preparation of glass products, and in particular step 103, is preferably performed continuously.

FIG. 2 shows a flow diagram containing the steps 201, 202 and 203 of a process 200 for the preparation of a silicon dioxide granulate I. In a first step 201, a silicon dioxide powder is provided. A silicon dioxide powder is preferably obtained from a synthetic process in which a silicon containing material, for example a siloxane, a silicon alkoxide or a silicon halide is converted into silicon dioxide in a pyrogenic process. In a second step 202, the silicon dioxide powder is mixed with a liquid, preferably with water, to obtain a slurry. In a third step 203, the silicon dioxide contained in the slurry is transformed into a silicon dioxide granulate. The granulation is performed by spray granulation. For this, the slurry is sprayed through a nozzle into a spray tower and dried to obtain granules, wherein the contact surface between the nozzle and the slurry comprises a glass or a plastic.

FIG. 3 shows a flow diagram containing the steps 301, 302, 303 and 304 of a process 300 for the preparation of a silicon dioxide granulate II. The steps 301, 302 and 303 proceed corresponding to the steps 201, 202 and 203 according to FIG. 2. In step 304, the silicon dioxide granulate I obtained in step 303 is processed to obtain a silicon dioxide granulate II. This is preferably performed by warming the silicon dioxide granulate I in a chlorine containing atmosphere.

FIG. 4 shows a flow diagram containing the steps 401 to 404 of a process for the preparation of a quartz glass grain 400. In a first step 401, a silicon dioxide granulate is provided. In a second step 402, a first glass melt is formed from the silicon dioxide. Preferably, for this, the silicon dioxide granulate is introduced into a melting crucible and heated therein until a first glass melt forms. Preferably, hanging metal sheet crucibles or sintering crucibles or standing sintering crucibles are used as melting crucibles. Melting takes place preferably in a reducing atmosphere containing hydrogen. In a third step 403 a glass product is made. The glass product is made preferably by removing at least one part of the first glass melt from the crucible and cooling. Removal takes place preferably by a nozzle at the bottom end of the crucible. The shape of the glass product can be determined by the design of the nozzle. Preparation of quartz glass bodies, and in particular step 403, takes place preferably continuously. In a fourth step 404 the size of the glass product is reduced, preferably by high voltage discharge pulses, to obtain a quartz glass grain.

FIG. 5 shows a flow diagram containing the steps 501 to 506 of a process for the preparation of a quartz glass body 500. In a first step 501, a silicon dioxide granulate is provided. In a second step 502, a first glass melt is formed from the silicon dioxide granulate. Preferably, for this, the silicon dioxide granulate is introduced into a melting crucible and heated therein until a first glass melt forms. Preferably, hanging metal sheet crucibles or sintering crucibles or standing sintering crucibles are used as melting crucibles. Melting takes place preferably in a reducing atmosphere containing hydrogen. In a third step 503 a glass product is made. The glass product is made preferably by removing at least one part of the first glass melt from the crucible and cooling. Removal takes place preferably by a nozzle at the bottom end of the crucible. The shape of the glass product can be determined by the design of the nozzle. Preparation of glass products, and in particular step 503, takes place preferably continuously. In a fourth step 504 the size of the quartz glass body is reduced, preferably by high voltage discharge pulses to obtain a quartz glass grain. In a fifth step 505, a further glass melt is formed from the quartz glass grain. Preferably, for this, the quartz glass grain is introduced into a melting crucible and heated therein until a further glass melt forms. Preferably, hanging metal sheet crucibles or sintering crucibles or standing sintering crucibles are used as melting crucibles. Melting takes place preferably in a reducing atmosphere containing hydrogen. In a sixth step 506 a quartz glass body is made. The quartz glass body is made preferably by removing at least one part of the further glass melt from the crucible and cooling. Removal takes place preferably by a nozzle at the bottom end of the crucible. The shape of the quartz glass body can be determined by the design of the nozzle. Preparation of quartz glass bodies, and in particular step 506, takes place preferably continuously. The quartz glass bodies obtained in this way are preferably transparent.

FIG. 6 shows a flow diagram containing the steps 601 to 604 of the process for the preparation of a light duct. In the first step 601, a quartz glass body is provided, preferably a quartz glass body prepared according to FIG. 5. In a second step 602, a hollow quartz glass body is formed from a solid quartz glass body provided in step 601. In a third step 603, one or more than one core rods are introduced into the hollow quartz glass body. In a fourth step 604, the quartz glass body fitted with one or more than one core rods is processed to obtain a light duct. For this, the quartz glass body fitted with one or more than one core rods is preferably softened by heating and stretched until the desired thickness of the light duct is achieved.

FIG. 7 shows a flow diagram containing the steps 701, 702 and 704 as well as the optional step 703 of a process for the preparation of an illuminant. In the first step 701, a quartz glass body is provided, preferably a quartz glass body prepared according to FIG. 5. In a second step 702, a hollow quartz glass body is formed from a solid quartz glass body provided in step 701. In an optional third step 703, the hollow quartz glass body is fitted with electrodes. In a fourth step 704, the hollow quartz glass body is filled with a gas, preferably with argon, krypton, xenon or a combination thereof. Preferably, a solid quartz glass body is first provided (701), formed to obtain a hollow body (702), fitted with electrodes (703) and filled with a gas (704).

In FIG. 8, a preferred embodiment of an oven 800 with a hanging crucible is shown. The crucible 801 is arranged hanging in the oven 800. The crucible 801 has a hanger assembly 802 in its upper region, as well as a solids inlet 803 and a nozzle 804 as outlet. The crucible 801 is filled via the solids inlet 803 with silicon dioxide granulate 805. In operation, silicon dioxide granulate 805 is present in the upper region of the crucible 801, whilst a glass melt 806 is present in the lower region of the crucible. The crucible 801 can be heated by heating elements 807 which are arranged on the outer side of the crucible wall 810. The oven also has an insulation layer 809 between the heating elements 807 and the outer wall 808 of the oven. The space in between the insulation layer 809 and the crucible wall 810 can be filled with a gas and for this purpose has a gas inlet 811 and a gas outlet 812. A glass product 813 can be removed from the oven through the nozzle 804.

In FIG. 9 a preferred embodiment of an oven 900 with a standing crucible is shown. The crucible 901 is arranged standing in the oven 900. The crucible 901 has a standing area 902, a solids inlet 903 and a nozzle 904 as outlet. The crucible 901 is filled with silicon dioxide granulate 905 via the inlet 903. In operation, silicon dioxide granulate 905 is present in the upper region of the crucible, whilst a glass melt 906 is present in the lower region of the crucible. The crucible can be heated by heating elements 907 which are arranged on the outer side of the crucible wall 910. The oven also has an insulation layer 909 between the heating elements 907 and the outer wall 908. The space between the insulation layer 909 and the crucible wall 910 can be filled with a gas and for this purpose has a gas inlet 911 and a gas outlet 912. A glass product 913 can be removed from the crucible 901 through the nozzle 904.

In FIG. 10 is shown a preferred embodiment of a crucible 1000. The crucible 1000 has a solids inlet 1001 and a nozzle 1002 as outlet. The crucible 1000 is filled with silicon dioxide granulate 1003 via the solids inlet 1001. In operation, silicon dioxide granulate 1003 is present as a reposing cone 1004 in the upper region of the crucible 1000, whilst a glass melt 1005 is present in the lower region of the crucible. The crucible 1000 can be filled with a gas. It has a gas inlet 1006 and a gas outlet 1007. The gas inlet is a flushing ring mounted on the crucible wall above the silicon dioxide granulate. The gas in the interior of the crucible is released through the flushing ring (with a gas feed not shown here) close above the melting level and/or the reposing cone near the crucible wall and flows in the direction of the gas outlet 1007 which is arranged as a ring in the lid 1008 of the crucible 1000. The gas flow 1010 which is produced in this way moves along the crucible wall and submerges it. A glass product 1009 can be removed from the crucible 1000 through the nozzle 1002.

In FIG. 11 is shown a preferred embodiment of a spray tower 1100 for spray granulating silicon dioxide. The spray tower 1100 comprises a feed 1101 through which a pressurised slurry containing silicon dioxide powder and a liquid are fed into the spray tower. At the end of the pipeline is a nozzle 1102 through which the slurry is introduced into the spray tower as a finely spread distribution. Preferably, the nozzle slopes upward, so that the slurry is sprayed into the spray tower as fine droplets in the nozzle direction and then falls down in an arc under the influence of gravity. At the upper end of the spray tower there is a gas inlet 1103. By introduction of a gas through the gas inlet 1103, a gas flow is created in the opposite direction to the exit direction of the slurry out of the nozzle 1102. The spray tower 1100 also comprises a screening device 1104 and a sieving device 1105. Particles which are smaller than a defined particle size are extracted by the screening device 1104 and removed through the discharge 1106. The extraction strength of the screening device 1104 can be configured to correspond to the particle size of the particles to be extracted. Particles above a defined a defined particle size are sieved off by the sieving device 1105 and removed through the discharge 1107. The sieve permeability of the sieving device 1105 can be selected to correspond to the particle size to be sieved off. The remaining particles, a silicon dioxide granulate having the desired particle size, are removed through the outlet 1108.

FIG. 12 shows a preferred embodiment of a crucible 1400. The crucible has a solids inlet 1401 and an outlet 1402. In operation, silicon dioxide granulate 1403 is present in a reposing cone 1404 in the upper region of the crucible 1400, whilst a glass melt 1405 is present in the lower region of the crucible. The crucible 1400 has a gas inlet 1406 and a gas outlet 1407. The gas inlet 1406 and the gas outlet 1407 are arranged above the reposing cone 1404 of the silicon dioxide granulate 1403. The gas outlet 1406 comprises a pipeline for the gas feed 1408 and a device 1409 for measuring the dew point of the exiting gas. The device 1409 comprises a dew point mirror hygrometer (not shown here). The separation between the crucible and the device 1409 for measuring the dew point can vary. A quartz glass body 1410 can be removed through the outlet 1402 of the crucible 1400.

FIG. 13 shows a preferred embodiment of the oven 1500 which is suitable for a vacuum sintering process, a gas pressure sinter process and in particular a combination thereof. The oven has from outside inward a pressure resistant jacket 1501 and a thermal insulating layer 1502. The space enclosed thereby, referred to as the oven interior, can be charged with a gas or a gas mixture via a gas feed 1504. Further, the oven interior has a gas outlet 1505 via which gas can be removed. According to the gas transport balance between gas feed 1504 and gas removal at 1505 an overpressure, a vacuum or also a gas flow can be produced in the interior of the oven 1500. Further, heating elements 1506 are present in the oven interior 1500. These are often mounted on the insulation layer 1502 (not shown here). For protecting the melt material from contamination, there is a so-called “liner” 1507 in the interior of the oven, which separates the oven chamber 1503 from the heating elements 1506. Moulds 1508 with material to be melted 1509 can be introduced into the oven chamber 1503. The mould 1508 can be open on a side (shown here) or can completely enclose the melt material 1509 (not shown).

### Test Methods

a. Fictive Temperature
The fictive temperature is measured by Raman spectroscopy using the Raman scattering intensity at about 606 cm⁻¹. The procedure and analysis described in the contribution of Pfleiderer et. al.; “The UV-induced 210 nm absorption band in fused Silica with different thermal history and stoichiometry”; Journal of Non-Crystalline Solids, volume 159 (1993), pages 145-153.
   b. OH Content
The OH content of the glass is measured by infrared spectroscopy. The method of D. M. Dodd & D. M. Fraser “Optical Determinations of OH in Fused Silica” (J.A.P. 37, 3991 (1966)) is employed. Instead of the device named therein, an FTIR-spectrometer (Fourier transform infrared spectrometer, current System 2000 of Perkin Elmer) is employed. The analysis of the spectra can in principle be performed on either the absorption band at ca. 3670 cm⁻¹ or on the absorption band at ca. 7200 cm⁻¹. The selection of the band is made on the basis that the transmission loss through OH absorption is between 10 and 90%.
   c. Oxygen Deficiency Centers (ODCs)
For the quantitative detection, the ODC(I) absorption is measured at 165 nm by means of a transmission measurement at a probe with thickness between 1-2 mm using a vacuum UV spectrometer, model VUVAS 2000, of McPherson, Inc. (USA).
Then:

N=α/σ

with
N=defect concentration [1/cm³]
α=optical absorption [1/cm, base e] of the ODC(I) band
σ=effective cross section [cm²]
wherein the effective cross section is set to σ=7.5·10⁻¹⁷ cm² (from L. Skuja, “Color Centers and Their Transformations in Glassy SiO₂”, Lectures of the summer school “Photosensitivity in optical Waveguides and glasses”, Jul. 13-18, 1998, Vitznau, Switzerland).
   d. Elemental Analysis
d-1) Solid samples are crushed. Then, ca. 20 g of the sample is cleaned by introducing it into a HF-resistant vessel fully, covering it with HF and thermally treating at 100° C. for an hour. After cooling, the acid is discarded and the sample cleaned several times with high purity water. Then, the vessel and the sample are dried in the drying cabinet.
Next, ca. 2 g of the solid sample (crushed material cleaned as above; dusts etc. without pre-treatment) is weighed into an HF resistant extraction vessel and dissolved in 15 ml HF (50 wt.-%). The extraction vessel is closed and thermally treated at 100° C. until the sample is completely dissolved. Then, the extraction vessel is opened and further thermally treated at 100° C., until the solution is completely evaporated. Meanwhile, the extraction vessel is filled 3x with 15 ml of high purity water. 1 ml HNO₃ is introduced into the extraction vessel, in order to dissolve separated impurities and filled up to 15 ml with high purity water. The sample solution is then ready.
d-2) ICP-MS/ICP-OES measurement
Whether OES or MS is employed depends on the expected elemental concentrations. Typically, measurements of MS are 1 ppb, and for OES they are 10 ppb (in each case based on the weighed sample). The measurement of the elemental concentration with the measuring device is performed according to the stipulations of the device manufacturer (ICP-MS: Agilent 7500ce; ICP-OES: Perkin Elmer 7300 DV) and using certified reference liquids for calibration. The elemental concentrations in the solution (15 ml) measured by the device are then converted based on the original weight of the probe (2 g).
Note: It is to be kept in mind that the acid, the vessels, the water and the devices must be sufficiently pure in order to measure the elemental concentrations in question. This is checked by extracting a blank sample without quartz glass.
The following elements are measured in this way: Li, Na, Mg, K, Ca, Fe, Ni, Cr, Hf, Zr, Ti, (Ta), V, Nb, W, Mo, Al.
d-3) The measurement of samples present as a liquid is carried out as described above, wherein the sample preparation according to step d-1) is skipped. 15 ml of the liquid sample are introduced into the extraction flask. No conversion based on the original sample weight is made.
   e. Determination of Density of a Liquid
For measuring the density of a liquid, a precisely defined volume of the liquid is weighed into a measuring device which is inert to the liquid and its constituents, wherein the empty weight and the filled weight of the vessel are measured. The density is given as the difference between the two weight measurements divided by the volume of the liquid introduced.
   f. Fluoride Determination
15 g of a quartz glass sample is crushed and cleaned by treating in nitric acid at 70° C. The sample is then washed several times with high purity water and then dried. 2 g of the sample is weighed into a nickel crucible and covered with 10 g Na₂CO₃ and 0.5 g ZnO. The crucible is closed with a Ni-lid and roasted at 1000° C. for an hour. The nickel crucible is then filled with water and boiled up until the melt crust has dissolved entirely. The solution is transferred to a 200 ml measuring flask and filled up to 200 ml with high purity water. After sedimentation of undissolved constituents, 30 ml are taken and transferred to a 100 ml measuring flask, 0.75 ml of glacial acetic acid and 60 ml TISAB are added and filled up with high purity water. The sample solution is transferred to a 150 ml glass beaker.
The measurement of the fluoride content in the sample solution is performed by means of an ion sensitive (fluoride) electrode, suitable for the expected concentration range, and display device as stipulated by the manufacturer, here a fluoride ion selective electrode and reference electrode F-500 with R503/D connected to a pMX 3000/pH/ION from Wissenschaftlich-Technische Werkstätten GmbH. With the fluoride concentration in the solution, the dilution factor and the sample weight, the fluoride concentration in the quartz glass is calculated.
   g. Determination of Chlorine (>=50 ppm)
15 g of a quartz glass sample is crushed and cleaned by treating with nitric acid at ca. 70° C. Subsequently, the sample is rinsed several times with high purity water and then dried. 2 g of the sample are then filled into a PTFE-insert for a pressure container, dissolved with 15 ml NaOH (c=10 mol/l), closed with a PTFE lid and placed in the pressure container. It is closed and thermally treated at ca. 155° C. for 24 hours. After cooling, the PTFE insert is removed and the solution is transferred entirely to a 100 ml measuring flask. There, 10 ml HNO₃ (65 wt.-%) and 15 ml acetate buffer and added, allowed to cool and filled to 100 ml with high purity water. The sample solution is transferred to a 150 ml glass beaker. The sample solution has a pH value in the range between 5 and 7.
The measurement of the chloride content in the sample solution is performed by means of an ion sensitive (Chloride) electrode which is suitable for the expected concentration range, and a display device as stipulated by the manufacturer, here an electrode of type C1-500 and a reference electrode of type R-503/D attached to a pMX 3000/pH/ION from Wissenschaftlich-Technische Werkstätten GmbH.
   h. Chlorine Content (<50 ppm)
Chlorine content <50 ppm up to 0.1 ppm in quartz glass is measured by neutron activation analysis (NAA). For this, 3 bores, each of 3 mm diameter and 1 cm long are taken from the quartz glass body under investigation. These are given to a research institute for analysis, in this case to the institute for nuclear chemistry of the Johannes-Gutenberg University in Mainz, Germany. In order to exclude contamination of the sample with chlorine, a thorough cleaning of the sample in an HF bath on location directly before the measurement was arranged. Each bore is measured several times. The results and the bores are then sent back by the research institute.
   i. Optical Properties
The transmission of quartz glass samples is measured with the commercial grating- or FTIR-spectrometer from Perkin Elmer (Lambda 900 [190-3000 nm] or System 2000 [1000-5000 nm]). The selection is determined by the required measuring range.
For measuring the absolute transmission, the sample bodies are polished on parallel planes (surface roughness RMS <0.5 nm) and the surface is cleared off all residues by ultrasound treatment. The sample thickness is 1 cm. In the case of an expected strong transmission loss due to impurities, dopants etc., a thicker or thinner sample can be selected in order to stay within the measuring range of the device. A sample thickness (measuring length) is selected at which only slight artefacts are produced on account of the passage of the radiation through the sample and at the same time a sufficiently detectable effect is measured.
The measurement of the opacity, the sample is placed in front of an integrating sphere. The sample thickness is 1 cm. The opacity is calculated using the measured transmission value T according to the formula: O=1/T=I₀/I.
   j. Refractive Index and Distribution of Refractive Index in a Tube or Rod
The distribution of refractive index of tubes/rods can be characterised by means of a York Technology Ltd. Preform Profiler P102 or P104. For this, the rod is placed lying in the measuring chamber the chamber is closed tight. The measuring chamber is then filled with an immersion oil which has a refractive index at the test wavelength of 633 nm, which is very similar to that of the outermost glass layer at 633 nm. The laser beam then goes through the measuring chamber. Behind the measuring chamber (in the direction of the of the radiation) is mounted a detector which measures the angle of deviation (of the radiation entering the measuring chamber compared to the radiation exiting the measuring chamber). Under the assumption of radial symmetry of the distribution of refractive index of the rod, the diametral distribution of refractive index can be reconstructed by means of an inverse Abel transformation. These calculations are performed by the software of the device manufacturer York.
The refractive index of a sample is measured with the York Technology Ltd. Preform Profiler P104 analogue to the above description. In the case of isotropic samples, measurement of distribution of refractive index gives only one value, the refractive index.
   k. Carbon Content
The quantitative measurement of the surface carbon content of silicon dioxide granulate and silicon dioxide powder is performed with a carbon analyser RC612 from Leco Corporation, USA, by the complete oxidation of all surface carbon contamination (apart from SiC) with oxygen to obtain carbon dioxide. For this, 4.0 g of a sample are weighed and introduced into the carbon analyser in a quartz glass dish. The sample is bathed in pure oxygen and heated for 180 seconds to 900° C. The CO₂ which forms is measured by the infrared detector of the carbon analyser. Under these measuring conditions, the detection limit lies at <1 ppm (weight-ppm) carbon.
A quartz glass boat which is suitable for this analysis using the above named carbon analyser is obtainable as a consumable for the LECO analyser with LECO number 781-335 on the laboratory supplies market, in the present case from Deslis Laborhandel, Flurstrße 21, D-40235 Dusseldorf (Germany), Deslis-No. LQ-130XL. Such a boat has width/length/height dimensions of ca. 25 mm/60 mm/15 mm. The quartz glass boat is filled up to half its height with sample material. For silicon dioxide powder, a sample weight of 1.0 g sample material can be reached. The lower detection limit is then <1 weight ppm carbon. In the same boat, a sample weight of 4 g of a silicon dioxide granulate is reached for the same filling height (mean particle size in the range from 100 to 500 μm). The lower detection limit is then about 0.1 weight ppm carbon. The lower detection limit is reached when the measurement surface integral of the sample is not greater than three times the measurement surface integral of an empty sample (empty sample=the above process but with an empty quartz glass boat).
   l. Curl Parameter
The curl parameter (also called: “Fibre Curl”) is measured according to DIN EN 60793-1-34:2007-01 (German version of the standard IEC 60793-1-34:2006). The measurement is made according to the method described in Annex A in the sections A.2.1, A.3.2 and A.4.1 (“extrema technique”).
   m. Attenuation
The attenuation is measured according to DIN EN 60793-1-40:2001 (German version of the standard IEC 60793-1-40:2001). The measurement is made according to the method described in the annex (“cut-back method”) at a wavelength of λ=1550 nm.
   n. Viscosity of the Slurry
The slurry is set to a concentration of 30 weight-% solids content with demineralised water (Direct-Q 3UV, Millipore, Water quality: 18.2 MΩcm). The viscosity is then measured with a MCR102 from Anton-Paar. For this, the viscosity is measured at 5 rpm. The measurement is made at a temperature of 23° C. and an air pressure of 1013 hPa.
   o. Thixotropy
The concentration of the slurry is set to a concentration of 30 weight-% of solids with demineralised water (Direct-Q 3UV, Millipore, water quality: 18.2 MΩcm). The thixotropy is then measured with an MCR102 from Anton-Paar with a cone and plate arrangement. The viscosity is measured at 5 rpm and at 50 rpm. The quotient of the first and the second value gives the thixotropic index. The measurement is made at a temperature of 23° C.
   p. Zeta Potential of the Slurry
For zeta potential measurements, a zeta potential cell (Flow Cell, Beckman Coulter) is employed. The sample is dissolved in demineralised water (Direct-Q 3UV, Millipore, water quality: 18.2 MΩcm) to obtain a 20 mL solution with a concentration of 1 g/L. The pH is set to 7 through addition of HNO₃ solutions with concentrations of 0.1 mol/L and 1 mol/L and an NaOH solution with a concentration of 0.1 mol/L. The measurement is made at a temperature of 23° C.
   q. Isoelectric Point of the Slurry
The isoelectric point, a zeta potential measurement cell (Flow Cell, Beckman Coulter) and an auto titrator (DelsaNano AT, Beckman Coulter) is employed. The sample is dissolved in demineralised water (Direct-Q 3UV, Millipore, water quality: 18.2 MΩcm) to obtain a 20 mL solution with a concentration of 1 g/L. The pH is varied by adding HNO₃ solutions with concentrations of 0.1 mol/L and 1 mol/L and an NaOH solution with a concentration of 0.1 mol/L. The isoelectric point is the pH value at which the zeta potential is equal to 0. The measurement is made at a temperature of 23° C.

### r. pH Value of the Slurry

The pH value of the slurry is measured using a WTW 3210 from Wissenschaftlich-Technische-Werkstätten GmbH. The pH 3210 Set 3 from WTW is employed as electrode. The measurement is made at a temperature of 23° C.
   s. Solids Content
A weighed portion m₁ of a sample is heated for 4 hours to 500° C. reweighed after cooling (m₂). The solids content w is given as m₂/m₁*100 [Wt. %].
   t. Bulk Density
The bulk density is measured according to the standard DIN ISO 697:1984-01 with an SMG 697 from Powtec. The bulk material (silicon dioxide powder or granulate) does not clump.
   u. Tamped Density (Granulate)
The tamped density is measured according to the standard DIN ISO 787:1995-10.
   v. Measurement of the Pore Size Distribution
The pore size distribution is measured according to DIN 66133 (with a surface tension of 480 mN/m and a contact angle of 140°). For the measurement of pore sizes smaller than 3.7 nm, the Pascal 400 from Porotec is used. For the measurement of pore sizes from 3.7 nm to 100 μm, the Pascal 140 from Porotec is used. The sample is subjected to a pressure treatment prior to the measurement. For this a manual hydraulic press is used (Order-Nr. 15011 from Specac Ltd., River House, 97 Cray Avenue, Orpington, Kent BR5 4HE, U.K.). 250 mg of sample material is weighed into a pellet die with 13 mm inner diameter from Specac Ltd. and loaded with 1 t, as per the display. This load is maintained for 5 s and readjusted if necessary. The load on the sample is then released and the sample is dried for 4 hat 105±2° C. in a recirculating air drying cabinet.
The sample is weighed into the penetrometer of type 10 with an accuracy of 0.001 g and in order to give a good reproducibility of the measurement it is selected such that the stem volume used, i.e. the percentage of potentially used Hg volume for filling the penetrometer is in the range between 20% to 40% of the total Hg volume. The penetrometer is then slowly evacuated to 50 μm Hg and left at this pressure for 5 min. The following parameters are provided directly by the software of the measuring device: total pore volume, total pore surface area (assuming cylindrical pores), average pore radius, modal pore radius (most frequently occurring pore radius), peak n. 2 pore radius (μm).
   w. Primary Particle Size
The primary particle size is measured using a scanning electron microscope (SEM) model Zeiss Ultra 55. The sample is suspended in demineralised water (Direct-Q 3UV, Millipore, water quality: 18.2 MΩcm), to obtain an extremely dilute suspension. The suspension is treated for 1 min with the ultrasound probe (UW 2070, Bandelin electronic, 70 W, 20 kHz) and then applied to a carbon adhesive pad.
   x. Mean Particle Size in Suspension
The mean particle size in suspension is measured using a Mastersizer 2000, available from Malvern Instruments Ltd., UK, according to the user manual, using the laser deflection method. The sample is suspended in demineralised water (Direct-Q 3UV, Millipore, water quality: 18.2 MΩcm) to obtain a 20 mL suspension with a concentration of 1 g/L. The suspension is treated with the ultrasound probe (UW 2070, Bandelin electronic, 70 W, 20 kHz) for 1 min.
   y. Particle Size, Core Size of the Solid and Shape of Particles
The particle size and core size of the solid are measured using a Camsizer XT, available from Retsch Technology GmbH, Deutschland according to the user manual. The software gives the D10, D50 and D90 values for a sample. Moreover, SYMM3- and SPHT3-values are provided.
   z. BET Measurement
For the measurement of the specific surface area, the static volumetric BET method according to DIN ISO 9277:2010 is used. For the BET measurement, a “NOVA 3000” or a “Quadrasorb” (available from Quantachrome), which operate according to the SMART method (“Sorption Method with Adaptive dosing Rate”), is used. The micropore analysis is performed using the t-plot process (p/p0=0.1-0.3) and the mesopore analysis is performed using the MBET process (p/p0=0.0-0.3). As reference material, the standards alumina SARM-13 and SARM-214, available from Quantachrome are used. The tare weight of the measuring cell (clean and dry) is weighed. The type of measuring cell is selected such that the sample material which is introduced and the filler rod fill the measuring cell as much as possible and the dead space is reduced to a minimum. The sample material is introduced into the measuring cell. The amount of sample material is selected so that the expected value of the measurement value corresponds to 10-20 m²/g. The measuring cells are fixed in the baking positions of the BET measuring device (without filler rod) and evacuated to <200 mbar. The speed of the evacuation is set so that no material leaks from the measuring cell. Baking is performed in this state at 200° C. for 1 h. After cooling, the measuring cell filled with the sample is weighed (raw value). The tare weight is then subtracted from the raw value of the weight=nett weight=weight of the sample. The filling rod is then introduced into the measuring cell this is again fixed at the measuring location of the BET measuring device. Prior to the start of the measurement, the sample identifications and the sample weights are entered into the software. The measurement is started. The saturation pressure of nitrogen gas (N2 4.0) is measured. The measuring cell is evacuated and cooled down to 77 K using a nitrogen bath. The dead space is measured using helium gas (He 4.6). The measuring cell is evacuated again. A multi point analysis with at least 5 measuring points is performed. N2 4.0 is used as absorptive. The specific surface area is given in m²/g.
   za. Viscosity of Glass Bodies
The viscosity of the glass is measured using the beam bending viscosimeter of type 401—from TA Instruments with the manufacturer's software WinTA (current version 9.0) in Windows 10 according to the DIN ISO 7884-4:1998-02 standard. The support width between the supports is 45 mm. Sample rods with rectangular cross section are cut from regions of homogeneous material (top and bottom sides of the sample have a finish of at least 1000 grain). The sample surfaces after processing have a grain size=9 μm & RA=0.15 μm. The sample rods have the following dimensions: length=50 mm, width=5 mm & height=3 mm (ordered: length, width, height, as in the standards document). Three samples are measured and the mean is calculated. The sample temperature is measured using a thermocouple tight against the sample surface. The following parameters are used: heating rate=25 K up to a maximum of 1500° C., loading weight=100 g, maximum bending=3000 μm (deviation from the standards document).
   zb. Dew Point Measurement
The dew point is measured using a dew point mirror hygrometer called “Optidew” of the company Michell Instruments GmbH, D-61381 Friedrichsdorf. The measuring cell of the dew point mirror hygrometer is arranged at a distance of 100 cm from the gas outlet of the oven. For this, the measuring device with the measuring cell is connected in gas communication to the gas outlet of the oven via a T-piece and a hose (Swagelok PFA, Outer diameter: 6 mm). The over pressure at the measuring cell is 10±2 mbar. The through flow of the gas through the measuring cell is 1-2 standard litre/min. The measuring cell is in a room with a temperature of 25° C., 30% relative air humidity and a mean pressure of 1013 hPa.
   zc. Residual Moisture (Water Content)
The measurement of the residual moisture of a sample of silicon dioxide granulate is performed using a Moisture Analyzer HX204 from Mettler Toledo. The device functions using the principle of thermogravimefiy. The HX204 is equipped with a halogen light source as heating element. The drying temperature is 220° C. The starting weight of the sample is 10 g±10%. The “Standard” measuring method is selected. The drying is carried out until the weight change reaches not more than 1 mg/140 s. The residual moisture is given as the difference between the initial weight of the sample and the final weight of the sample, divided by the initial weight of the sample.
The measurement of residual moisture of silicon dioxide powder is performed according to DIN EN ISO 787-2:1995 (2 h, 105° C.).
   zd. Blistering and Bubble Size
Blistering means the number of bubbles per 1 kg of an examined sample, thus glass product or quartz glass body. Bubble size means the arithmetic mean of the diameter of a representative number of bubbles. Both values are visually determined with a measuring magnifier. This has a measurement scale for determining distances, such as a diameter.
In samples with a blistering of less than 50 bubbles/kg of sample, the diameter of each individual bubble is determined and divided by the number of measured bubbles. In samples with a blistering of more than 50 bubbles/kg, a disk is cut from the sample, the number of bubbles and the blistering of the disk is determined, and then extrapolated to the reference value of 1 kg of sample.

### EXAMPLES

The example is further illustrated in the following through examples. The invention is not limited by the examples.

### A. 1. Preparation of Silicon Dioxide Powder (OMCTS Route)

An aerosol formed by atomising a siloxane with air (A) is introduced under pressure into a flame which is formed by igniting a mixture of oxygen enriched air (B) and hydrogen. Furthermore, a gas flow (C) surrounding the flame is introduced and the process mixture is then cooled with process gas. The product is separated off at a filter. The process parameters are given in Table 1 and the specifications of the resulting product are given in Table 2. Experimental data for this example are indicated with A1-x.

2. Modification 1: Increased Carbon Content
A process was carried out as described in A.1., but the burning of the siloxane was performed in such a way that an amount of carbon was also formed. Experimental data for this example are indicated with A2-x.

TABLE 1

| Example | | A1-1 | A2-1 | A2-2 |
|---|---|---|---|---|
| Aerosol formation | | | | |
| Siloxane | | OMCTS* | OMCTS* | OMCTS* |
| Feed rate | kg/h | 10 | 10 | 10 |
| | (kmol/h) | (0.0337) | (0.0337) | (0.0337) |
| Feed rate of air (A) | Nm³/h | 14 | 10 | 12 |
| Pressure | barO | 1.2 | 1.2 | 1.2 |
| Burner feed | | | | |
| Oxygen enriched air (B) | Nm³/h | 69 | 65 | 68 |
| O₂-content | Vol. % | 32 | 30 | 32 |
| total O₂ feed rate | Nm³/h | 25.3 | 21.6 | 24.3 |
| | kmol/h | 1.130 | 0.964 | 1.083 |
| Hydrogen feed rate | Nm³/h | 27 | 27 | 12 |
| | kmol/h | 1.205 | 1.205 | 0.536 |
| Feed | | — | — | |
| Carbon compound | | | | |
| Material | | | | methane |
| Amount | Nm³/h | | | 5.5 |
| Air flow (C) | Nm³/h | 60 | 60 | 60 |

| | | | |
|---|---|---|---|
| Stoichiometric ratio | | | |
| V | 2.099 | 1.789 | 2.011 |
| X | 0.938 | 0.80 | 2.023 |
| Y | 0.991 | 0.845 | 0.835 |

V = molar ratio of employed O₂/O₂ required for completed oxidation of the siloxane; X = molar ratio O₂/H₂; Y = (molar ratio of employed O₂/O₂ required for stoichiometric conversion OMCTS + fuel gas); barO = overpressure;
*OMCTS = Octamethylcyclotetrasiloxane.

TABLE 2

| Example | | A1-1 | A2-1 | A2-2 |
|---|---|---|---|---|
| BET | m²/g | 30 | 33 | 34 |
| Bulk density | g/ml | 0.114 +− 0.011 | 0.105 +− 0.011 | 0.103 +− 0.011 |
| tamped density | g/ml | 0.192 +− 0.015 | 0.178 +− 0.015 | 0.175 +− 0.015 |
| Primary particle size | nm | 94 | 82 | 78 |
| particle size distribution D10 | μm | 3.978 ± 0.380 | 5.137 ± 0.520 | 4.973 ± 0.455 |
| particle size distribution D50 | μm | 9.383 ± 0.686 | 9.561 ± 0.690 | 9.423 ± 0.662 |
| particle size distribution D90 | μm | 25.622 ± 1.387 | 17.362 ± 0.921 | 18.722 ± 1.218 |
| C content | ppm | 34 ± 4 | 73 ± 6 | 80 ± 6 |
| Cl content | ppm | <60 | <60 | <60 |
| Al content | ppb | 20 | 20 | 20 |
| Total content of metals other than Al | ppb | <700 | <700 | <700 |
| residual moisture content | wt.-% | 0.02-1.0 | 0.02-1.0 | 0.02-1.0 |
| pH value in water 4% (IEP) | — | 4.8 | 4.6 | 4.5 |
| Viscosity at 5 rpm, aqueous | mPas | 753 | 1262 | 1380 |
| suspension 30 Wt-%, 23° C. | | | | |
| Alkali earth metal content | ppb | 538 | 487 | 472 |

B. 1. Preparation of silicon dioxide powder (silicon source: SiCl₄)
A portion of silicon tetrachloride (SiCl₄) is evaporated at a temperature T and introduced with a pressure P into a flame of a burner which is formed by igniting a mixture of oxygen enriched air and hydrogen. The mean normalised gas flow to the outlet is held constant. The process mixture is then cooled with process gas. The product was separated off at a filter. The process parameters are given in Table 3 and the specifications of the resulting products are given in Table 4. They are indicated with B1-x.

2. Modification 1: Increased Carbon Content
A process was carried out as described in B.1., but the burning of the silicon tetrachloride was performed such that an amount of carbon was also formed. Experimental data for this example are indicated with B2-x.

TABLE 3

| Example | | B1-1 | B2-1 |
|---|---|---|---|
| Aerosol formation | | | |
| Silicon tetrachloride feed | kg/h | 50 | 50 |
| | (kmol) | (0.294) | (0.294) |
| Temperature T | ° C. | 90 | 90 |
| Pressure p | barO | 1.2 | 1.2 |
| Burner feed | | | |
| Oxygen enriched air, | Nm³/h | 145 | 115 |
| O₂ content therein | Vol. % | 45 | 30 |
| Feed | | — | |
| Carbon compound | | | |
| Material | | | methane |
| Amount | Nm³/h | | 2.0 |
| Hydrogen feed | Nm³/h | 115 | 60 |
| | kmol/h | 5.13 | 2.678 |

| | | |
|---|---|---|
| Stoichiometric ratios | | |
| X | 0.567 | 0.575 |
| Y | 0.946 | 0.85 |

X = as molar ratio O₂/H₂; Y = molar ratio of employed O₂/O₂ required for stoichiometric reaction with SiCl4 + H2 + CH4); barO = Overpressure.

TABLE 4

| Example | | B1-1 | B2-1 |
|---|---|---|---|
| BET | m²/g | 49 | 47 |
| Bulk density | g/ml | 0.07 ± 0.01 | 0.06 ± 0.01 |
| tamped density | g/ml | 0.11 ± 0.01 | 0.10 ± 0.01 |
| Primary particle size | nm | 48 | 43 |
| particle size distribution D10 | μm | 5.0 ± 0.5 | 4.5 ± 0.5 |
| particle size distribution D50 | μm | 9.3 ± 0.6 | 8.7 ± 0.6 |
| particle size distribution D90 | μm | 16.4 ± 0.5 | 15.8 ± 0.7 |
| C content | ppm | <4 | 76 |
| Cl content | ppm | 280 | 330 |
| Al content | ppb | 20 | 20 |
| Total of the concentrations of | ppb | <1300 | <1300 |
| Ca, Co, Cr, Cu, Fe, Ge, Hf, K, | | | |
| Li, Mg, Mn, Mo, Na, Nb, Ni, Ti, | | | |
| V, W, Zn, Zr | | | |
| residual moisture content | wt.-% | 0.02-1.0 | 0.02-1.0 |
| pH value in water 4% (IEP) | pH | 3.8 | 3.8 |
| Viscosity at 5 rpm, aqueous | mPas | 5653 | 6012 |
| suspension 30 Wt-%, 23° C. | | | |
| Alkali earth metal content | ppb | 550 | 342 |

### C. Steam Treatment

A particle flow of silicon dioxide powder is introduced via the top of a standing column. Steam at a temperature (A) and air are fed via the bottom of the column. The column is maintained at a temperature (B) at the top of the column and at a second temperature (C) at the bottom of the column by an internally situated heater. After leaving the column (holding time (D)) the silicon dioxide powder has in particular the properties shown in Table 6. The process parameters are given in Table 5.

TABLE 5

| Example | | C-1 | C-2 |
|---|---|---|---|
| Educt: Product of | | B1-1 | B2-1 |
| Educt feed | kg/h | 100 | 100 |
| Steam feed | kg/h | 5 | 5 |
| Steam temperature (A) | ° C. | 120 | 120 |
| Air feed | Nm³/h | 4.5 | 4.5 |
| Column | | | |
| height | m | 2 | 2 |
| Inner diameter | mm | 600 | 600 |
| T (B) | ° C. | 260 | 260 |
| T (C) | ° C. | 425 | 425 |
| Holding time (D) silicon | s | 10 | 10 |
| dioxide powder | | | |

TABLE 6

| Example | | C-1 | C-2 |
|---|---|---|---|
| pH value in water 4% (IEP) | — | 4.6 | 4.6 |
| Cl content | ppm | <60 | <60 |
| C content | ppm | <4 | 36 |
| Viscosity at 5 rpm, aqueous | mPas | 1523 | 1478 |
| suspension 30 Wt-%, 23° C. | | | |

The silicon dioxide powders obtained in the examples C-1 and C-2 each have a low chlorine content as well as a moderate pH value in suspension. The carbon content of example C-2 is higher as for C-1.
   D. Treatment with a Neutralising Agent
A particle flow of silicon dioxide powder is introduced via the top of a standing column. A neutralising agent and air are fed via the bottom of the column. The column is maintained at a temperature (B) at the top of the column and at a second temperature (C) at the bottom of the column by an internally situated heater. After leaving the column (holding time (D)) the silicon dioxide powder has in particular the properties shown in Table 8. The process parameters are given in Table 7.

TABLE 7

| Example | | D-1 |
|---|---|---|
| Educt: Product from | | B1-1 |
| Educt feed | kg/h | 100 |
| Neutralising agent | | Ammonia |
| Neutralising agent feed | kg/h | 1.5 |
| Neutralising agent | | Obtainable from Air Liquide: |
| specifications | | Ammonia N38, purity ≥ 99.98 Vol. % |
| Air feed | Nm³/h | 4.5 |
| Column | | |
| height | m | 2 |
| inner diameter | mm | 600 |
| T (B) | ° C. | 200 |
| T (C) | ° C. | 250 |
| Holding time (D) of | s | 10 |
| silicon dioxide powder | | |

TABLE 8

| Example | | D-1 |
|---|---|---|
| pH value in water 4% (IEP) | — | 4.8 |
| Cl content | ppm | 210 |
| C content | ppm | <4 |
| Viscosity at 5 rpm, aqueous | mPas | 821 |
| suspension 30 Wt-%, 23° C. | | |

E. 1. Preparation of Silicon Dioxide Granulate from Silicon Dioxide Powder
A silicon dioxide powder is dispersed in fully desalinated water. For this, an intensive mixer of type R from the Gustav Eirich machine factory is used. The resulting suspension is pumped with a membrane pump and thereby pressurised and converted into droplets by a nozzle. These are dried in a spray tower and collect on the floor of the tower. The process parameters are given in Table 9 and the properties of the obtained granulate in Table 10. Experimental data for this example are indicated with E1-x.

2. Modification 1: Increased Carbon Content
The process is analogous to that described in E.1. Additionally, carbon powder is dispersed into the suspension. Experimental data for these examples are indicated with E2-x.

3. Modification 2: Addition of Silicon
The process is analogous to that described in E.1. Additionally, a silicon component is dispersed into the suspension. Experimental data for these examples are identified with E3-1.

TABLE 9

| Example | | E1-1 | E1-2 | E1-3 | E1-4 | E1-5 | E2-1 | E3-1 | | E3-2 |
|---|---|---|---|---|---|---|---|---|---|---|
| Educt = Product from | | A1-1 | A2-1 | B1-1 | C-1 | C-2 | A1-1 | A1-1 | | A2-1 |
| Amount of educt | Kg | 10 | 10 | 10 | 10 | 10 | 10 | 10 | | 10 |
| Carbon powder | | | | | | | | | | |
| Material | | — | — | — | — | — | C** | — | | — |
| Max. Particle size | | | | | | | 75 μm | | | |
| Amount | | | | | | | 1 g | | | |
| Silicon component | | | | | | | | | | |
| Material | | — | — | — | — | — | — | silicon | | — |
| | | | | | | | | powder*** | | |
| Grain size (d50) | | | | | | | | 8 | μm | |
| Amount | | | | | | | | 1000 | ppm | |
| Carbon content | | | | | | | | 0.5 | ppm | |
| Total of the concentra- | | | | | | | | 5 | ppm | |
| tions of Ca, Co, Cr, | | | | | | | | | | |
| Cu, Fe, Ge, Hf, K, Li, | | | | | | | | | | |
| Mg, Mn, Mo, Na, Nb, | | | | | | | | | | |
| Ni, Ti, V, W, Zn, Zr | | | | | | | | | | |
| Water | Rating* | FD | FD | FD | FD | FD | FD | FD | | FD |
| | Litre | 5.4 | 5.4 | 5.4 | 5.4 | 5.4 | 5.4 | 5.4 | | 5.4 |
| Dispersion | | | | | | | | | | |
| Solids content | Wt. % | 65 | 65 | 65 | 65 | 65 | 65 | 65 | | 65 |
| Nozzle | | | | | | | | | | |
| Diameter | mm | 2.2 | 2.2 | 2.2 | 2.2 | 2.2 | 2.2 | 2.2 | | 2.2 |
| Temperature | ° C. | 25 | 25 | 25 | 25 | 25 | 25 | 25 | | 25 |
| Pressure | Bar | 16 | 16 | 16 | 16 | 16 | 16 | 16 | | 16 |
| Installation height | m | 6.5 | 6.5 | 6.5 | 6.5 | 6.5 | 6.5 | 6.5 | | 6.5 |
| Spray tower | | | | | | | | | | |

| | | | | | | | | | |
|---|---|---|---|---|---|---|---|---|---|
| Height | m | 18.20 | 18.20 | 18.20 | 18.20 | 18.20 | 18.20 | 18.20 | 18.20 |
| Inner diameter | m | 6.30 | 6.30 | 6.30 | 6.30 | 6.30 | 6.30 | 6.30 | 6.30 |
| T (introduced gas) | ° C. | 380 | 380 | 380 | 380 | 380 | 380 | 380 | 380 |
| T (exhaust) | ° C. | 110 | 110 | 110 | 110 | 110 | 110 | 110 | 110 |
| Air flow | m³/h | 6500 | 6500 | 6500 | 6500 | 6500 | 6500 | 6500 | 6500 |

Installation height = distance between nozzle and lowest point of the spray tower interior in the direction of gravity.
*FD = fully desalinated, conductance ≤ 0.1 μS;
**C 006011: Graphite powder, max. particle size: 75 μm, high purity (available from Goodfellow GmbH, Bad Nauheim (Germany);
***available from Wacker Chemie AG (Munich, Germany).

TABLE 10

| Example | | E1-1 | E1-2 | E1-3 | E1-4 | E1-5 | E2-1 | E3-1 | E3-2 |
|---|---|---|---|---|---|---|---|---|---|
| BET | m²/g | 30 | 33 | 49 | 49 | 47 | 28 | 31 | 35 |
| Bulk density | g/ml | 0.8 ± 0.1 | 0.8 ± 0.1 | 0.8 ± 0.1 | 0.8 ± 0.1 | 0.8 ± 0.1 | 0.8 ± 0.1 | 0.8 ± 0.1 | 0.8 ± 0.1 |
| tamped density | g/ml | 0.9 ± 0.1 | 0.9 ± 0.1 | 0.9 ± 0.1 | 0.9 ± 0.1 | 0.9 ± 0.1 | 0.9 ± 0.1 | 0.9 ± 0.1 | 0.9 ± 0.1 |
| mean particle size | μm | 255 | 255 | 255 | 255 | 255 | 255 | 255 | 255 |
| particle size distribu- | μm | 110 | 110 | 110 | 110 | 110 | 110 | 110 | 110 |
| tion D10 | | | | | | | | | |
| particle size distribu- | μm | 222 | 222 | 222 | 222 | 222 | 222 | 222 | 222 |
| tion D50 | | | | | | | | | |
| particle size distribu- | μm | 390 | 390 | 390 | 390 | 390 | 390 | 390 | 390 |
| tion D90 | | | | | | | | | |
| SPHT3 | Dim- | 0.64-0.98 | 0.64-0.98 | 0.64-0.98 | 0.64-0.98 | 0.64-0.98 | 0.64-0.98 | 0.64-0.98 | 0.64-0.98 |
| | less | | | | | | | | |
| Aspect ratio W/L | Dim- | 0.64-0.94 | 0.64-0.94 | 0.64-0.94 | 0.64-0.94 | 0.64-0.94 | 0.64-0.94 | 0.64-0.94 | 0.64-0.94 |
| (width to length) | less | | | | | | | | |
| C content | ppm | <4 | 39 | <4 | <4 | 32 | 100 | <4 | 39 |
| Cl content | ppm | <60 | <60 | 280 | <60 | <60 | <60 | <60 | <60 |
| Al content | ppb | 20 | 20 | 20 | 20 | 20 | 20 | 20 | 20 |
| Total of the concentra- | ppb | <700 | <700 | <1300 | <1300 | <1300 | <700 | <700 | <700 |
| tions of Ca, Co, Cr, Cu, | | | | | | | | | |
| Fe, Ge, Hf, K, Li, Mg, | | | | | | | | | |
| Mn, Mo, Na, Nb, Ni, | | | | | | | | | |
| Ti, V, W, Zn, Zr | | | | | | | | | |
| residual moisture con- | wt.-% | <3 | <3 | <3 | <3 | <3 | <3 | <3 | <3 |
| tent | | | | | | | | | |
| Alkaline earth metal | ppb | 538 | 487 | 550 | 550 | 342 | 538 | 538 | 487 |
| content | | | | | | | | | |
| pore volume | ml/g | 0.33 | 0.33 | 0.45 | 0.45 | 0.45 | 0.33 | 0.33 | 0.33 |
| angle of repose | ° | 26 | 26 | 26 | 26 | 26 | 26 | 26 | 26 |

The granulates are all open pored, have a uniform and spherical shape (all by microscopic investigation). They tend not to stick together or cement.

### F. Cleaning of Silicon Dioxide Granulate

Silicon dioxide granulate is first optionally treated with oxygen or nitrogen (see Table 11) at a temperature T1 in a rotary kiln. Subsequently, unless indicated otherwise (F3-1, F3-2, etc.), the silicon dioxide granulate is treated with a co-flow of a chlorine containing component, wherein the temperature is raised to a temperature T2. Because of the treatment with a chlorine component in the heat, this process is called “hot chlorination”. The process parameters are given in Table 11 and the properties of the obtained treated granulate in Table 12.

TABLE 11

| Example | | F1-1 | F1-2 | F1-3 | F1-4 | F1-5 | F2-1 | F3-1 | F3-2 |
|---|---|---|---|---|---|---|---|---|---|
| Educt = Product from | | E1-1 | E1-2 | E1-3 | E1-4 | E1-5 | E2-1 | E3-1 | E3-2 |
| Rotary kiln ¹⁾ | | | | | | | | | |
| length | cm | 200 | | 200 | 200 | 200 | | 200 | 200 |
| Inner diameter | cm | 10 | | 10 | 10 | 10 | | 10 | 10 |
| Throughput | kg/h | 2 | | 2 | 2 | 2 | | 2 | 2 |
| Rotational speed | rpm | 2 | | 2 | 2 | 2 | | 2 | 2 |
| T1 | ° C. | 1100 | NA | 1100 | 1100 | 1100 | NA | 1100 | 1100 |
| Atmosphere | | O2 pure | NA | O2 pure | O2 pure | O2 pure | NA | N2 | N2 |
| Reactant | | O2 | NA | O2 | O2 | O2 | NA | None | None |
| Feed | | 300 l/h | NA | 300 l/h | 300 l/h | 300 l/h | NA | | |
| residual moisture | wt.-% | <1 | <3 | <1 | <1 | <1 | <3 | <1 | <1 |
| content | | | | | | | | | |
| T2 | ° C. | 1100 | 1100 | 1100 | 1100 | 1100 | 1100 | NA | NA |
| Co-flow | | | | | | | | | |
| Component 1: HCl | l/h | 50 | 50 | 50 | 50 | 50 | 50 | NA | NA |
| Component 2: Cl2 | l/h | 0 | 15 | 0 | 0 | 0 | 15 | NA | NA |
| Component 3: N2 | l/h | 50 | 35 | 50 | 50 | 50 | 35 | NA | NA |
| Total co-flow | l/h | 100 | 100 | 100 | 100 | 100 | 100 | NA | NA |

¹⁾ For the rotary kilns, the throughput is selected as the control variable. That means that during operation the mass flow exiting from the rotary kiln is weighed and then the rotational speed and/or the inclination of the rotary kiln is adapted accordingly. For example, an increase in the throughput can be achieved by a) increasing the rotational speed, or b) increasing the inclination of the rotary kiln away from horizontal, or a combination of a) and b).

TABLE 12

| Example | | F1-1 | F1-2 | F1-3 | F1-4 | F1-5 | F2-1 | F3-1 | F3-2 |
|---|---|---|---|---|---|---|---|---|---|
| BET | m²/g | 25 | 27 | 43 | 45 | 40 | 23 | 25 | 26 |
| C content | ppm | <4 | <4 | <4 | <4 | <4 | <4 | <4 | <4 |
| Cl content | ppm | 100-200 | 100-200 | 300-400 | 100-200 | 100-200 | 100-200 | <60 | <60 |
| Al content | ppb | 20 | 20 | 20 | 20 | 20 | 20 | 20 | 20 |
| pore volume | mm³/g | 650 | 650 | 650 | 650 | 650 | 650 | 650 | 650 |
| Total of the | ppb | <200 | <200 | <200 | <200 | <200 | <200 | <700 | <700 |
| concentrations | | | | | | | | | |
| of Ca, Co, Cr, | | | | | | | | | |
| Cu, Fe, Ge, Hf, | | | | | | | | | |
| K, Li, Mg, Mn, | | | | | | | | | |
| Mo, Na, Nb, Ni, | | | | | | | | | |
| Ti, V, W, Zn, Zr | | | | | | | | | |
| Alkaline earth | ppb | 115 | 55 | 95 | 115 | 40 | 35 | 136 | 33 |
| metal content | | | | | | | | | |
| tamped density | g/cm³ | 0.95 ± 0.05 | 0.95 ± 0.05 | 0.95 ± 0.05 | 0.95 ± 0.05 | 0.95 ± 0.05 | 0.95 ± 0.05 | 0.95 ± 0.05 | 0.95 ± 0.05 |

In the case of F1-2, F2-1 and F3-2, the granulates after the cleaning step show a significantly reduced carbon content (like low carbon granulate, e.g. F1-1). In particular, F1-2, F1-5, F2-1 and F3-2 show a significantly reduced content of alkaline earth metals. SiC formation was not observed.

### G. Treatment of Silicon Dioxide Granulate by Warming

Silicon dioxide granulate is subjected to a temperature treatment in a pre chamber in the form of a rotary kiln which is positioned upstream of the melting oven and which is connected in flow connection to the melting oven via a further intermediate chamber. The rotary kiln is characterised by a temperature profile which increases in the flow direction. A further treated silicon dioxide granulate was obtained. In example G-4-2 no treatment by warming was performed during mixing in the rotary kiln. The process parameters are given in Table 13 and the properties of the obtained treated granulate in Table 14.

TABLE 13

| Example | | G1-1 | G1-2 | G1-3 | G1-4 | G1-5 | G2-1 | G3-1 | G3-2 | G4-1 | G4-2 |
|---|---|---|---|---|---|---|---|---|---|---|---|
| Educt = Product from | | F1-1 | F1-2 | F1-3 | F1-4 | F1-5 | F2-1 | F3-1 | F3-2 | F1-1 | F1-1 |
| Silicon components | | | | | | | | | | | |
| Material | | — | — | — | — | — | — | — | — | Silicon | Silicon |
| | | | | | | | | | | powder*** | powder*** |
| Amount | | | | | | | | | | 0.01% | 0.1% |
| Rotary kiln ¹⁾ | | | | | | | | | | | |
| Length | cm | 200 | 200 | 200 | 200 | 200 | 200 | 200 | 200 | 200 | NA |
| Inner diameter | cm | 10 | 10 | 10 | 10 | 10 | 10 | 10 | 10 | 10 | |
| Throughput | kg/h | 8 | 5 | 5 | 5 | 5 | 5 | 5 | 5 | 5 | |
| Rotation speed | rpm | 30 | 30 | 30 | 30 | 30 | 30 | 30 | 30 | 30 | |
| T1 (Rotary kiln inlet) | ° C. | RT | RT | RT | RT | RT | RT | RT | RT | RT | |
| T2 (Rotary kiln outlet) | ° C. | 500 | 500 | 500 | 500 | 500 | 500 | 500 | 500 | 500 | |
| Atmosphere | | | | | | | | | | | |
| Gas, flow | | air, free | O₂, in | O₂, in | O₂, in | O₂, in | O₂, in | O₂, in | O₂, in | O₂, in | |
| direction | | convec- | contra- | contra- | contra- | contra- | contra- | contra- | contra- | contra- | |
| | | tion | flow | flow | flow | flow | flow | flow | flow | flow | |
| Total throughput | Nm³/h | | 0.6 | 0.6 | 0.6 | 0.6 | 0.6 | 0.6 | 0.6 | 0.6 | |
| of gas flow | | | | | | | | | | | |

***Grain size D₅₀ = 8 μm; carbon content ≤ 5 ppm; Total foreign metals ≤ 5 ppm; 0.5 ppm; available from Wacker Chemie AG (Munich, Germany).
RT = room temperature (25° C.)
¹⁾ For the rotary kilns, the throughput is selected as the control variable. That means that during operation the mass flow exiting from the rotary kiln is weighed and then the rotational speed and/or the inclination of the rotary kiln is adapted accordingly. For example, an increase in the throughput can be achieved by a) increasing the rotational speed, or b) increasing the inclination of the rotary kiln away from horizontal, or a combination of a) and b).

TABLE 14

| Example | | G1-1 | G1-2 | G1-3 | G1-4 | G1-5 | G2-1 | G3-1 | G3-2 | G4-1 | G4-2 |
|---|---|---|---|---|---|---|---|---|---|---|---|
| BET | m²/g | 22 | 23 | 38 | 42 | 37 | 22 | 22 | 21 | 22 | 24 |
| Water content (residual moisture) | ppm | 500 | 100 | 100 | 100 | 100 | 100 | 500 | 100 | 500 | <10000 |
| C content | ppm | <4 | <4 | <4 | <4 | <4 | <4 | <4 | <4 | <4 | <4 |
| Cl content | ppm | 100-200 | 100-200 | 300-400 | 100-200 | 100-200 | 100-200 | <60 | <60 | 100-200 | 100-200 |
| Al content | ppb | 20 | 20 | 20 | 20 | 20 | 20 | 20 | 20 | 20 | 20 |
| Total of the concentrations of Ca, Co, Cr, | ppb | ≤200 | ≤200 | ≤200 | ≤200 | ≤200 | ≤200 | ≤200 | ≤200 | ≤200 | ≤200 |
| Cu, Fe, Ge, Hf, K, Li, Mg, Mn, Mo, Na, Nb, | | | | | | | | | | | |
| Ni, Ti, V, W, Zn, Zr | | | | | | | | | | | |
| Alkaline earth metal content | ppb | 115 | 55 | 95 | 115 | 40 | 35 | 136 | 33 | 115 | 115 |
| angle of repose | ° | 26 | 26 | 26 | 26 | 26 | 26 | 26 | 26 | 26 | 26 |

Due to this treatment, G3-1 and G3-2 exhibit a significantly reduced alkaline earth metal content in comparison to before (E3-1 & E3-2 respectively).

### H. Melting of Granulate to Obtain Quartz Glass

Silicon dioxide granulate according to line 2 of Table 15 is employed for preparing a dense quartz glass body in a vertical crucible drawing process. The structure of the standing oven, for example 115-1 comprising a standing melting crucible is shown schematically in FIG. 9, and for all the other examples with a hanging melting crucible FIG. 8 serves as a schematic representation. The silicon dioxide granulate is introduced via the solids feed and the interior of the melting crucible is flushed with a gas mixture. In the melting crucible, a glass melt forms upon which a reposing cone of silicon dioxide granulate sits. In the lower region of the melting crucible, molten glass is removed from the glass melt through a die and is pulled vertically down in the form of a tubular thread. The output of the plant results from the weight of the glass melt, the viscosity of the glass through the nozzle the size of the hole provided by the nozzle. By varying the feed rate of silicon dioxide granulate and the temperature, the output can be set to the desired level. The process parameters are given in Table 15 and Table 17 and in some cases in Table 19 and the properties of the formed quartz glass body in Table 16 and Table 18.
In Example H7-1, a gas distributing ring is arranged in the melting crucible, with which the flushing gas is fed close to the surface of the glass melt. An example of such an arrangement is shown in FIG. 10.
In Example H8-x, the dew point is measured at the gas outlet. The measuring principle is shown in FIG. 14. Between the outlet of the melting crucible and the measuring location of the dew point, the gas flow covers a distance of 100 cm.

TABLE 15

| Example | | H1-1 | H1-2 | H1-3 | H1-4 | H1-5 | H3-1 | H3-2 | H4-1 | H4-2 |
|---|---|---|---|---|---|---|---|---|---|---|
| Educt = Product from | | G1-1 | G1-2 | G1-3 | G1-4 | G1-5 | G3-1 | G3-2 | G4-1 | G4-2 |
| Melting crucible | | | | | | | | | | |
| Type | | Hanging | Hanging | Hanging | Hanging | Hanging | Hanging | Hanging | Hanging | Hanging |
| | | metal | metal | metal | metal | metal | metal | metal | metal | metal |
| | | sheet | sheet | sheet | sheet | sheet | sheet | sheet | sheet | sheet |
| | | crucible | crucible | crucible | crucible | crucible | crucible | crucible | crucible | crucible |
| Type of metal | | tungsten | tungsten | tungsten | tungsten | tungsten | tungsten | tungsten | tungsten | tungsten |
| length | cm | 200 | 150 | 150 | 150 | 150 | 200 | 150 | 200 | 200 |
| Inner diameter | cm | 40 | 25 | 25 | 25 | 25 | 40 | 25 | 40 | 40 |
| Throughput | kg/h | 30 | 20 | 20 | 20 | 20 | 30 | 20 | 30 | 30 |
| T1 (Gas compartment of the | ° C. | 300 | 300 | 300 | 300 | 300 | 300 | 300 | 300 | 300 |
| melting crucible) | | | | | | | | | | |
| T2 (glass melt) | ° C. | 2100 | 2100 | 2100 | 2100 | 2100 | 2100 | 2100 | 2100 | 2100 |
| T3 (nozzle) | ° C. | 1900 | 1900 | 1900 | 1900 | 1900 | 1900 | 1900 | 1900 | 1900 |
| Atmosphere/Flushing gas | | | | | | | | | | |
| He | Vol.-% | 50 | 50 | 50 | 50 | 50 | 50 | 50 | 50 | 50 |
| Concentration | | | | | | | | | | |
| H₂ | Vol.-% | 50 | 50 | 50 | 50 | 50 | 50 | 50 | 50 | 50 |
| Concentration | | | | | | | | | | |
| Total gas flow throughput | Nm³/h | 4 | 4 | 4 | 4 | 4 | 2 | 4 | 2 | 2 |
| O₂ | ppm | ≤100 | ≤100 | ≤100 | ≤100 | ≤100 | ≤100 | ≤100 | ≤100 | ≤100 |

TABLE 16

| Example | | H1-1 | H1-2 | H1-3 | H1-4 | H1-5 | H3-1 | H3-2 | H4-1 | H4-2 |
|---|---|---|---|---|---|---|---|---|---|---|
| C content | ppm | <4 | <4 | <4 | <4 | <4 | <4 | <4 | <4 | <4 |
| Cl content | ppm | 100-200 | 100-200 | 300-400 | 100-200 | 100-200 | <60 | <60 | 100-200 | 100-200 |
| Al content | ppb | 20 | 20 | 20 | 20 | 20 | 20 | 20 | 20 | 20 |
| Total of the | ppb | <400 | <400 | <400 | <400 | <400 | <400 | <400 | <400 | <400 |
| concentrations | | | | | | | | | | |
| of Ca, Co, Cr, | | | | | | | | | | |
| Cu, Fe, Ge, Hf, | | | | | | | | | | |
| K, Li, Mg, Mn, | | | | | | | | | | |
| Mo, Na, Nb, | | | | | | | | | | |
| Ni, Ti, V, | | | | | | | | | | |
| W, Zn, Zr | | | | | | | | | | |
| OH content | ppm | 400 | 400 | 400 | 400 | 400 | 80 | 400 | 80 | 80 |
| Alkaline | ppb | 115 | 55 | 95 | 115 | 40 | 136 | 33 | 115 | 115 |
| earth metal | | | | | | | | | | |
| content | | | | | | | | | | |
| ODC content | l/cm³ | 4*10¹⁵ | 2*10¹⁶ | 4*10¹⁵ | 4*10¹⁵ | 4*10¹⁵ | 5*10¹⁸ | 2*10¹⁶ | 5*10¹⁸ | 8*10¹⁸ |
| pore volume | mL/g | 0.1 | 0.1 | 0.1 | 0.1 | 0.1 | 0.1 | 0.1 | 0.1 | 0.1 |
| Outer diameter | cm | 19.7 | 3.0 | 19.7 | 19.7 | 19.7 | 19.7 | 3.0 | 19.7 | 19.7 |
| tubular | | | | | | | | | | |
| thread/quartz | | | | | | | | | | |
| glass body | | | | | | | | | | |
| Viscosity | Lg(η/dPas) | | | | | | | | | |
| @1250° C. | | 11.69 ± | 11.69 ± | 11.69 ± | 11.69 ± | 11.69 ± | 12.16 ± | 11.69 ± | 12.16 ± | 12.16 ± |
| | | 0.13 | 0.13 | 0.13 | 0.13 | 0.13 | 0.2 | 0.13 | 0.2 | 0.2 |
| @1300° C. | | 11.26 ± | 11.26 ± | 11.26 ± | 11.26 ± | 11.26 ± | 11.49 ± | 11.26 ± | 11.49 ± | 11.49 ± |
| | | 0.1 | 0.1 | 0.1 | 0.1 | 0.1 | 0.15 | 0.1 | 0.15 | 0.15 |
| @1350° C. | | 10.69 ± | 10.69 ± | 10.69 ± | 10.69 ± | 10.69 ± | 10.88 ± 0.1 | 10.69 ± | 10.88 ± | 10.88 ± |
| | | 0.07 | 0.07 | 0.07 | 0.07 | 0.07 | | 0.07 | 0.1 | 0.1 |

“±”-value are the standard deviation.

TABLE 17

| Example | | H5-1 | H6-1 | H7-1 | H8-1 | H8-2 | H8-3 | H8-4 |
|---|---|---|---|---|---|---|---|---|
| Educt = Product from | | G1-1 | G1-1 | G1-1 | G1-1 | G1-1 | G1-1 | G1-1 |
| Melting crucible | | | | | | | | |
| Type | | Standing | Hanging | Hanging | Hanging | Hanging | Hanging | Hanging |
| | | sinter | sinter | metal plate | metal plate | metal plate | metal plate | metal plate |
| | | crucible | crucible | crucible | crucible | crucible | crucible | crucible |
| Type of metal | | tungsten | tungsten | tungsten | tungsten | tungsten | tungsten | tungsten |
| Additional fittings | | — | — | Gas dis- | dew point | dew point | dew point | dew point |
| and fixtures | | | | tributor | measure- | measure- | measure- | measure- |
| | | | | ring | ment | ment | ment | ment |
| Length | cm | 250 | 250 | 200 | 200 | 200 | 200 | 200 |
| Inner diameter | cm | 40 | 36 | 40 | 40 | 40 | 40 | 40 |
| Throughput | kg/h | 40 | 35 | 30 | 30 | 30 | 30 | 30 |
| T1 (Gas compartment of | ° C. | 300 | 400 | 300 | 300 | 300 | 300 | 300 |
| melting crucible) | | | | | | | | |
| T2 (glass melt) | ° C. | 2100 | 2150 | 2100 | 2100 | 2100 | 2100 | 2100 |
| T3 (Nozzle) | ° C. | 1900 | 1900 | 1900 | 1900 | 1900 | 1900 | 1900 |
| Atmosphere | | | | | | | | |
| He | Vol.-% | 30 | 50 | 50 | 50 | 50 | 50 | 50 |
| Concentration | | | | | | | | |
| H₂ | Vol.-% | 70 | 50 | 50 | 50 | 50 | 50 | 50 |
| Concentration | | | | | | | | |
| Total gas flow | Nm³/h | 4 | 4 | 8 | 8 | 4 | 3 | 2 |
| throughput | | | | | | | | |
| O₂ | ppm | <100 | <100 | ≤10 | ≤100 | ≤100 | ≤100 | ≤100 |

TABLE 18

| Example | | H5-1 | H6-1 | H7-1 | H8-1 | H8-2 | H8-3 | H8-4 |
|---|---|---|---|---|---|---|---|---|
| C content | ppm | <4 | <4 | <4 | <4 | <4 | <4 | <4 |
| Cl content | ppm | 100-200 | 100-200 | 100-200 | 100-200 | 100-200 | 100-200 | 100-200 |
| Al content | ppb | 20 | 20 | 20 | 20 | 20 | 20 | 20 |
| Total of the concentrations of | ppb | <400 | <400 | <400 | <400 | <400 | <400 | <400 |
| Ca, Co, Cr, Cu, Fe, Ge, Hf, K, | | | | | | | | |
| Li, Mg, Mn, Mo, Na, Nb, Ni, Ti, | | | | | | | | |
| V, W, Zn, Zr | | | | | | | | |
| OH content | ppm | 400 | 400 | 400 | 250 | 400 | 500 | 800 |
| Alkaline earth metal content | ppb | 115 | 115 | 115 | 115 | 115 | 115 | 115 |
| ODC content | l/cm³ | <4*10¹⁵ | <4*10¹⁵ | <4*10¹⁵ | <4*10¹⁵ | <4*10¹⁵ | <4*10¹⁵ | <4*10¹⁵ |
| Content of W, Mo, Re, Ir, Os | ppb | <300 ppb | <300 ppb | <100 ppb | <50 ppb | <100 ppb | <5 ppm | 100 ppm |
| Outer diameter of tubular | cm | 26.0 | 19.7 | 19.7 | 19.7 | 19.7 | 19.7 | 19.7 |
| thread/quartz glass body | | | | | | | | |
| Viscosity | lg(η/dPas) | | | | | | | |
| @1250° C. | | 11.69 ± 0.13 | 11.69 ± 0.13 | 11.69 ± 0.13 | 12.06 ± 0.15 | 11.69 ± 0.13 | 11.69 ± 0.13 | 11.63 ± 0.13 |
| @1300° C. | | 11.26 ± 0.1 | 11.26 ± 0.1 | 11.26 ± 0.1 | 11.38 ± 0.1 | 11.26 ± 0.1 | 11.26 ± 0.1 | 11.22 ± 0.1 |
| @1350° C. | | 10.69 ± 0.07 | 10.69 ± 0.07 | 10.69 ± 0.07 | 10.75 ± 0.08 | 10.69 ± 0.07 | 10.69 ± 0.07 | 10.65 ± 0.07 |

TABLE 19

| Example | | H-7-1 | H8-1 | H8-2 | H8-3 | H8-4 |
|---|---|---|---|---|---|---|
| Distributor ring (Gas inlet in the melting | cm | 2 | — | — | — | — |
| crucible), Height above the glass melt | | | | | | |
| Location of gas outlet | | In the lid | In the lid | In the lid | In the lid | In the lid |
| | | of the | of the | of the | of the | of the |
| | | melting | melting | melting | melting | melting |
| | | crucible | crucible | crucible | crucible | crucible |
| Dew point of the gas flow | | | | | | |
| Before introduction into melting | | −90 | −90 | −90 | −90 | −90 |
| crucible | | | | | | |
| After removal from melting crucible | | −10 | −30 | −10 | 0 | +10 |

### I. Preparation of a Quartz Glass Grain

Quartz glass bodies with the features indicated in Table 20 are reduced in size to a quartz glass grain. For this, 100 kg of the quartz glass body is subjected to a so-called electrodynamic size reduction process, e.g., an electric shockwave treatment. The starting glass is reduced in size in a tank by electrical pulses to the desired grain size. If necessary, the material is screened using a vibrating screen in order to separate off disrupting fine and course proportions. The quartz glass grain is flushed, acidified with HF, flushed again with water and dried. The quartz glass purified in this way has the properties indicated in Table 21.

TABLE 20

| Example | | H1-1 | H4-1 | H3-1 | H1-3 | H2-1 |
|---|---|---|---|---|---|---|
| C content | ppm | <4 | <4 | <4 | <4 | <4 |
| Cl content | ppm | 100-200 | 100-200 | <60 | 300-400 | 100-200 |
| Al content | ppb | 20 | 20 | 20 | 20 | 20 |
| Total of the concentrations of | ppb | <400 | <400 | <400 | <400 | <400 |
| Ca, Co, Cr, Cu, Fe, Ge, Hf, K, | | | | | | |
| Li, Mg, Mn, Mo, Na, Nb, Ni, Ti, | | | | | | |
| V, W, Zn, Zr | | | | | | |
| OH content | ppm | 400 | 80 | 80 | 400 | 400 |
| Viscosity | Lg(η/dPas) | | | | | |
| @1250° C. | | 11.69 ± 0.13 | 12.16 ± 0.2 | 12.16 ± 0.2 | 11.69 ± 0.13 | 11.87 ± 0.15 |
| @1300° C. | | 11.26 ± 0.1 | 11.49 ± 0.15 | 11.49 ± 0.15 | 11.26 ± 0.1 | 11.29 ± 0.12 |
| @1350° C. | | 10.69 ± 0.07 | 10.88 ± 0.1 | 10.88 ± 0.1 | 10.69 ± 0.07 | 10.75 ± 0.1 |

TABLE 21

| Example | | I1-1 | I4-1 | I3-1 | I1-3 | I2-1 |
|---|---|---|---|---|---|---|
| Educt = Product from | | H1-1 | H4-1 | H3-1 | H1-3 | H2-1 |
| C content | ppm | <4 | <4 | <4 | <4 | <4 |
| Cl content | ppm | 100-200 | 100-200 | 100-200 | 300-400 | 100-200 |
| Al content | ppb | 20 | 20 | 20 | 20 | 20 |
| Total of the concentrations of | ppb | <1000 | <1000 | <1000 | <1000 | <1000 |
| Ca, Co, Cr, Cu, Fe, Ge, Hf, K, | | | | | | |
| Li, Mg, Mn, Mo, Na, Nb, Ni, Ti, | | | | | | |
| V, W, Zn, Zr | | | | | | |
| OH content | ppb | 400 | 80 | 80 | 400 | 400 |
| BET | cm²/g | <1 | <1 | <1 | <1 | <1 |
| Bulk density | g/cm³ | 1.25 | 1.35 | 1.35 | 1.30 | 1.25 |
| Particle size | | | | | | |
| D10 | mm | 0.85 | 0.09 | 0.08 | 0.1 | 0.85 |
| D50 | mm | 2.21 | 0.18 | 0.19 | 0.18 | 2.21 |
| D90 | mm | 3.20 | 0.27 | 0.26 | 0.25 | 3.20 |

### J. Melting of the Quartz Glass Grain to Obtain a Quartz Glass Body

The quartz glass grain according to Table 21 is used to prepare a quartz glass body in a vertical crucible drawing process. The design of a hanging melting crucible is shown as a schematic drawing in FIG. 8. The quartz glass grain is added via the solids supply and the inside of the melting crucible is rinsed with a gas mixture. A glass melt forms in the melting crucible, on which rests a material cone made of quartz glass grain. In the lower region of the melting crucible, molten glass from the glass melt is removed via a die (optionally with a mandrel) and pulled down vertically as a tubular thread. The throughput of the system results from the intrinsic weight and viscosity of the glass melt via the nozzle and the size of the hole predetermined by the nozzle. The throughput can be set to the desired value by varying the content of quartz glass grain supplied and the temperature. The process parameters are indicated in Table 22, and the properties of the formed quartz glass bodies in Table 23. The thus-obtained quartz glass bodies were cut into pieces (weight: 75 kg, diameter=9.00 cm, total length 5.30 m). The end surfaces are post-processed by sawing in order to obtain a straight end surface. The thus machined quartz glass bodies are purified for 30 minutes by dipping in a HF bath (V=2 m³) for 30 minutes and then flushed with FD (fully desalinated) water.

TABLE 22

| Example | | J1-1 | J4-1 | J3-1 | J1-3 | J2-1 |
|---|---|---|---|---|---|---|
| Educt = Product from | | I1-1 | I4-1 | I3-1 | I1-3 | I2-1 |
| Melting crucible | | | | | | |
| Type | | Hanging | Hanging | Hanging | Hanging | Hanging |
| | | metal sheet | metal sheet | metal sheet | metal sheet | metal sheet |
| | | crucible | crucible | crucible | crucible | crucible |
| Type of metal | | tungsten | tungsten | tungsten | tungsten | tungsten |
| Length | cm | 200 | 150 | 150 | 150 | 200 |
| Inner diameter | cm | 40 | 25 | 25 | 25 | 40 |
| Throughput | kg/h | 30 | 20 | 20 | 20 | 30 |
| T1 (Gas chamber | ° C. | 300 | 300 | 300 | 300 | 300 |
| melting crucible) | | | | | | |
| T2 (Glass melt) | ° C. | 2100 | 2100 | 2100 | 2100 | 2100 |
| T3 (Nozzle) | ° C. | 1900 | 1900 | 1900 | 1900 | 1900 |
| Atmosnhere/Flushing | | | | | | |
| gas | | | | | | |
| He | Vol.-% | 50 | 50 | 50 | 50 | 50 |
| Concentration | | | | | | |
| H₂ | Vol.-% | 50 | 50 | 50 | 50 | 50 |
| Concentration | | | | | | |
| Throughput gas flow | Nm³/h | — | — | 2 | 2 | |
| total | | | | | | |
| O₂ | ppm | ≤100 | ≤100 | ≤100 | ≤100 | ≤100 |

TABLE 23

| Example | | J1-1 | J4-1 | J3-1 | J1-3 | J2-1 |
|---|---|---|---|---|---|---|
| C content | ppm | 0.01 | 0.01 | 0.01 | 0.01 | 0.01 |
| Cl content | ppm | 100-200 | 100-200 | <60 | 300-400 | 100-200 |
| Al content | ppb | 20 | 20 | 20 | 20 | 20 |
| Total of the concentrations of Ca, | ppb | <500 | <500 | <500 | <500 | <500 |
| Co, Cr, Cu, Fe, Ge, Hf, K, Li, | | | | | | |
| Mg, Mn, Mo, Na, Nb, Ni, Ti, V, | | | | | | |
| W, Zn, Zr | | | | | | |
| OH content | ppm | 400 | 80 | 80 | 400 | 400 |
| Alkali earth metal content | ppb | 115 | 115 | 136 | 95 | 115 |
| ODC content | l/cm³ | 4*10¹⁵ | 5*10¹⁸ | 5*10¹⁸ | 4*10¹⁵ | 5*10¹⁷ |
| pore volume | mL/g | 0.01 | 0.01 | 0.01 | 0.01 | 0.01 |
| Outer diameter tubular | cm | 19.7 | 19.7 | 19.7 | 19.7 | 19.7 |
| thread/quartz glass body | | | | | | |
| Viscosity | Lg(η/dPas) | | | | | |
| @1250° C. | | 11.69 ± 0.13 | 12.16 ± 0.2 | 12.16 ± 0.2 | 11.69 ± 0.13 | 11.87 ± 0.15 |
| @1300° C. | | 11.26 ± 0.1 | 11.49 ± 0.15 | 11.49 ± 0.15 | 11.26 ± 0.1 | 11.29 ± 0.12 |
| @1350° C. | | 10.69 ± 0.07 | 10.88 ± 0.1 | 10.88 ± 0.1 | 10.69 ± 0.07 | 10.75 ± 0.1 |

“±”-values are the standard deviation.

### K. Combination of Different Melting Processes

Further quartz glass bodies were produced, wherein each were melted twice, and reduced in size in the interim. The examples are shown as an overview in Table 24 and the properties of the formed quartz glass bodies are shown in Table 25.

TABLE 24

| | K-I | K-II | K-III | K-IV |
|---|---|---|---|---|
| Raw material | OMCTS granulate | OMCTS granulate | OMCTS granulate | OMCTS granulate |
| | as in G1-1 | as in G1-1 | as in G1-1 | as in G1-1 |
| Quantity (kg) | 10 | 1000 | 2000 | 2000 |
| Melting #1 | V drawing¹⁾ | V drawing¹⁾ | V drawing¹⁾ | V drawing¹⁾ |
| Post-processing | 50 μm with HF | 50 μm with HF | 50 μm with HF | 50 μm with HF |
| #1 | acidifying | acidifying | acidifying | acidifying |
| Reducing in size | Electric shock- | Electric shock- | Electric shock- | Hammer mill |
| | wave treatment | wave treatment, | wave treatment | |
| | | then vibrating mill | | |
| Preparing #2 | Hot chlorination | Hot chlorination | Hot chlorination | Magnetic separation, |
| | | | | hot chlorination |
| Melting #2 | GDS | IDD | V drawing¹⁾ | V drawing¹⁾ |
| Post-processing | Mechanical | Mechanical | 50 pm with HF | 50 pm with HF |
| #2 | post-processing | post-processing | acidifying | acidifying |
| | (grinding, etc.) | (grinding, etc.) | | |

¹⁾V drawing is a vertically arranged crucible drawing process

Examples K-I to K-1V will now be described in more detail:
For K-I, the pre-treated silicon dioxide granulate G1-1 was selected as starting material. This was melted in a crucible drawing process in a hanging sheet metal crucible. The same conditions were selected as for J1-1 in Table 22. A quartz glass strand was drawn from the crucible at a speed of 2.4 m/h, cooled at a rate of 40 K/min and reduced in size in an electrodynamic size reduction process with a throughput of 40 kg/h—as described in Example I. (Preparation of a quartz glass grain)—to obtain a quartz glass grain. Its grain size distribution D₁₀=0.3 mm, D₅₀=1.5 mm, and D₉₀=3.0 mm. Then, the quartz glass grain was hot chlorinated as in Example F1-1 and then processed immediately to obtain a quartz glass body, using GDS processes. During the melting step, a temperature of 2000° C. was used, at a pressure of 10 bar. After cooling, the melt set in the mould to a temperature of less than 100° C. was removed from the mould. The formed body was then mechanically ground.
For K-II, the pre-treated silicon dioxide granulate G1-1 was selected as starting material. This was melted in a crucible drawing process in a hanging sheet metal crucible. The same conditions were selected as for J1-1 in Table 22. A quartz glass strand was drawn from the crucible at a speed of 2.4 m/h, cooled at a rate of 40 K/min and reduced in size in an electrodynamic size reduction process as described in Example I. to obtain a quartz glass grain. This is then further reduced in size using a vibrating mill at a throughput of 30 kg/h to obtain a finer quartz glass grain. Its grain size distribution D₁₀=0.05 mm, D₅₀=0.15 mm, and D₉₀=0.25 mm. Then, the quartz glass grain was hot chlorinated and then processed immediately to obtain a quartz glass body with a diameter of 180 mm, using IDD processes, at a throughput of 3.0 kg/h. The melting temperature was 1990° C. The formed body was then mechanically ground.
For K-III, the pre-treated silicon dioxide granulate G1-1 was selected as starting material. This was melted in a crucible drawing process in a hanging sheet metal crucible. The same conditions were selected as for J1-1 in Table 22. A quartz glass strand was drawn from the crucible at a speed of 2.4 m/h, cooled at a rate of 40 K/min and reduced in size in an electrodynamic size reduction process as described in Example I. to obtain a quartz glass grain. Its grain size distribution D₁₀=0.3 mm, D₅₀=1.5 mm, and D₉₀=3.0 mm. Then, the quartz glass grain was hot chlorinated and then processed immediately to obtain a quartz glass body by means of a second crucible drawing process. The same conditions were selected as for J1-1 in Table 22. The formed body was then acidified externally with HF to 50 μm.
For K-1V, the pre-treated silicon dioxide granulate G1-1 was selected as starting material. This was melted in a crucible drawing process in a hanging sheet metal crucible. The same conditions were selected as for J1-1 in Table 22. A quartz glass strand was drawn from the crucible at a speed of 2.4 m/h, cooled at a rate of 40 K/min and reduced in size in a hammer mill with a throughput of 200 kg/h to obtain a quartz glass grain. Its grain size distribution D₁₀=0.2 mm, D₅₀=0.6 mm, D₉₀=1.2 mm. This was then purified of metallic impurities by Freifall inline magnet systems with NdFeB-magnets. The throughput here is approximately lt/h. Then, the quartz glass grain was hot chlorinated and then processed immediately to obtain a quartz glass body by means of a second crucible drawing process. The same conditions were selected as for J1-1 in Table 22. The formed body was then acidified externally with HF to 50 μm.

TABLE 25

| Example | | K-I | K-II | K-III | K-IV |
|---|---|---|---|---|---|
| C content | ppm | below the | below the | below the | below the |
| | | detection limit | detection limit | detection limit | detection limit |
| Cl content | ppm | <60 | <60 | <60 | <60 |
| Al content | ppb | <50 | <50 | <50 | <50 |
| Total of the concentrations of | ppb | <200 | <200 | <200 | <500 |
| Ca, Co, Cr, Cu, Fe, Ge, Hf, K, | | | | | |
| Li, Mg, Mn, Mo, Na, Nb, Ni, Ti, | | | | | |
| V, W, Zn, Zr | | | | | |
| OH content | ppm | 600 | 300 | 600 | 600 |
| Alkali earth metal content | ppb | <50 | <50 | <50 | <50 |
| Pore volume | mL/g | No pores | No pores | No pores | No pores |
| Blistering (number of | | <1 | <1 | <1 | <1 |
| bubbles/kg) | | | | | |
| Outer diameter tubular | cm | Plain cylinder | Hollow cylinder | Plain cylinder | Plain cylinder |
| thread/quartz glass body | | with 20 cm | with 46 cm outer | with 9 cm | with 9 cm |
| | | diameter | diameter and 31 | diameter | diameter |
| | | | cm inner diameter | | |
| Viscosity | | | | | |
| @1250° C. | Lg(η/dPas) | 11.69 ± 0.13 | 11.69 ± 0.13 | 11.69 ± 0.13 | 11.69 ± 0.13 |
| @1300° C. | | 11.26 ± 0.1 | 11.26 ± 0.1 | 11.26 ± 0.1 | 11.26 ± 0.1 |
| @1350° C. | | 10.69 ± 0.07 | 10.69 ± 0.07 | 10.69 ± 0.07 | 10.69 ± 0.07 |

“±”-values are the standard deviation.

1-18. (canceled)

19. A process for the preparation of a quartz glass body comprising:
i.) providing a silicon dioxide granulate comprising:
I. providing a pyrogenically produced silicon dioxide powder; and
II. processing the silicon dioxide powder to the silicon dioxide granulate, wherein the silicon dioxide granulate has a greater particle diameter than the silicon dioxide powder;
ii.) making a first glass melt out of the silicon dioxide granulate;
iii.) making a glass product out of at least one part of the first glass melt;
iv.) reducing the size of the glass product to obtain a quartz glass grain;
v.) making a further glass melt from the quartz glass grain; and
vi.) making the quartz glass body out of at least one part of the further glass melt.

20. The process according to claim 19, wherein the glass product has at least one of the following features:
A] a transmission of more than 0.3, particularly preferably of more than 0.5;
B] a blistering in the range from 5 to 5000 based on 1 kg of the glass product;
C] an average bubble size in a range from 0.5 to 10 mm;
D] a BET surface area of less than 1 m²/g;
E] a density in a range from 2.1 to 2.3 g/cm³;
F] a carbon content of less than 5 ppm;
G] a total metal content of metals different to aluminium of less than 2000 ppb; and
H] a cylindrical form;
wherein the ppb and ppm are each based on the total weight of the glass product.

21. The process according to claim 19, wherein in i.) a quantity of 1 to 10 ppm carbon is added.

22. The process according to claim 19, wherein i. II. comprises:
II.1. Providing a liquid phase
II.2. Mixing the silicon dioxide powder with the liquid phase to obtain a slurry;
II.3. Granulating the slurry to obtain the silicon dioxide granulate.

23. The process according to claim 19, wherein at least one of ii.) and v.) is carried out in a melting crucible which has at least one inlet and an outlet, wherein the inlet is arranged above the outlet.

24. The process according to claim 19, wherein the melt energy in at least one of ii.) and v.) is transferred to the melt material via a solid surface.

25. The process according to claim 19, wherein the glass product in iii.), the quartz glass body in vi.), or both, are produced in a crucible drawing process.

26. The process according to claim 19, wherein the reduction in size in iv.) takes place by high voltage discharge pulses.

27. The process according to claim 19, wherein the silicon dioxide powder is prepared from a compound selected from a group consisting of siloxanes, silicon alkoxides and silicon halides.

28. The process according to claim 19, wherein the silicon dioxide granulate
A) has a carbon content of less than 50 ppm;

29. The process according to claim 19, wherein the silicon dioxide granulate comprises at least one of:
B) a BET surface area in a range from 20 to 50 m²/g;
C) a mean particle size in a range from 50 to 500 μm;
D) a bulk density in a range from 0.5 to 1.2 g/cm³.
E) an aluminium content of less than 200 ppb;
F) a tamped density in a range from 0.7 to 1.0 g/cm³;
G) a pore volume in a range from 0.1 to 2.5 mL/g;
H) an angle of repose in a range from 23 to 26°,
I) a particle size distribution D₁₀ in a range from 50 to 150 μm;
J) a particle size distribution D₅₀ in a range from 150 to 300 μm; and
K) a particle size distribution D₉₀ in a range from 250 to 620 μm,
wherein the ppm and ppb are each based on the total weight of the silicon dioxide granulate.

30. The process according to claim 19, wherein the quartz glass grain comprises at least one of:
I/ an OH content of less than 500 ppm;
II/ a chlorine content of less than 60 ppm;
III/ an aluminium content of less than 200 ppb;
IV/ a BET surface area of less than 1 m²/g;
V/ a bulk density in a range from 1.1 to 1.4 g/cm³.
VI/ a particle size D₅₀ for deployment in a melt in a range from 50 to 5000 μm;
VII/ a particle size D₅₀ for deployment in a slurry in a range from 0.5 to 5 mm;
VIII/ a metal content of metals different to aluminium of less than 2 ppm; and
IX/ a viscosity (p=1013 hPa) in a range from log 10 (η (1250° C.)/dPas)=11.4 to log 10 (η (1250° C.)/dPas)=12.9 or log 10 (η (1300° C.)/dPas)=11.1 to log 10 (η (1300° C.)/dPas)=12.2 or log 10 (η (1350° C.)/dPas)=10.5 to log 10 (η (1350° C.)/dPas)=11.5;
wherein the ppm and ppb are each based on the total weight of the quartz glass grain.

31. The process according to claim 19, wherein the quartz glass body is characterised by:
[A] a transmission of more than 0.9; and
[B] a blistering in a range from 0.5 to 500 based on 1 kg of the quartz glass product.

32. The process according to claim 19, wherein the quartz glass body comprises at least one of:
[C] a mean particle size in a range from 0.05 to 1 mm;
[D] a BET surface area of less than 1 m²/g;
[E] a density in a range from 2.1 to 2.3 g/cm³.
[F] a carbon content of less than 5 ppm;
[G] a metal content of metals different to aluminium of less than 2 ppm;
[H] a cylindrical form;
[I] a sheet;
[J] an OH content of less than 500 ppm;
[K] a chlorine content of less than 60 ppm;
[L] an aluminium content of less than 200 ppb; and
[M] an ODC content of less than 5*10¹⁸/cm³;
wherein the ppm and ppb are each based on the total weight of the quartz glass body.

33. A quartz glass grain obtained by a process according to claim 19.

34. A process for the preparation of a light duct comprising:
A/ providing a quartz glass body according to claim 33, wherein the quartz glass body is first processed to obtain a hollow body with at least one opening;
B/ introducing one or more core rods into the hollow body from step A/ through the at least one opening to obtain a precursor; and
C/ drawing the precursor in the heat to obtain a light duct with one or several cores and a jacket M1.

35. A process for preparing an illuminant comprising:
(i) providing a quartz glass body according to claim 33, wherein the quartz glass body is first processed to obtain a hollow body
(ii) optionally fitting the hollow body with electrodes; and
(iii) filling the hollow body with a gas.

36. A process for preparing a formed body comprising:
(1) providing a quartz glass body according to claim 33; and
(2) forming the quartz glass body to obtain the formed body.

37. A process for the preparation of a light duct comprising:
A/ providing a quartz glass body obtained according to a process according to claim 18, wherein the quartz glass body is first processed to obtain a hollow body with at least one opening;
B/ introducing one or more core rods into the hollow body from step A/ through the at least one opening to obtain a precursor; and
C/ drawing the precursor in the heat to obtain a light duct with one or several cores and a jacket M1.

38. A process for preparing an illuminant comprising:
(iv) providing a quartz glass body obtained according to a process according to claim 18, wherein the quartz glass body is first processed to obtain a hollow body
(v) optionally fitting the hollow body with electrodes; and
(vi) filling the hollow body with a gas.

39. A process for preparing a formed body comprising:
(1) providing a quartz glass body obtained according to a process according to claim 18; and
(2) forming the quartz glass body to obtain the formed body.
